(19) United States
(12) Patent Application Publication
(10) Pub. No.: US 2009/0311963 A1
(43) Pub. Date: Dec. 17, 2009

(54) Methods of Remotely Identifying, Suppressing, Disabling and Access Filtering Wireless Devices of Interest Using Signal Timing and Intercept Receivers to Effect Power Reduction, Minimization of Detection, and Minimization of Collateral Interfernce.

(76) Inventor: James D Haverty, Boxborough, MA (US)

Correspondence Address: GORDON E NELSON;PATENT ATTORNEY, PC, 57 CENTRAL ST, PO BOX 782, ROWLEY, MA, 01969, US

(21) Appl. No.: 12/065,225

(22) PCT Filed: Aug. 29, 2006
(86) PCT No.: PCT/US06/33738

§ 371 Date: Feb. 28, 2008

Related U.S. Application Data
(63) Continuation-in-part of application No. PCT/US06/30159, filed on Aug. 1, 2006.
(60) Provisional application No. 60/704,808, filed on Aug. 2, 2005.
(60) Provisional application No. 60/712,704, filed on Aug. 29, 2005.
(60) Provisional application No. 60/717,131, filed on Sep. 14, 2005.

(51) Int. Cl. H04B 1/00

(52) U.S. Cl. 455/63.1

(57) ABSTRACT

Techniques for interfering with communications made according to a wireless standard between a beacon and a wireless device. The techniques determine a characteristic that is required by the standard for a signal produced during the communication. Then an interference signal is generated that is specifically adapted to the characteristic and interferes with the characteristic such that the wireless device and the beacon cannot interact as provided for the communication by the wireless standard. The techniques may be used to suppress legitimate wireless beacons in an operational area, to establish a baiting beacon in the operational area, or to interfere with communications between a wireless device and a baiting beacon or other beacon. The interference signal is specifically adapted to the characteristic in a way that greatly reduces the amount of power required for the interference signal and the conspicuousness of the interference signal.

### CROSS-REFERENCE TO RELATED APPLICATIONS

The present patent application claims priority from the following U.S. provisional patent applications:
60/712,704, Haverty, Methods of surgical wireless device access filtering and threat suppression using signal timing, filed 29 Aug. 2005; and
60/717,131, Haverty, Methods of power consumption minimization as applied to the remote interrogation and/or suppression of wireless devices, filed 14 Sep. 2005

The present patent application also claims priority from PCT US2006/30159, James D. Haverty, Methods of remotely identifying, suppressing, and/or disabling wireless devices of interest, filed 1 Aug. 2006. The U.S. National Phase of the present patent application will also be a continuation-in-part of the U.S. National Phase of PCT/US2006/30159. PCT US2006/30159 also claims priority from the above provisional patent applications and from the provisional patent application, 60/704,808, Haverty, Methods of remotely identifying, suppressing, and or disabling wireless devices of interest, filed 2 Aug. 2000. Each of the provisional patent applications and PCT/US2006/30159 is incorporated by reference into the present patent application in its entirety and for all purposes. The present patent application refers to a filtering system which is implemented in the same fashion as the interrogation system of PCT/US2006/30159 but extends the uses to which the capabilities of the interrogation system may be put. New material in the present patent application includes an improved description of the wireless network operations under a new heading General Description of Wireless Network Operations, enhanced descriptions of the CDMA and GSM signaling and protocols under the headings CDMA and CDMA 2000 and GSM, GPRS and EDGE respectively, and descriptions of additional ways in which the filtering system may be used in the sections titled CDMA Access Filtering Techniques for the CDMA standard and GSMAccess Filtering Techniques for the GSM standard.

Each of the provisional applications listed above and PCT US2006/30159 is incorporated by reference into the present patent application in its entirety and for all purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates to the methods of controlling a transceiver to remotely interrogate wireless devices on demand in some prescribed operational area so as to identify the presence of said device, whether it is friend or foe, and subsequently disabling the device based on its identity or enticing it to transmit to facilitate its location. It is further enhanced to include methods of selectively filtering access to wireless networks in some pre-defined operational area for specific or entire classes of wireless devices and to suppress the operation of heretofore clandestine, unfriendly or unapproved wireless devices in real-time in so as to prevent their use for purposes of: detonation or other triggering; hostile or illicit communications; or allowing only emergency personnel or friendly military forces use of the wireless network and to do so while minimizing collateral interference of legitimate wireless devices outside of the pre-defined operational area; using a minimum amount of power; and having maximum inconspicuousness.

2. Description of Related Art

The widespread use of wireless devices in criminal and terrorist activities has made it desirable for law enforcement officials to be able to identify and subsequently suppress, ring, locate, or when necessary even disable clandestine wireless devices. Such devices may be concealed in containers or on persons, may be connected to detonators or other activators, or may be being used for purposes of terrorism, unauthorized intelligence collection. In some cases, a legitimate wireless device may even have been inadvertently enabled in a secure environment. Law enforcement officials further need to be able to identify and quarantine wireless devices in emergency situations or in situations where use of wireless devices is prohibited, such as prisons, hospitals or baggage screening areas and to determine the identifying information of a wireless device prior to locating and intercepting the wireless device and collecting either voice or data from the wireless device.

A further need exists to filter such devices for access to the wireless network ranging from denying all access to a wireless network to selectively allowing only wireless devices on an approved list to gain access to said networks and to further manipulate said access to gain actionable intelligence such as defeating encryption for purposes of collecting phone numbers or voice or prolonging communications by selectively crippling a link so as to make location of a wireless device possible.

Interrogtion and Disablement

The wireless standards prescribe that a wireless device register (or re-register) with the system when the wireless device detects a beacon in its registration area that is “better” than the beacon the wireless device is currently monitoring. The “better” beacon has either greater signal strength or better quality compared to the beacon which the wireless device is currently monitoring. The wireless device obtains the thresholds for making such determinations from parameter settings in the beacon currently being monitored. For example, all beacons broadcast one or more messages that include parameters for determining when a wireless device monitoring the beacon is to register with the “better” beacon.

The key to dealing with wireless devices that pose a security risk in an area of interest to the law enforcement personnel (termed herein an operational area) is to entice such a device to reregister with a baiting beacon that is under the control of the law enforcement personnel. A baiting beacon is a counterfeit beacon, i.e., a beacon that appears to the wireless device to belong to the network with which the wireless device interacts but is in fact not one of the network's beacons. A known method for making a wireless device register with a baiting beacon is to generate a baiting beacon that is like one in the current registration area but differs from it in two respects:
it has a power level which is greater than the power level of the strongest beacon that is detected in the operational area by more than the strongest beacon's threshold amount; and
it has broadcast settings that indicate that it is in a different registration area.

In response to this combination of greater power and different registration area, the wireless devices in the operational area will automatically re-register with the baiting beacon.

The technique of proffering a baiting beacon has been further refined in prior art to include a directional antenna so as to focus the baiting beacon's signal in a direction (where a wireless device of interest is presumed to be located). Directional focusing the baiting beacon both reduces both the required power consumption and the amount of interference with wireless devices that are not of interest. Such interference is termed in the following collateral interference. The obvious limitations of this technique are that it presumes some knowledge of where a device of interest is located and that it limits but does not eliminate collateral interference: any wireless device that is located within the directional beam will be affected, even if the device is outside the operational area.

Merely offering a baiting beacon whose signal in the operational area is stronger than that of any other beacon in the operational area has the intrinsic and fundamental limitation that collateral interference cannot be limited to the operational area. Because the baiting beacon's signal must be greater than that of the strongest beacon in the operational area, and that in turn means that the signal will reach far beyond the operational area. Merely offering a stronger baiting beacon further means that the minimum power level for the beacon must be a level which is just above the threshold of the strongest legitimate beacon in the operational area. The need for such high power levels makes it difficult to design portable baiting beacons that are both light in weight and have sufficient power to operate in close proximity to a legitimate beacon. Finally, the parameters received by the wireless devices from the legitimate beacon dictate how long the wireless device must detect the stronger signal before attempting to reregister, and that in turn determines how quickly a wireless device can be made to register with the baiting beacon.

Once a wireless device has been enticed to register with a baiting beacon, the wireless device can be interrogated. Many interrogation techniques can be derived directly from a reading of the cellular standards. However, in the case of GSM or UMTS wireless devices only the International Standard Mobile Identifier (IMSI), the Temporary Mobile Identifier (TMSI) and the equipment electronic serial number (IMEI) can be queried. The actual dialed number of the wireless device, known in the art as the Mobile Identification Number (MIN) is not stored in the wireless device but instead is stored in the network and hence cannot be queried using these standard interrogation techniques.

Also known are techniques for temporarily disabling a wireless device once interrogated. In the case of the GSM standard, this includes issuing an authentication rejection which tells the subscriber identity module (SIM) chip embedded in the wireless device to prohibit all incoming and outgoing calls or hijacking the wireless device and issuing an artificial IMSI detach. The IMSI detach tells the network that the wireless device is powering down. The network responds to the message by ceasing to route incoming calls to the wireless device. The effect of the authentication rejection on the SIM is reversed when the wireless device is power cycled. The effect of the IMSI detach is reversed when the wireless device is power cycled or it spontaneously reregisters with the network. Once a wireless device is disabled as described using these techniques, there are no ways of reversing these effects at the baiting beacon. Instead, action by either the network or the user of the wireless device is required. Disablement by way of the authentication rejection further alerts the user to the fact that the wireless device has been disabled.

The prior art solutions for GSM enumerated in the foregoing do not lend themselves to the UMTS standard, which includes measures to thwart such attacks. For example, in UMTS, the wireless device authenticates the beacon it is monitoring, and consequently, a baiting beacon operating according to the UMTS standard must be able to authenticate itself to the wireless device.

Access Filtering and Manipulation

A critical requirement is that the any intervention be either prophylactic or immediately reactive such that it denies access to either unapproved or otherwise unfriendly wireless devices. More specifically, an intervention must be able to prevent incoming calls to devices being used as perhaps detonators and/or be able to disable outgoing calls such as might be placed by prisoners or other unapproved users, while at the same time allowing approved devices to make and receive calls unmolested. Another important requirement is the ability to provide limited access such as allowing a call to go through in order to obtain information about the call (e.g., identifying the dialed numbers of incoming or outgoing calls) and then subsequently shutting off access before the call is connected. Related is the ability to prolong communication for purposes such as locating a device by crippling rather than jamming communications and thus permitting a call to stay up while rendering the call's content mostly unintelligible.

Indiscriminate jamming of all communications over some prescribed operational area is known in the art. The obvious problem with such jamming is that it prevents all calls (including emergency), whether incoming or outgoing, within the operational area. Indiscriminate jamming also often consumes large amounts of power. Moreover, the potential for collateral interference outside of the operational area is high.

As described previously under Interrogation and Disablement, the prior art describes methods for interrogating and thereby identifying specific wireless devices and once identified provides for techniques to subsequently disable a phone. General examples include:
Issuing a disablement command such as an authentication rejection in GSM (SIM disable) or a maintenance lock order in CDMA, or
Forging a power down on the network, whereby a filtering system impersonates a selected wireless device and forges a power down message to tell the wireless network that the wireless device will no longer be accepting calls.

These techniques can be used prophylactically to disable a particular wireless device. However, in many cases it is time-critical that a wireless device be detected and suppressed before it can effect communication and the above methodologies are more often than not too slow to react—particularly in dynamic situations where wireless devices are entering or exiting some operational area—possibly because the operational area itself is moving, or wireless devices are turned on and a call is placed before they can be interrogated. For example, it will typically take as few as 8 seconds to gain the attention of a wireless device for interrogation with 10s of seconds or more being typical. If there are multiple wireless devices, it may take several minutes or more to make a complete inventory of devices in some operational area, as each must be interrogated in turn and subsequently disabled if it is not on an approved list. If the device is turned on and then used immediately to make a phone call such as might be done by a prisoner, this methodology will fail as the device will have been allocated to a traffic channel before it can be interrogated and it is not until the end of the call, when it is too late to intervene, that an interrogator can gain the attention of the wireless device.

Furthermore “interrogation followed by disablement” techniques, as described previously under the heading of Interrogation and Disablement, are in many cases not reversible and may require a power cycling by the user to undo the disablement. The fact that the user may be unaware of the situation exacerbates the problem as it may be hours to perhaps days before the user discovers that the wireless device is disabled. Moreover, a wireless device that is being interrogated cannot make or receive calls. Thus, where wireless devices come or go in the operational area or where the operational area is not static, the interrogation process must be constantly repeated. The constantly repeated interrogation may prevent any wireless device from gaining access to the system while in the operational area It also does not deal with the problem of an otherwise legitimate wireless device that enters an operational area where the device is not approved and is disabled but cannot be re-enabled until the device is power cycled. The same is the case with collateral wireless devices on persons that live or work near an operational area.

An obvious measure would be to enlist the help of the wireless service provider to filter access for approved devices. However this has many shortcomings including but not limited to:
Operational areas may be in hostile places where the service provider cannot or will not provide such support.
An operational area is likely to be a small subset of the entire area serviced by the wireless service provider, making spatial filtering extremely difficult. This makes the potential for collateral interference very high for persons that live and work in proximity to an operational area as they will routinely be affected because there is no efficient mechanism for adding them to the approved list.
Managing the approved list is difficult as there must be a constant and fluid mechanism for adding and removing approved wireless devices. This may need to occur on a daily basis or perhaps in a matter of minutes when emergency situations arise.

Problems not solved by known techniques of enticing wireless devices to reregister with a baiting beacon include: limiting or eliminating collateral interference and false alarms in some operational area; minimizing the power required for the baiting beacon; minimizing the time required for the baiting beacon to elicit a registration; and distinguishing wireless devices that are permitted in the operational area from those that are not permitted there.

Problems not solved by known techniques of querying enticed wireless devices include: guaranteeing that a subscriber is not alerted that a wireless device has been disabled, re-enabling a wireless device on demand; the determining the MIN of the wireless device; defeating the encryption without directly attacking the key; and querying wireless devices that operate on the UMTS standard.

Problems not solved by known techniques are further: selectively and efficiently give only approved wireless devices access to the network; reacting in a timely fashion to the dynamic conditions in an operational area; limiting collateral interference to an operational area; and surgically tailoring attacks on communications between wireless devices and beacons so as to achieve minimum power consumption while being maximally inconspicuous.

It is an object of the inventions disclosed herein to solve these and other problems related to remotely interrogating, identifying, disabling and filtering wireless devices and thereby to provide improved techniques for remote interrogation, identification, disablement and access filtering of wireless devices.

### SUMMARY OF THE INVENTION

The object of the invention is attained by a method for interfering with a communication between a beacon and a wireless device that is made according to a wireless standard. The method includes determining a characteristic of a signal produced during the communication. The characteristic is one that is required for the communication by the wireless standard and then generating an interference signal. The interference signal is specifically adapted to the characteristic and interferes with the characteristic such that the wireless device and the beacon cannot interact as provided for the communication by the wireless standard.

Other objects and advantages will be apparent to those skilled in the arts to which this invention pertains, upon perusal of the following Detailed Description and drawings, wherein:

### BRIEF DESCRIPTION OF THE SEVERAL VIEWS OF THE DRAWINGS

FIG. 1—shows full duplex communications employed by wireless networks

FIG. 2—Shows the roaming and registration process used in wireless networks.

FIG. 3—shows a summary of the registration signaling process with a particular beacon.

FIG. 4—shows a summary of the call setup signaling process.

FIG. 5—shows the operation and scope of the filtering system.

FIG. 6—shows the preferred embodiment of a filtering system transceiver.

FIG. 7—shows a known method of creating a baiting beacon to entice a wireless device to register.

FIG. 8—shows a method of enticing a wireless device to register with a baiting beacon having minimum power consumption and minimal collateral interference

FIG. 9—shows creating baiting beacons to cover multiple service providers operating in the same frequency band.

FIG. 10—shows a method of interrogating an wireless device and using measurement reports transmitted by the wireless device to estimate its location.

FIG. 11—shows a simplified representation of a CDMA signal structure.

FIG. 12—shows a simplified representation of a CDMA signal structure for the forward channel.

FIG. 13—shows a simplified representation of a CDMA signal structure for the reverse channel.

FIG. 14—shows a simplified representation of a CDMA signal structure for an access probe.

FIG. 15—shows a generalized depiction of the multipathed CDMA pilot and an interfering pilot signal with multiple delays.

FIG. 16—shows an example of attacking the a CDMA code channel by matching the delay spreads and allowing the decimated long code randomization to work on behalf of the filtering system to effect interference.

FIG. 17—shows a pilot or symbol delay dithering technique to randomly delay a signal to match the multipath spread of a CDMA signal so as to corrupt sets of symbols that will be contiguous after the deinterleaving process.

FIG. 18—shows the generalized CRC attack.

FIG. 19—shows an example of using commercially available test signal generation equipment and the associated beacon settings that to implement a baiting beacon for a CDMA wireless device.

FIG. 20—shows various classes of interfering CDMA signals.

FIG. 21—shows an example of the a surgical CDMA attack timed to the CDMA pilot.

FIG. 22—show a method of herding a wireless device to an unused channel.

FIG. 23—shows methods of hooking a wireless device on an unused channel which is used as a technique to effectively disable the wireless device.

FIG. 24—shows a method of effecting a reverse channel denial-of-service attack by generating confusing access probes.

FIG. 25—shows the process of allowing only a particular beacon for access and surgically attacking CDMA forward channel signals that gain access thereby.

FIG. 26—shows a generalized representation of the signals generated by a GSM beacon.

FIG. 27—shows a generalized representation of GSM beacon/wireless device signaling interaction.

FIG. 28—shows a signal flow diagram for a GSM Location Update Request (registration).

FIG. 29—shows a signal flow diagram for a GSM call setup.

FIG. 30—shows examples of surgical attacks on the GSM training sequence.

FIG. 31—shows the signal structure for GSM traffic (voice) signaling.

FIG. 32—shows a block diagram for generating sets of interfering GSM signals for wideband signal attacks against frequency hoppers.

FIG. 33—shows an example of using commercially available test signal generation equipment to implement a baiting beacon for a GSM wireless device.

FIG. 34—shows GSM wireless device interrogation methods.

FIG. 35—shows a method of hijacking a GSM wireless device so as to co-opt the network to provide the MIN of the wireless device.

FIG. 36—shows GSM wireless device herding methods.

FIG. 37—shows a method whereby a GSM wireless device can be selectively disabled and re-enabled.

FIG. 38—shows a method for disabling any or all UMTS wireless devices.

### DETAILED DESCRIPTION OF THE INVENTION

Certain Definitions:

Cellular—Wireless communication in any of the generally accepted bands allocated for individual commercial subscriber based voice or data communications.

PCS—Personal Communications Systems (synonymous with ‘cellular’ for purposes of this patent application)

Handset—A mobile device used by a subscriber for voice communication and is a particular type of wireless device. This term is often used interchangeably with wireless device.

Wireless Device—any device be it a mobile wireless device, a portable data assistant or pager that operates on any cellular, PCS or similar system that nominally provides for voice and data communications.

Standards—The governing technical standards describing the operation of certain cellular or other wireless systems.

CDMA (CDMA 2000)—Code Division Multiplexed Access as governed by the TIA IS-95 and IS-2000 standards.

GSM—Global System for Mobile Communications—ETSI standard describing a second generation system for mobile wireless communications.

UMTS—Universal Mobile Telephone System—ETSI standard describing a third generation system for mobile wireless communications.

Collateral Wireless Devices—Any wireless device operating outside of the operational area or approved wireless devices operating in the operational area.

Beacon—A generic term used for the signal broadcast by a cell tower that continuously provides cell tower and system level information as well as timing so as to aid a wireless device in gaining access to a wireless network.

Operational Area—A predefined area in which all wireless devices will be affected by the interrogator.

IMSI—International Mobile Standard Identifier—A unique identifier that is either associated with a specific subscriber or a wireless device used thereby.

TMSI—Temporary Mobile Standard Identifier—A temporary identification number used as local shorthand while the wireless device is operational in a system.

Registration Area—A contiguous geographic region encompassing some number of cell towers. A wireless device will reregister with the cellular network each time it enters a new registration zone so as to facilitate the routing of incoming calls.

MIN—Mobile Identification Number—in this patent application, the MIN is synonymous with the “dialed” phone number of a wireless device as opposed to the subscriber identity codes such as IMSI or TMSI. In some standards the MIN and IMSI are de facto synonymous but the term MIN is used when it necessary to refer specifically to the dialed number without regard to standard.

CRC—Cyclic Redundancy Check—A collection of bits that is appended to a packet of data which is used to detect if one or more bits in said packet was erroneously received.

Forward Channel—transmission in the direction from the beacon to the wireless device.

Reverse Channel—transmission in the direction from the wireless device to the beacon.

TCH—GSM designator for a traffic channel

SDCCH—GSM designator for a Stand-Alone Dedicated Control Channel

SACCH—GSM designator for a Slow Associated Control Channel

FACCH—GSM designator for a Fast Associated Control Channel

BCCH—GSM designator for the Broadcast Control Channel

SCH—GSM designator for the Synchronization Channel

FCCH—GSM designator for the Frequency Correction Channel

CCCH—GSM designator for Common Control Channel—umbrella designator for a collection of channels that carry either PCH or AGCH

PCH—GSM designator for Paging Channel

AGCH—GSM designator for Access Grant Channel

SIM—Subscriber Identity Module—A removable module (chip) that is inserted in a GSM or UMTS based wireless device such that wireless device assumes the identity of the information contained therein.

DoS—Denial-of-Service.

General Description of Wireless Network Operations

While the detailed techniques described herein are specific to the standards under which a wireless device may be operating, the specific techniques for the various standards such as CDMA, GSM and UMTS all necessarily share the same core operational premises. The techniques will therefore be better understood through a brief description of these common premises.

Full Duplex Communication and Sectoring

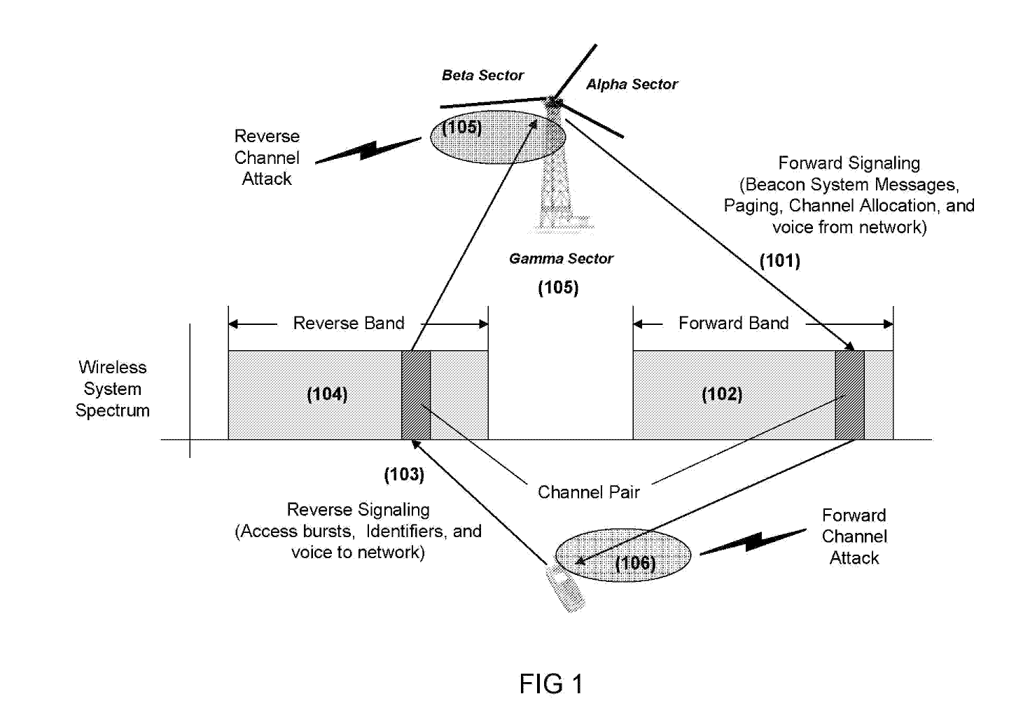

All communications between the wireless device and the network is full-duplex, i.e., the network transmits via a beacon to the wireless device on what is designated as a forward channel (also known in the art as a downlink channel) and the wireless device simultaneously transmits to the network beacon on the reverse channel (also known in the art as an uplink channel) as shown in FIG. 1. Each forward channel (101) is either a time or code channel operating within some frequency channel and sets of these frequency channels are collected in a contiguous forward spectral band (102). Paired with each forward channel is a matching reverse frequency, time and/or code channel (103) and sets of these channels are collected in a contiguous reverse spectral band (104). All timing between the wireless device and the network is established on the forward channel. The timing on the reverse channel is synchronized to the timing on the paired forward channel. A receiver thus need only synchronize to the forward channel to know the timing of both less any uncharacterized propagation delays.

Most towers also employ sectored antennas that concentrate transmitted energy in a particular direction (105) (sector) while at the same time making it only sensitive to received energy from this sector. This has several purposes including spectrum management such that it limits transmit energy propagation to a sector so as to improve frequency reuse while simultaneously increasing the receiver sensitivity of the tower to a wireless device operating in that same sector. A tower's sectors have an influence on how best to attack a signal with respect to access filtering, as it can often be the case that a wireless device of interest may either receive or be received by a tower differently based on the location of the wireless device relative to the tower's sectors.

Beacons

All towers broadcast a specifically crafted signal known in the art as a beacon. The beacon is continuously broadcast and contains identifying and access information that enables the wireless device to identify a tower as an access point on the network and to determine if it is suitably compatible with the wireless device. Beacons also incorporate other signaling such as paging and access grant channels that enable a wireless device to negotiate with the network for access. All beacons operate on a fixed forward frequency channel. For purposes of this discussion a beacon is synonymous with a tower unless expressly noted.

Network Access and Roaming

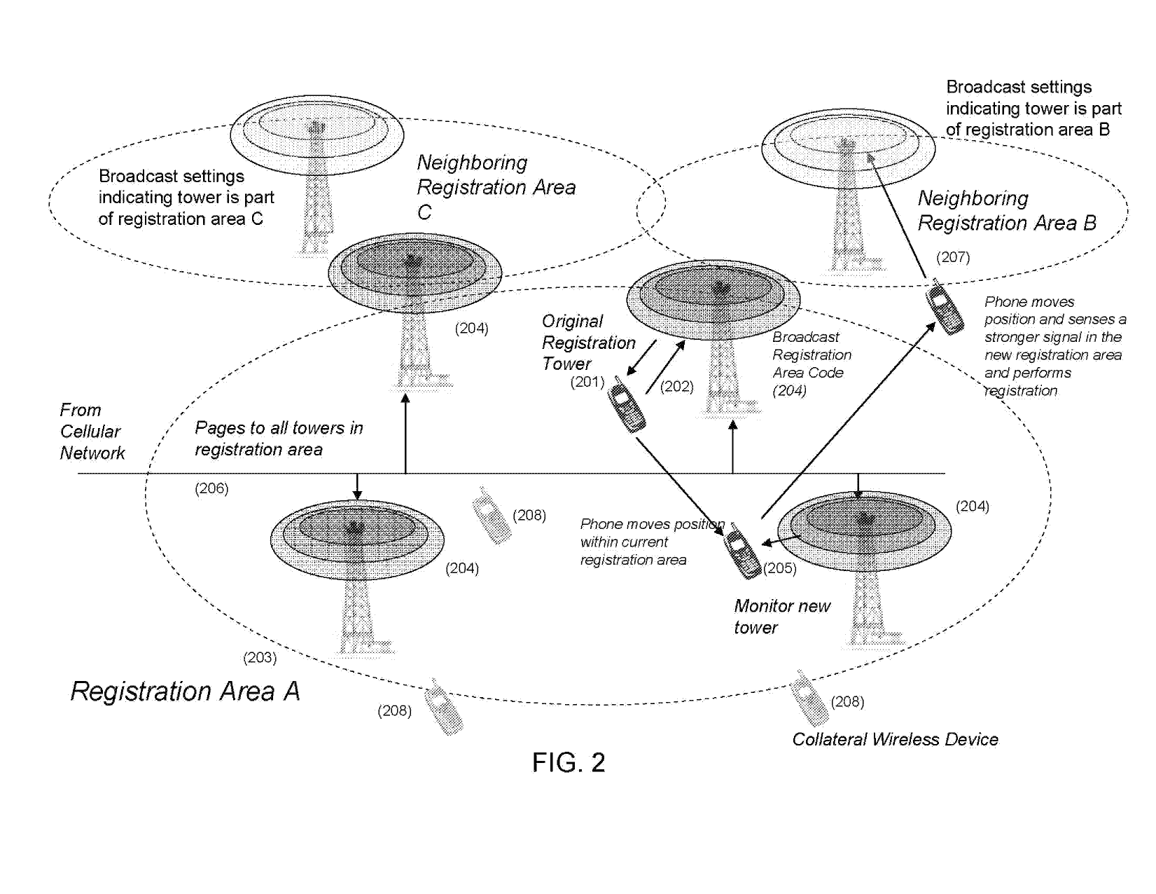

All wireless devices must arbitrate for access to a network using a precisely synchronized and orchestrated protocol, whether making or receiving phone calls. While the signaling protocols are specific to a standard, the generalized process is shown in FIG. 2. Upon power up, the wireless device scans prescribed forward bands looking for beacons broadcast by each tower (201). If one or more beacons are identified, the wireless device will chose the best beacon (be it for quality, signal strength or compatibility) and attempt a registration (202). The purpose of registration is to indicate to the wireless network that the wireless device is on and therefore able to accept incoming calls or connections. Once registered with the network, the wireless device monitors the network awaiting incoming calls. All standards provide for a registration area (203) (known variously in the standards as a registration zone or a location area). Embedded in the signal of each beacon is a common registration area code that indicates that a given beacon is part of a set of beacons (204)—presumably grouped over a contiguous geographic region such as a part of a city. The purpose of the registration area is to allow the wireless device to roam in the registration area without having to expressly register with each and every beacon it might sense. Instead the wireless device will unilaterally choose which beacon it shall monitor within some registration (205) area awaiting incoming pages from the network (typically indicative of an incoming call). Since a wireless device will roam as it may, the network does not have any sense as to which beacon the wireless device may be monitoring and hence sends any pages intended for the wireless device simultaneously to all of the beacons in the registration area to ensure reception (206). Apart from any automatic timed registration, it is only when the wireless device roams outside of the registration area and picks up a beacon with a stronger signal having a different registration area code, that the wireless device re-registers (207). It is consequently at best difficult to predict which tower a wireless device may be monitoring and hence on which tower it might register or otherwise attempt to gain access to make or receive a call subsequent to registration.

Registration

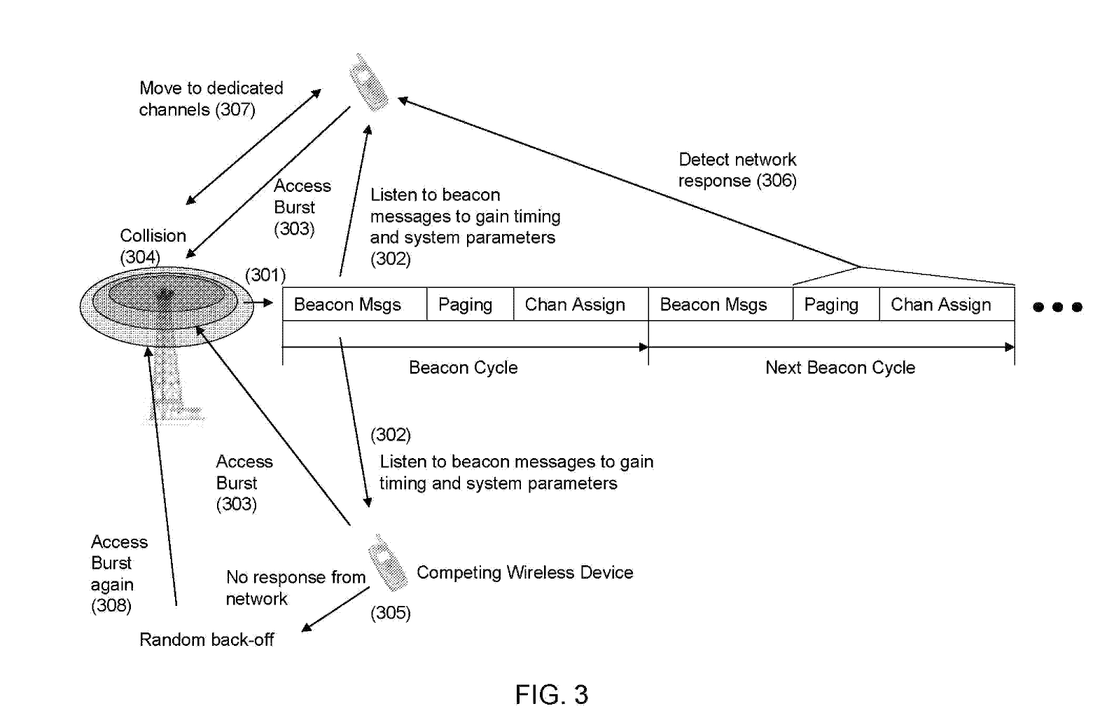

The process of registration is generalized in FIG. 3. Having scanned the operational band, the wireless device synchronizes to the beacon (301) and then analyzes a set of system information messages that are continuously repeated by the beacon (302). Among other things, these messages identify a particular beacon (including the service provider operating said the beacon) and specify how to gain access to the network through this beacon. Included in the specification of how to gain access are parameters specifying any secondary beacon, the beacon's timing, the revision of the protocol used by the beacon, or the type and revision of wireless devices it will accommodate. Presuming the beacon is compatible with the wireless device, the wireless device will send a precisely timed and crafted signal burst (known in GSM/UMTS as Random Access Channel, RACH, burst or in CDMA as an access probe) (303) on a reverse frequency, time and/or code channel that is either implied or expressly dictated by parameters in the messages. The purpose of this burst is to gain the attention of the tower so that the device can register with it.

Any number of wireless devices may be attempting to access a beacon simultaneously. Until a wireless device is recognized by the network and allocated a unique forward/reverse channel pair (be it frequency, timing or coding) that uniquely separates it from all other wireless devices, collisions between the wireless devices and other wireless devices (305) attempting to access the beacon are possible (304). Wireless protocols provide for this scenario by means of a “response/back-off” scheme. After sending the attention burst, the wireless device awaits a response at a specific time (306) from the beacon (in either the paging or channel assignment time slot allocation of the beacon depending on standard) acknowledging that the beacon has received the burst and in some standards (e.g., GSM and UMTS) this same response redirects the device to move to a channel (307) that has been uniquely reserved for any subsequent communication between the wireless device and the beacon. If the response is not forthcoming then it is presumed by the wireless device that the beacon did not hear the request (either because of collision or poor reception) and the device waits a pseudo-random period of time (“backs off”) (308) before attempting to burst again. If the reason for the failed attempt is a collision, then the competing devices will each back off for a different period of time before reattempting to burst. Because each wireless device backs off for a different period of time, the probability of their continual collision becomes vanishingly small and therefore both (or all) devices eventually gain access to the network.

Wireless devices can also initiate registration. An example is timed registration wherein a wireless device will automatically reregister with the system at some periodic interval as dictated by information in the beacon. However the registration interval is strictly at the discretion of the wireless network and can be both arbitrary and highly variable with periods of tens of minutes or more being typical. Therefore a detection system based on simply waiting for a wireless device to spontaneously register is not viable. Furthermore such detection system would be forced to monitor one or more reverse channels associated with each beacon in the operational area and without the use of highly specific and expensive directional antennas or sophisticated location technology, there is little hope of distinguishing reverse channel messages from clandestine wireless devices from reverse channel messages from collateral devices.

Call Processing

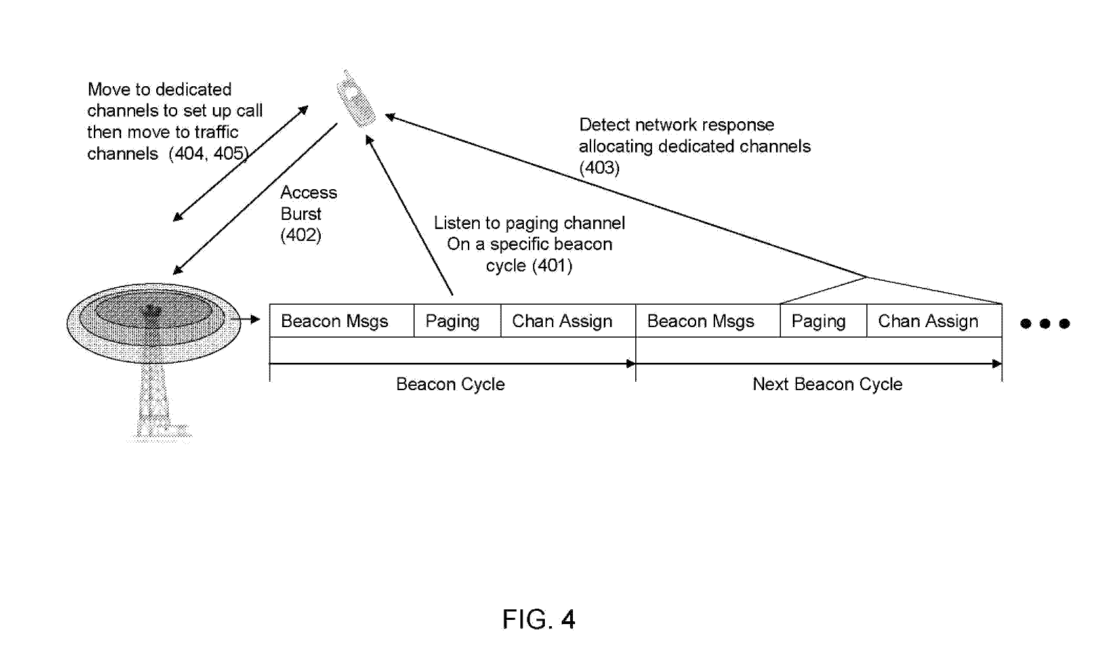

Following registration, the wireless device is able to make or receive calls. The general process for making and receiving calls is shown in FIG. 4. In the case of an incoming call, the wireless device receives a page on one of the logical channels provided by the beacon that the wireless device is currently monitoring (401). To conserve power in the wireless device, the protocol provides for sending a page to a particular wireless device only at prescribed times. This enables the wireless device to conserve power by shutting down its receiver between these times by shutting down the receiver

Either after receiving a page or when placing an outgoing call, the wireless device will attempt to gain access to the wireless network as described for the registration process above (402, 403). In either case, the wireless device and the network will then perform the additional step of signaling back and forth to set up the call (404), culminating with the device moving to what is known variously as the traffic or conversation state where the wireless device begins to communicate with the network over an expressly reserved pairing of forward and reverse channels (405).

Protocols, Messaging and Error Checking

All protocols, regardless of the standard employed, require precisely timed and highly orchestrated interaction between wireless device and network. This makes it possible to precisely predict when a particular signaling sequence or message will occur in the protocol including when individual symbols that comprise the message itself will occur. Error checking is done on all messages within a signaling sequence require error checking. When an erroneous message is detected, the recipient ignores the message and indicates the error to the sender, which retransmits the message. All of the standards use the Cyclic Redundancy Check (CRC) to verify message integrity. A CRC is a sequence of bits appended to a message which acts as a parity check. If any of the bits of the message or of the message's CRC is corrupted in transmission, the receiver will detect the fact that the message and the associated CRC do not match and discard the message.

A consequence of the fact that errors are detected on a per-bit basis is that it is not necessary to attack a signal in its entirety to prevent the wireless device and the network from either gaining access to the network and/or consummating either incoming or outgoing calls. Instead, the attack need merely corrupt a small subset of symbols within some message of the protocol. It is noted further that since CRCs are insensitive to which bits in the message are corrupted, the message's symbols can be attacked in a seemingly random fashion. The apparent randomness of the attack makes it difficult to detect, counter and/or locate the interferer.

Description of a Filtering System

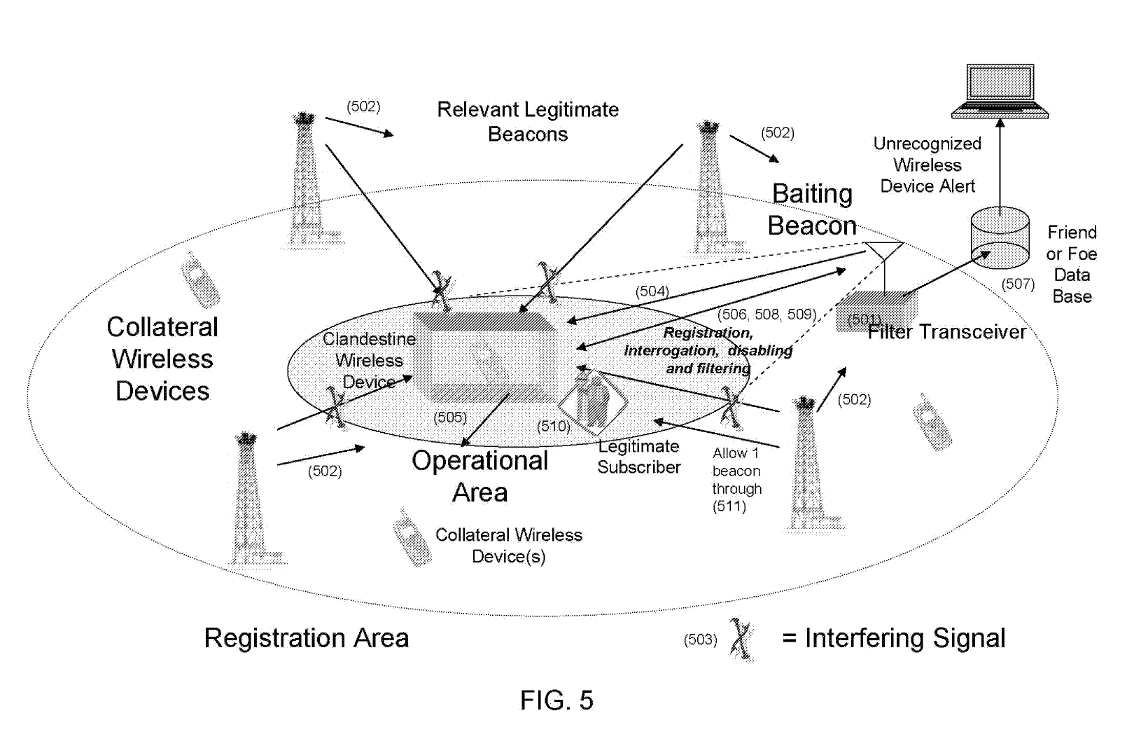

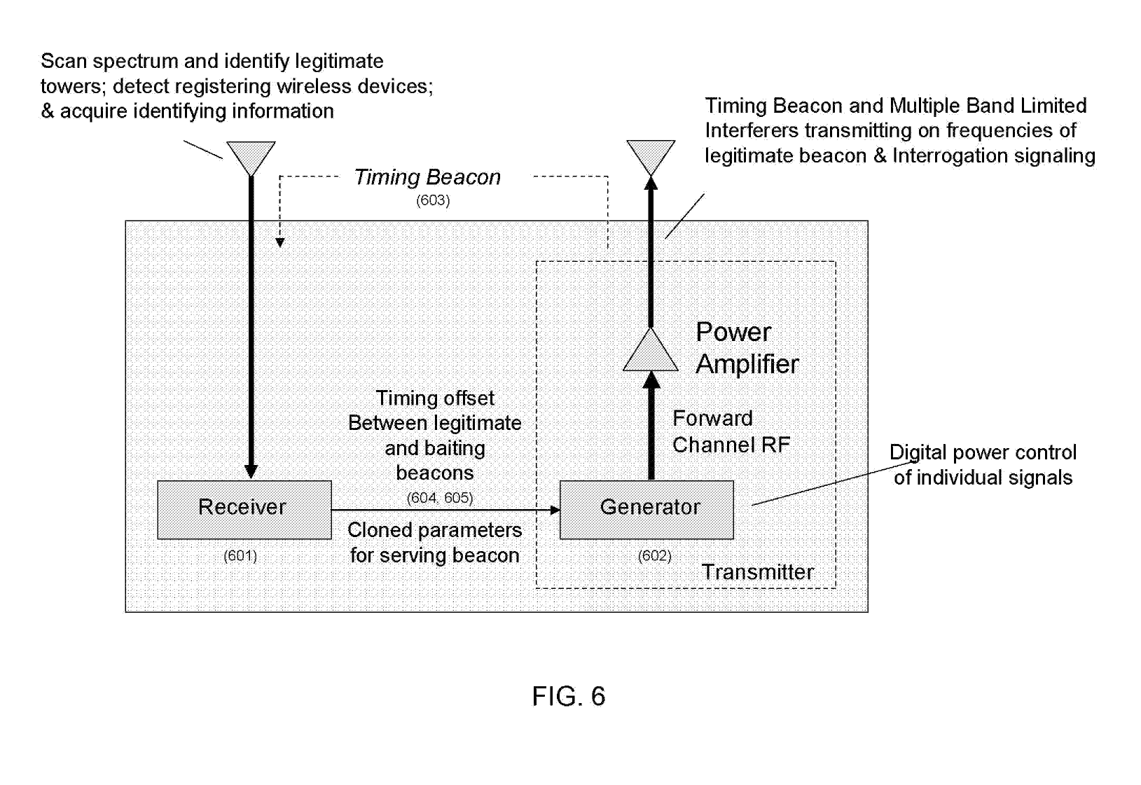

The system which carries out the baiting, interrogation, disablement and filtering operations on the wireless devices is called in the following a filtering system. A preferred embodiment of the filtering system is shown FIG. 5. The filtering system consists of a transceiver (501) that is capable of acting as a baiting beacon, a wireless device and an active interferer. A functional transceiver block diagram is shown in FIG. 6. The transceiver first scans the environment (502) in search of relevant beacons that can be detected in some operational area. It then transmits some number of interfering signals (503) that are tailored to these signals in both strength and bandwidth so as to blind all of the wireless devices present in some predefined operational area which is typically but not necessarily defined to be some radius from the transceiver. Placement or orientation of the transceiver may result in other geometries. By controlling the level of the interfering signals it is possible to control the effective radius of the operational area from perhaps a few yards (such as container security or baggage screening) to several thousand yards (such as locating wireless devices in a disaster area). The transceiver then proffers a baiting beacon (504) paired with a receiver that will entice all wireless devices within some smaller radius (up to and including the whole of the operational area) to register (505). By controlling the signal level of this beacon it is possible to precisely control the proximity in which wireless devices will attempt to register. When a wireless device registers, it can be subsequently interrogated (506) and checked against a friend or foe data base (507). Wireless devices that are not on a approved list can subsequently be acted upon as selected by the operator of the data base. Actions which can be performed using the techniques described herein (508) can range from triggering an alarm to automatically disabling a wireless device. Further still, the wireless device can be interrogated to derive or otherwise facilitate the discovery of secondary information such as encryption keys and/or sequences or the dialed number (known in the art as the Mobile Identification Number—MIN).

Once the beacon environment has been analyzed and the wireless devices in the operational area have been interrogated, the filtering system can filter access to a network. Access filtering can range from allowing specific beacons to operate in the operational area while monitoring the activity on the beacons and then filtering access to the beacons on a per-wireless device basis by attacking signaling specific to the wireless device (509) to extending the principals of beacon suppression described above to target all of the beacons (503) so as to effect a blanket DoS. or.

A preferred embodiment of a transceiver that is used to implement the filtering system is shown in FIG. 6. The transceiver consists of a receiver subsystem (601) and a generation subsystem (602). The generation subsystem is synchronized to the receiver subsystem through the use of the baiting beacon feedback (603). Specifically the baiting beacon is first turned on at some low power. The baiting beacon has specially encoded parameters that distinguish it from other beacons but are superfluous to the wireless device and therefore ignored by it—one possibility is the addition of a message that is not prescribed in the standards. The receiver then scans the environment. The receiver automatically detects the baiting beacon along with all of the other relevant beacons in the operational area and the receiver notes the timing difference between any relevant beacon and the baiting beacon. This allows the receiver to express to the generator the timing difference (604) between each relevant beacon and the baiting beacon with sub-microsecond precision. Additionally, the receiver receives the parameters that will need to be cloned to implement the baiting beacon (605). The critical feature of this technique is that it completely decouples the receiver timing from the generator timing. More specifically it eliminates any of the vagaries of timing delay between the receiver and generator that would otherwise require arduous calibration to deal with and instead simply specifies the difference in timing between the generator and any given relevant beacon as seen by the receiver.

The ability to achieve this degree of timing precision makes it possible to make micro-surgical attacks on critical sections of signaling waveforms. The micro-surgical attacks need only attack vulnerable parts of the waveform. The vulnerable parts are generally only a very small fraction of the wave form, and consequently the micro-surgical attacks minimize the required average power to suppress a waveform. This is particularly relevant with regard to standards such as CDMA that are intrinsically resistant to unsophisticated jamming attacks such as white noise. Instead, having precise timing allows the generator to not only attack these sections of the waveforms but indeed turn this to its advantage as described under the topics for the individual standards while reducing the required transmit power by possibly several orders of magnitude.

The incorporation of the data base allows the system to allow pre-approved wireless devices or classes of wireless devices to operate unmolested in the operational area while unapproved devices are disabled. An important advantage of the filtering techniques disclosed herein is that it is not necessary to precisely know the location of the wireless device. An example is a prison situation where it is only necessary to disable a wireless device as opposed to actually locating it. This enables prison staff to use their wireless devices while suppressing all other wireless devices (510). If it is necessary to know the location of the wireless device, the filtering system can force the wireless device to transmit in a quiescent part of the spectrum so as to facilitate location of the wireless device. The filtering system can also cause the wireless device to ring. Further still the wireless device can be interrogated to derive or otherwise facilitate the discovery of secondary information such as encryption keys and/or sequences or the dialed number (known in the art as the Mobile Identification Number—MIN)

A transceiver that may be used to implement baiting beacons and interference signals is the ComHouse Wireless Network Subscriber Test (NST), which may be purchased from ComHouse Wireless LP, 221 Chelmsford St., Chelmsford, Mass. 01824. The unit is a software defined radio capable of testing both wireless devices and base stations using the GSM and CDMA standards. NST can interrogate wireless devices by acting as a beacon and can scan cellular environments so as to identify and analyze beacons, and can generate multiple simultaneous signals which can be used as interference signals. The interference signals may be customized to surgically attack or manipulate cellular signals with sub-microsecond precision. The unit can also make and receive outgoing and incoming phone calls.

General Principles of the Techniques for Baiting, Interrogating, and/or Disabling Wireless Devices

While the detailed techniques described herein are specific to the standard under which a given wireless device is operating, the specific techniques for the various standards all share the same core operational premises. These will be described in turn for baiting, interrogation, and disablement.

Baiting Overview

When being used to establish a baiting beacon, the filtering system scans the cellular environment (502) and identifies all of the viable beacons in some defined operational environment. It then clones one or more of the beacons with certain important deviations to create baiting beacons while simultaneously generating interfering signals that blind the wireless device to the legitimate beacons and thereby forces the wireless device to search for and register with the proffered baiting beacons (503, 504). The baiting beacon is chosen such that it is not on a legitimate channel in the operational or surrounding areas. This makes it possible to distinguish wireless devices that are in the operational area from those legitimately operating outside of the operational area. This is ensured by controlling the power of the baiting beacon such that is not detectable outside of the operational area by collateral wireless devices. This further eliminates the need for directional antennas to control collateral interference and achieves a solution having the minimal transmitted power and thereby power consumption.

Baiting to Force Re-Registration

As described in the overview, the standards prescribe that a wireless device will re-register when it senses that it has entered a new registration area. More specifically when a new beacon is detected from a different registration area that is sufficiently stronger than any beacon in the current registration area, the wireless device will attempt to re-register in the new area (207). A newly-appearing beacon which is sufficiently stronger than an existing beacon that the wireless device attempts to register with it is said to override the existing beacon. In order to keep the wireless device from flip-flopping between registrations when in an area that is on a border between two registration areas, the standards provide for a hysteresis parameter that the beacon broadcasts to the wireless device and indicates to the wireless device how much stronger the new signal must be than any signal which the wireless device is receiving from beacons in the wireless device's current registration area. The hysteresis parameter generally requires that the new beacon signals be many times greater (typical is a factor of 4 to 10) than beacon signals from the current registration are before the newly-appearing beacon overrides the beacon with which the wireless device is currently registered.

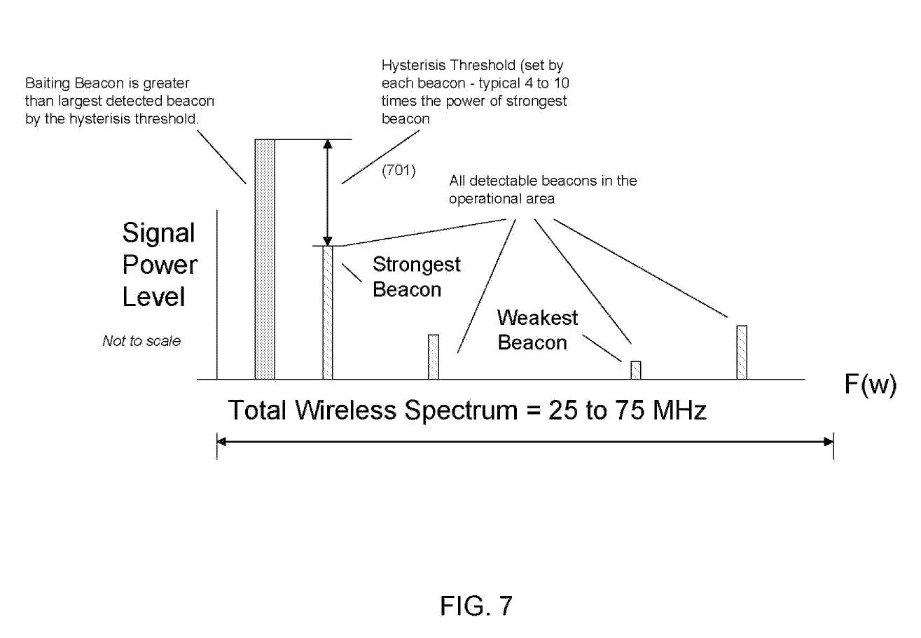

FIG. 7 is a spectral representation of a known method of forcing re-registration with a baiting beacon. First, the baiting beacon is made by cloning a beacon in the registration area and modifying the baiting beacon's registration area identifier. Then the baiting beacon is provided with enough signal power to satisfy the hysteresis parameter with regard to the most powerful beacon in the operational area (701). The high signal power required to satisfy the hysteresis parameter has two undesirable side effects: the power required to produce the signal and the amount of collateral interference caused by the signal outside the operational area (505)

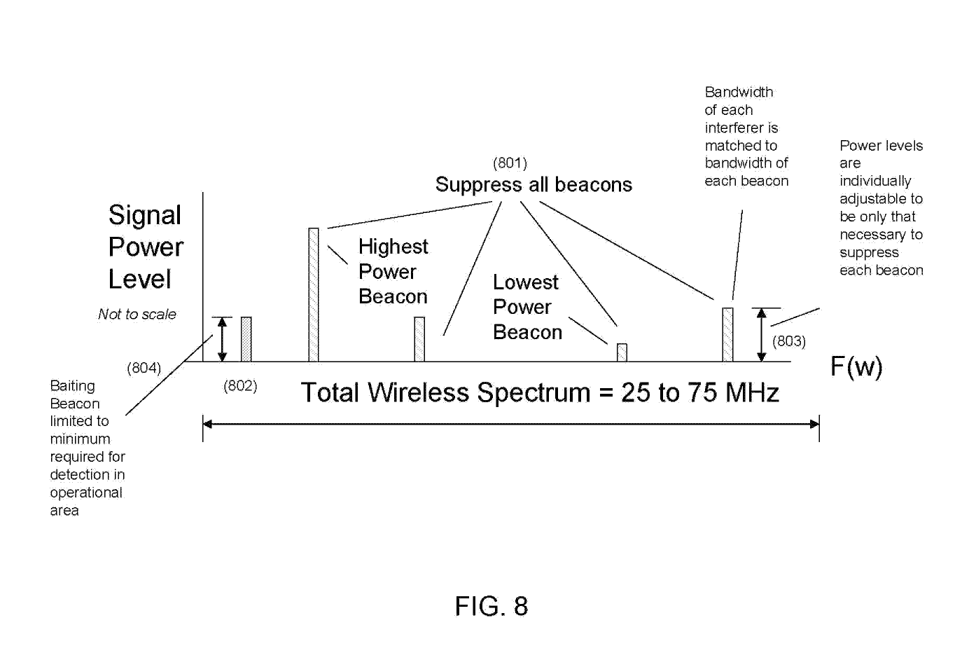

FIG. 8 shows the technique disclosed herein for surgically suppressing all relevant beacons (801) and then proffering a much lower powered beacon in some quiescent portion of the spectrum (802), preferably but not necessarily using a channel identified as a neighbor of a relevant beacon. Use of a neighbor channel is likely to speed the registration process because it prevents the wireless device from having to rescan the entire spectrum in search of new beacons. Suppressing all of the relevant beacons also prevents the wireless device from simply moving to monitor an unsuppressed beacon in the same registration area. It furthermore decreases the time it takes to force a wireless device to register because when a wireless device is cut off from its network, the wireless device immediately begins searching for new beacons. By contrast, when a baiting beacon is used without suppression, the baiting beacon must be detected for some period of time (perhaps 10s of seconds) as determined by a parameter provided by the relevant beacon the wireless device is monitoring before the wireless device will accept the baiting beacon as viable and attempt to register with it.

Another important refinement of the technique is that the filtering system automatically adjusts the individual baiting beacon and interference signals to both limit interference with and false alarms from collateral wireless devices. Specifically the power level and bandwidth of an interfering signal which is intended to suppress a relevant beacon may be limited to only that needed to suppress the relevant beacon (803) within the operational area. With all of the relevant beacons thus suppressed, the baiting beacon's power level is adjusted to the minimum required for a wireless device that is within the operational area to respond to the baiting beacon. (804). Power consumption, collateral interference, and false alarms from collateral devices can be further minimized by placing the operational area within a containment housing such as might be used for screening baggage for active wireless devices that may be used as detonators.

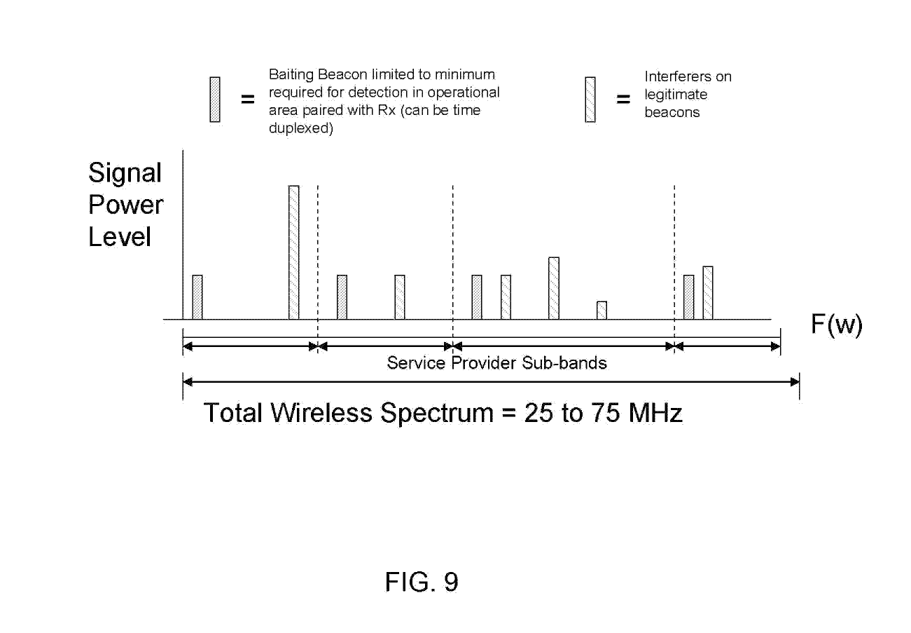

Often wireless devices are programmed to only respond to particular beacons as determined by the service provider. Furthermore the cellular spectrum is normally divided into sub-bands. An extension of this technique is thus to provide a baiting beacon corresponding to each relevant beacon belonging to the service provider as shown in FIG. 9. However it is not necessary to do so simultaneously. Instead, a single baiting beacon can be move from one sub-band to another, dwelling in each sub-band for a period that will permit detection of wireless devices that are using the sub-band in the operational area. Detecting all the wireless devices in the operational area will of course take longer when done this way than when done with a baiting beacon corresponding to each relevant beacon.

Interrogation, Herding and Location.

The filtering system includes a receiver (501) that is paired with the baiting beacon that detects the wireless device as it attempts to register with the baiting beacon (504). The interrogation process also makes use of a data base to store identifying information to create a friend or foe list (507). This makes it possible to filter legitimate wireless devices from as yet detected wireless devices that may be of interest and subsequently allow access to the legitimate network of friendly wireless devices (510). This further makes it possible for legitimate subscribers to keep wireless devices on their persons even while in the operational area without provoking false alarms.

Wireless devices that are enticed to register with the baiting beacon can be subsequently interrogated to determine whether they are friend or foe (506). The interrogator uses the paired baiting beacon and receiver to interact with the wireless device as it attempts to register so as to elicit identifying information such as the mobile identification number (i.e., the wireless device number), the international mobile subscriber identity IMSI, the temporary mobile subscriber identity TMSI, or the serial number. The concept can be extended further to entice the wireless device to transmit continuously and possibly be sequestered on a unique channel so as to facilitate its location. A further extension of the concept is to use the neighbor beacon list obtained from the relevant beacons on the initial scan to find a quiescent channel. The baiting beacon then forces the wireless device of interest to move to this channel and to transmit on demand. In some situations it may even be desirable to force the wireless device to ring.

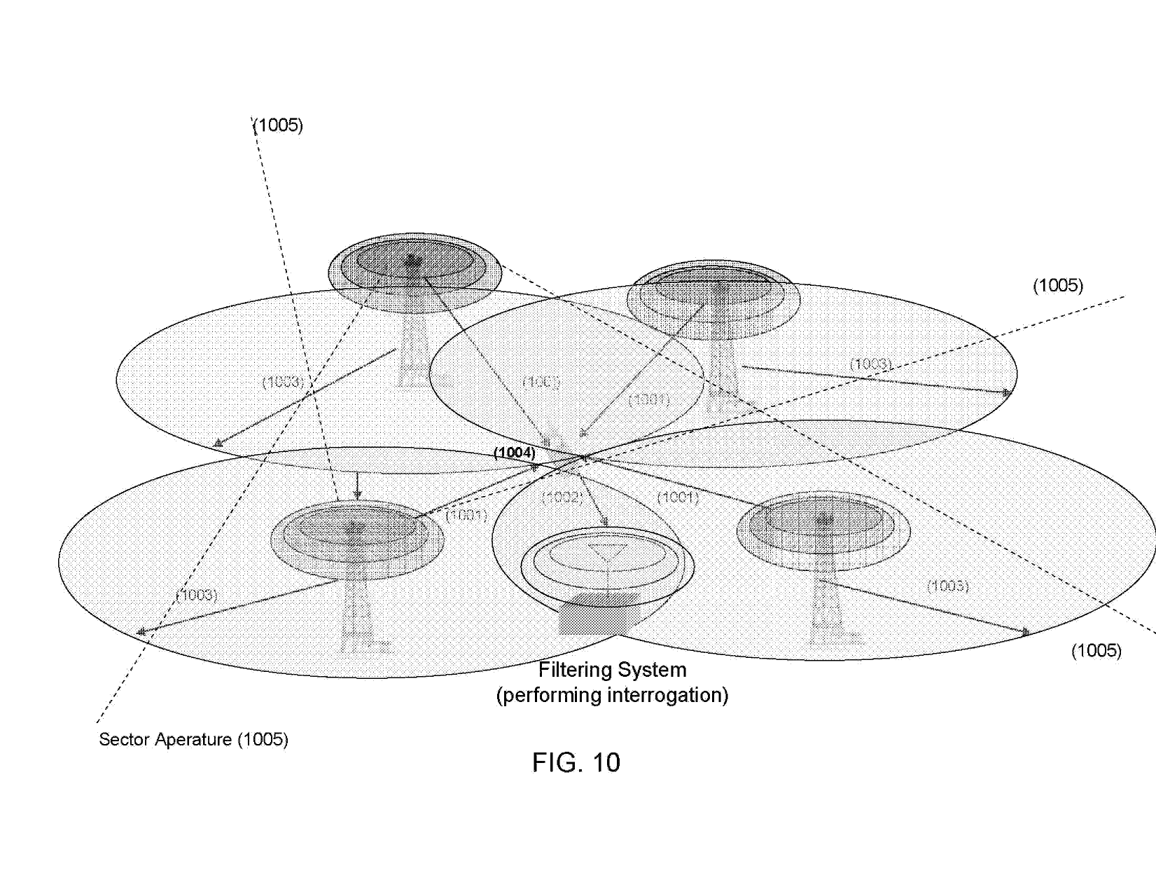

Once the baiting beacon is interacting with a wireless device, it is also possible for the filtering system to compute the approximate location of the wireless device, as shown in FIG. 10. Specifically the standards specify that a wireless device continually scan all of its neighbors (1001) while it is actively communicating with the current serving tower and to insert regular measurement reports on the absolute signal strength of the beacons as received by the wireless device. This information is then passed on to the network for purposes of determining when a phone should be handed off to another tower. If the wireless device is indicating to the network that it can sense a tower with much better signal strength and/or quality, the network will direct the wireless device to move to that tower. This is known in the art as Mobile Assisted Hand-Off (or Hand-Over)—MAHO.

The wireless device of course offers these reports to the filtering system's baiting beacon (1002). If a user of the filtering system knows the location of the neighboring towers (presumably from a previous survey), it is possible to derive, or as a minimum narrow, the position of the wireless device based on these power measurements as shown in FIG. 10. During the period in which the wireless device is collecting data for a measurement report, the interference signals are turned off so that the wireless device can detect the relevant beacons and the baiting beacon is given a signal strength sufficient to prevent the wireless device from monitoring another beacon. Specifically the received power implies a distance to the tower (1003). Therefore if a circle is drawn around each tower, the circle having a radius which is a function of the detected signal strength reported by the wireless device, the wireless device will be located at or near the intersection of the circles (1004). The location technique may be further refined by using sector orientation and aperture information from the surrounding legitimate beacons. For example, a tower survey is likely to include not just the frequency channel settings and the position of the tower but also the orientation and aperture (beam width) of the sectors mounted thereupon (e.g., pointing with respect to true north and aperture in degrees—typically 120 degrees out of 360 for a three sector tower). The location of the wireless device is therefore refined by overlaying on a map the projections of the sectors that can be heard by the wireless device with the intersection of the sectors being the presumed area in which the device is transmitting (1005).

Disablement

Wireless devices that are deemed to be foes can subsequently be quarantined or temporarily disabled. All standards provide for dealing with a malfunctioning wireless device by having the beacons in the registration area issue a command to the wireless device to which the wireless device responds by disabling itself until it is power cycled. The baiting beacon can use this command to disable wireless devices in the operational area.

In other cases, wireless devices can be disabled by irradiating them with large signal levels in the frequency band in which such devices are known to operate and thereby tripping protection circuitry that can only be reset by power cycling. The technique is further refined by either matching the bandwidth of the interferer to the operational bandwidth of the device so as to concentrate the energy and then sweeping this energy across the operational band over time or detecting the frequencies on which the cellular or paging systems are operating in the operational area and concentrating the energy in those channels. This technique is particularly useful for disabling strictly passive wireless devices such as one-way pagers that cannot be interrogated. Furthermore collateral interference is controlled by controlling the tripping signal power so that only devices within the operational area will be affected. One example is baggage screening where the apparatus operates in close proximity to the wireless device. Collateral interference may be further limited by the use of either radio-opaque containers or directional antennas.

Determination of the MIN

In the case of wireless devices that operate according to the GSM standard the filtering system can hijack the device and make a phone call on the network and use the network's caller ID functionality to detect the calling number of the wireless device.

General Principles of the Techniques for Access Filtering

As described for the interrogation process, the transceiver first scans a forward band in search of beacons (204, 502) that can be detected in some operational area. Since wireless devices are generally programmed to only operate on networks (i.e., entertain a beacon) of the service provider that supplies the wireless device (or on networks with which the service provider may have reciprocity agreements—known in the art as a “roaming agreement”), the filtering system must make note of both the service provider to which a beacon belongs and the standard used by the beacon. The transceiver then formulates an ordered selection factor list for a service provider and standard, using criteria such as the signal strength and quality to determine the most probable serving beacon for a wireless device using a particular standard and service provider in the operational area and proceeds to monitor the serving beacon (502, 508) awaiting incoming or outgoing calls.

Because it cannot be guaranteed that all wireless devices in the operational area will chose the serving beacon that is predicted by the filtering system, all beacons but the one predicted by the filtering system are suppressed. The suppression of the other beacons ensures that all of the wireless devices in the operational area will see the serving beacon as the only viable beacon (511) in the operational area. All of the wireless devices will then monitor the serving beacon for incoming pages and use the serving beacon for all incoming and outgoing calls. The filtering system will typically select the beacon which has the strongest signal in the operational area as the serving beacon. The remaining beacons will normally be significantly lower in power. The power consumption of the filtering system is minimized by attacking the lower power beacons while allowing the serving beacon to remain viable and only attacking the serving beacon when necessary.

Once the filtering system has established the timing of the network on any given beacon, the filtering system is capable of listening to either side of the signal interface between the wireless device and the serving beacon. It is therefore able to detect and react in real-time to important events such as a registration or a call set up and to obtain identifying information about the wireless device from these events. The filtering system applies the identification information to a friend or foe data base to determine on either a per-wireless device or per-wireless device class basis which wireless devices in the operational area are to be allowed access (507).

Surgical Attack, Power Consumption and Conspicuousness

The ability to attack only a small fraction of symbols within some message within some protocol or the ability to target specific aspects of a signal such as a pilot makes it possible to reduce the average power consumption of the interference signal by several orders of magnitude. This power reduction is particularly relevant with regard to beacons that operate according to standards such as CDMA which are intrinsically resistant to jamming attacks based on noise alone. This further fosters the desired characteristic of inconspicuousness, as the interference fundamentally “hides” within the signal that is being attacked (i.e., has the same modulation and bandwidth characteristics) and in many case the signal can be limited to small and seemingly randomized transmission times.

Categories of Filtering

At each step in the above described processes there is the potential to effect either broad or selective filtering. Four categories of filtering can be specified for the filtering system. They include: Blanket Denial of Service (DoS), which precludes all access to the network in some prescribed operational area; Negative Filtering, which prevents proscribed wireless devices or classes thereof from gaining initial access to a wireless system; Positive Filtering, which allows only prescribed wireless devices or classes of wireless devices to gain access to a wireless system; and Surgical Suppression, which surgically interferes with specific wireless devices after the wireless devices have gained access to a wireless system. The surgical interference may either directly jam communication and possibly force the wireless device off the air or prolong communication for purposes of either locating the wireless device or keeping it otherwise engaged. The kind of filtering done by the filtering system further depends on whether the forward or reverse link is being interfered with.

Broad Area Denial-of-Service

All standards provide for a wireless device to issue a power down alert to the network to indicate that the wireless device will no longer be able to accept incoming calls. As described previously, prior art has described techniques for hijacking a phone and feigning a power down to prevent the routing of incoming calls to a wireless device and as described under the heading of Roaming and Network Access, all standards employ the notion of a registration area wherein all pages intended for wireless devices that are currently registered therein are sent to all simultaneously to all of the towers in said area (206). Consequently, the filtering system need only listen to any one of the towers in a registration area to hear all of the pages for that registration area. If a filtering system is placed at a location where a number of registration areas overlap, the filtering system can listen to the pages and channel assignments from beacons in each of the registration areas.

It is therefore possible to compile at least a partial if not complete inventory of all of the wireless devices that are operational in a number of registration areas and then prevent all incoming calls over a wide area (essentially the union of all of the registration areas) by forming a list derived from a representative tower in each registration area and effecting a power-down hijack for each wireless device in the list by calling any tower in the same registration area in which the wireless device was detected. By further extension, using multiple suitably dispersed filtering systems, all incoming service to entire geographic regions can be suppressed and further still the effect is scalable indefinitely, limited only by the number of filtering systems.

Standard-Specific Methods

CDMA and CDMA 2000

CDMA and CDMA 2000 are governed by the Telecommunications Industry Association interim standards TIA IS-95B and TIA IS-2000 respectively. These standards are incorporated herein by reference.

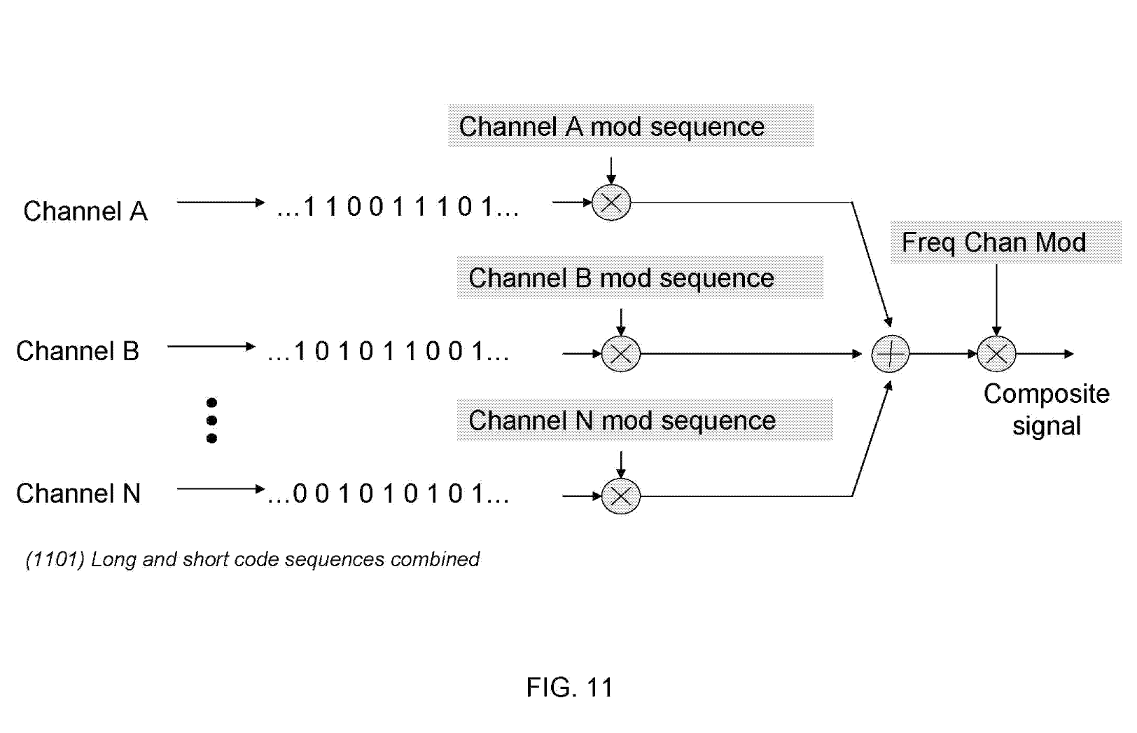

CDMA signals use direct sequence spread spectrum modulation technique to allow multiple beacons and multiple wireless devices to share RF spectrum simultaneously. The signals are distinguished by modulating each with a mutually orthogonal time-coded sequence. The sequences are synchronized directly to the Global Positioning System (GPS) to within sub-microsecond timing. The general principle is shown in FIG. 11.

The specific formatting, coding and modulation of the forward and reverse channel signaling can be found in sections 7 and 6 respectively of IS-95B. A summary diagram for the forward channel is presented in FIG. 7.1.3.1-1 of the IS-95B standard. Summary diagrams for access probe and reverse channel signaling are presented in FIGS. 6.1.3.1-1 to 7 of the IS-95B standard. The above references apply to CDMA 2000 signals.

The CDMA code sequences (1101) are composed of what is known in the art as the long and short code sequences in tandem. The forward and the paired reverse channel have slightly different long and short code schemes necessitating some differences in attack strategies. The former uses a decimated long code such that is only modulated on per Walsh code basis (every 64 chips—refer to block denoted “decimator” in FIG. 7.1.3.1-1 of IS-95B) and the latter modulates the long code on every chip

In either direction, the long code sequence is derived from the Electronic Serial Number (ESN) of the wireless device when it is in a “traffic” state (e.g., a phone call is in progress). However in the forward channel case, because the long code is only applied on a per Walsh code basis, it is not necessary to have knowledge of or otherwise utilize the ESN to achieve suppression in the traffic state.

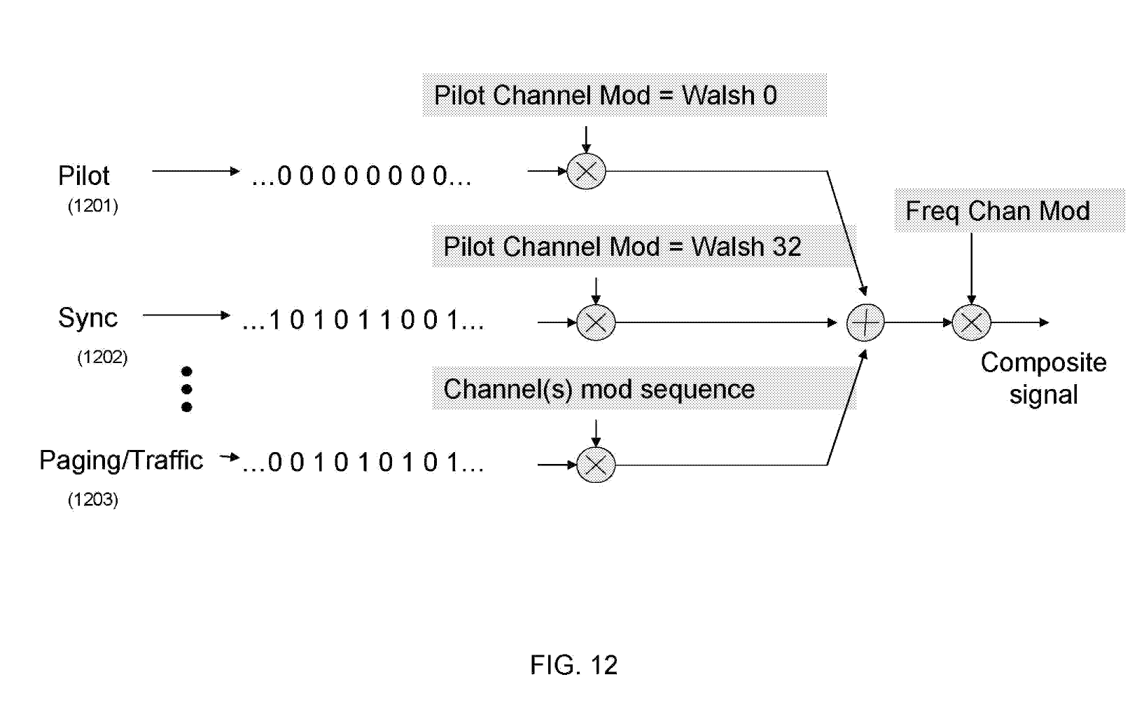

The CDMA beacon operating on some forward link frequency channel is provides a pilot and sync channel and some number of paging and traffic channels. All of the channels operate on the same frequency channel but are distinguished by different code sequences as summarized in FIG. 12. Upon powering up, the wireless device searches a set of programmed RF operational band(s) for the pilot channels of each beacon (1201). The wireless device will then use the pilot channel to acquire the sync channel (1202) to synchronize to the timing of the beacon and then extract a set of messages, known in the art as “overhead” messages, that is repeatedly broadcast on the first paging channel (1203). These messages are used by the wireless device to identify the network on which the beacon is operating as well as to obtain parameters for the behavior of the wireless device when interacting with the network. Included in the parameters are the ones necessary for formulating access probes to gain access to the system.

An important characteristic of the forward channel is that the timing of all code channels is based on the timing of the pilot channel which is in turn locked to GPS. In order to recover any given code channel, the receiver must synchronize to the pilot. Because all wireless devices monitoring the beacon must synchronize to the beacon's pilot, it is in general not possible to attack the pilot channel without running the risk of causing interference on unintended code channels. Under highly specific circumstances, however, the filtering system is able to attack the pilot channel. The synchronization of all code channels to the pilot channel also means that the timing of all of the code channels is co-dependent. The power levels of all of the code channels are all nominally equal. The pilot channel, however, except that the pilot has a signal strength which is 2-4 times greater than that of the code channels.

CDMA is also designed to maximize frequency reuse. An important feature of the standard is that multiple beacons can operate simultaneously on the same frequency channel. This is made possible by having each beacon delay its pilot signal (known in the art as a pilot PN offset) be a different amount. The delay ensures that the scrambling codes used by each beacon remain orthogonal and hence separable.

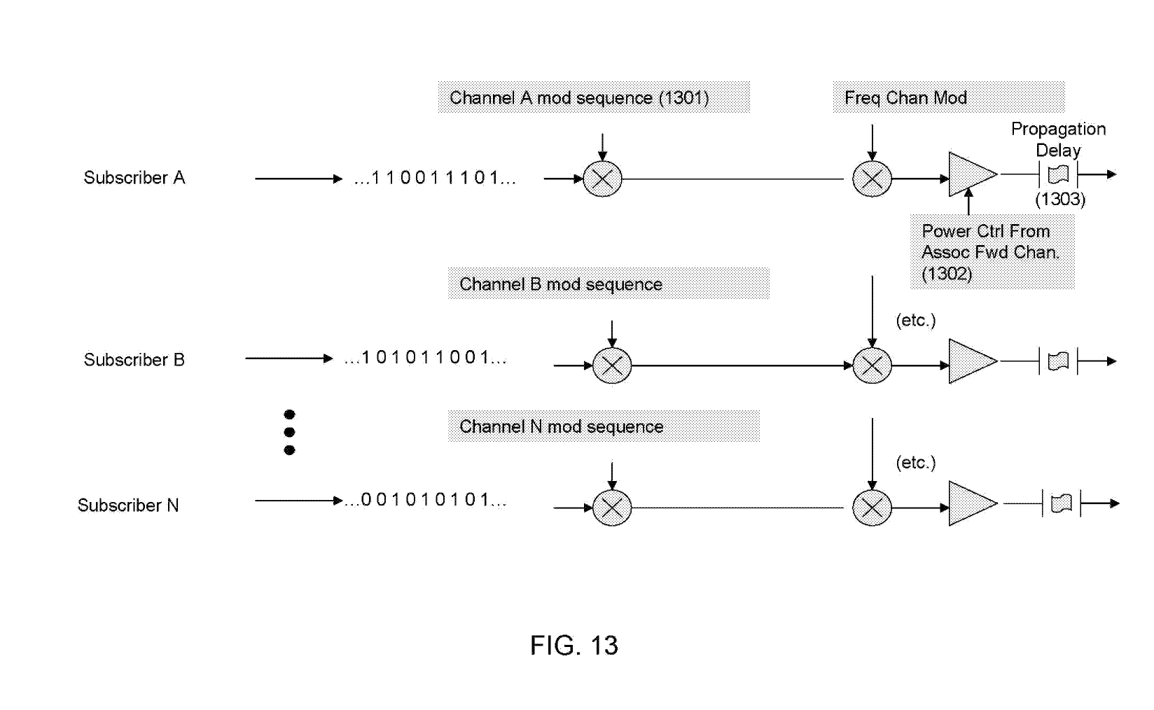

The reverse channel signaling is expressed in FIG. 13. The most important differences between reverse channel signaling and forward channel signaling are: all code channels are independent (1301) of one another and their power levels are distinct (1302), as they actively controlled by the base station via the paired forward channel; furthermore (1303) the absolute timing of each will vary as a function of the propagation time from the transmitter to the receiver (notwithstanding that they are implicitly locked to GPS via the forward link pilot channel); and unlike the forward channel there is no common pilot channel (although CDMA 2000 provides for an individual pilot associated with individual code channels).

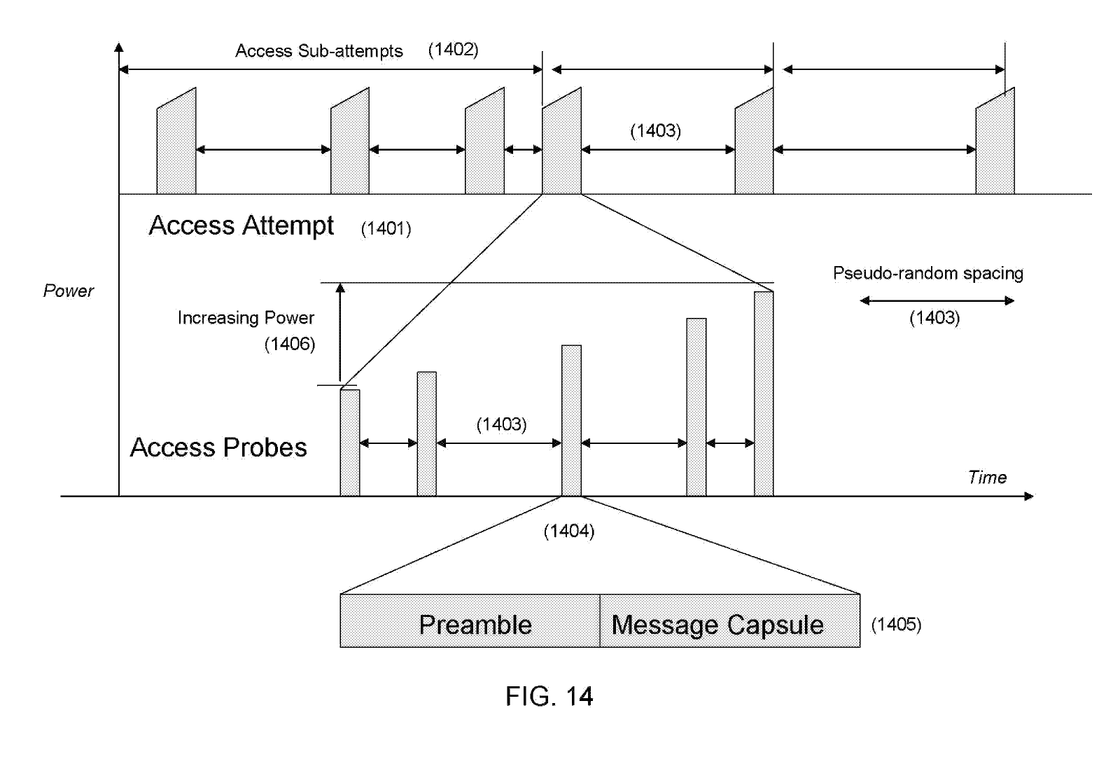

Access to a CDMA based wireless system is through the use of an Access Probe (AP). FIG. 14 summarizes the structure and operation of the AP. A detailed diagram is shown in FIG. 6.6.3.1.1.1-1. of IS-95B. When a wireless device attempts to communicate with the wireless network, including attempting placement of an outgoing call (an origination) or attempting a response to a page (in the case of an incoming call), the wireless device formulates an Access Attempt (1401). An access attempt is a collection of access sub-attempts (1402) that are pseudo-randomly spaced in time (1403) in order to mitigate collisions with access attempts by other wireless devices. The sub-attempt itself is a series of Access Probes (1404) each containing repeated bursts (1405) with increasing power (1406). The bursts have pseudo-random spacing (1403). After each burst the wireless device monitors the beacon paging channel(s) waiting for the network to respond. The AP bursts cease when either the Access Attempt reaches its limit of sub-attempts or when a response is detected. Embedded in the AP is the identifying information specific to the wireless device. This can be the ESN, the IMSI, the MIN or the TMSI. Parameters governing the formation of Access Attempts and Access Probes intended for the beacon to which the wireless device is attempting to gain access. are provided by the access parameters message that is broadcast by the beacon. The parameters include the span of the pseudo-random spacing between repeats; the number and size of power increments or the maximum number of sub-attempts.

CDMA Waveform Attack Methodologies

The filtering system uses a number of waveform vulnerabilities of the CDMA standard to achieve network access filtering and/or surgical suppression.

Waveform Overriding—The orthogonal noise-like nature of the CDMA waveform offers possibilities for overriding the waveform. The hallmark property of the CDMA waveform is its use of direct sequence spread spectrum modulation techniques. This allows a receiver to distinguish and coherently combine multiple echoes (known in the art as multi-path due to multiple path delays caused by various effects, such a reflections, refraction or diffraction) of the received signal and thereby enhance the receiver performance. CDMA receivers typically select a limited number of the strongest paths (echoes) which the receiver detects across a delay spread of typically several microseconds. The filtering system overrides a CDMA waveform by offering one or more copies of another signal having different delays (typically across several microseconds) that are timed to the signal under attack. The use of the different delays requires far less power to cause the receiver to abandon the legitimate signal in favor of the overriding signal than the power need to overwhelm the signal directly. Furthermore it offers the possibility of inserting information into the signal offered by the filtering system.

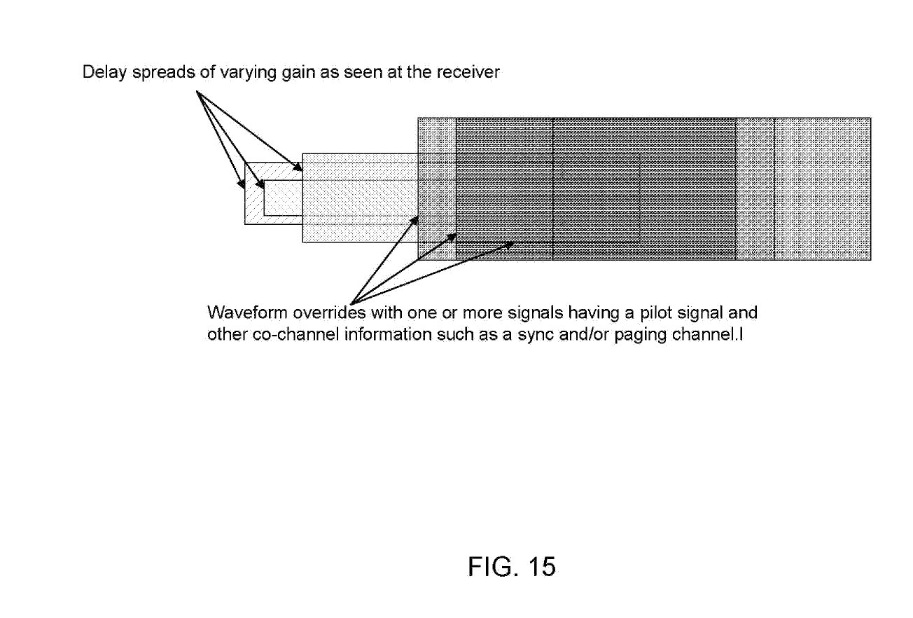

Because of the previously-described difficulties with attacking the forward channel pilot, this attack is largely limited to the reverse channels or blanket denial of service modes on the forward channel. However, the filtering system does use a pilot attack for surgical suppression in limited circumstances as described further below. The waveform overriding technique is illustrated in FIG. 15.

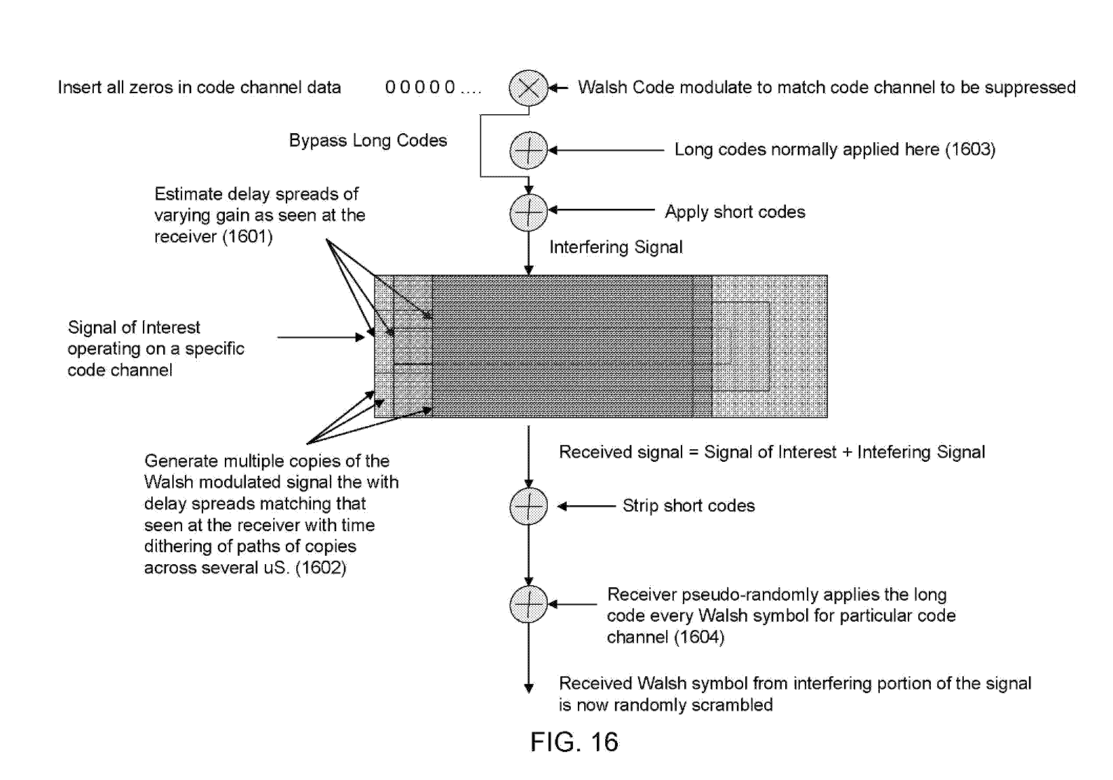

Direct Waveform Attack—CDMA waveform attacks are predicated on whether they are operating in either blanket or surgical mode and whether they are operating on the forward or reverse link. The attack contemplates using either of two strategies. The first strategy, shown in FIG. 16, is a direct attack on the waveform by timing to it directly to within a single chip.

In the first strategy, the filtering system estimates timing of any code channel as seen at the receiver of the wireless device. The estimation can be made if the filtering system is within a thousand feet or less of the wireless device and is attacking the forward channel (1601) (<1000 feet). In this case it simply a matter of generating an interfering signal that is directly matched to the forward channel's codes at a power level only slightly higher than that of the beacon. The filtering system further refines the attack by recognizing that the typical multi-path is in the 2 to 3 uS range and offering multiple copies of the signals in that range (1602). The limitation of this refinement is that as more copies of the signals are added, the likelihood of interfering with a co-spectral code channel increases. This is so because the delayed copies are delayed relative to the pilot and are therefore necessarily no longer strictly orthogonal to the other code channels.

The filtering system further need not know the identification information for the wireless device to attack any given code channel. Even though the Walsh symbols unique to the code channel are pseudo-randomly (1603) inverted by the long code which is in turn derived from the ESN (electronic serial number of the wireless device, the filtering system need not match this pseudo-random inversion but instead allows the pseudo-random inversion performed by the forward channel receiver in the wireless device to act on behalf of the filtering system (1604). (i.e., the wireless device creates its own scrambled interference).

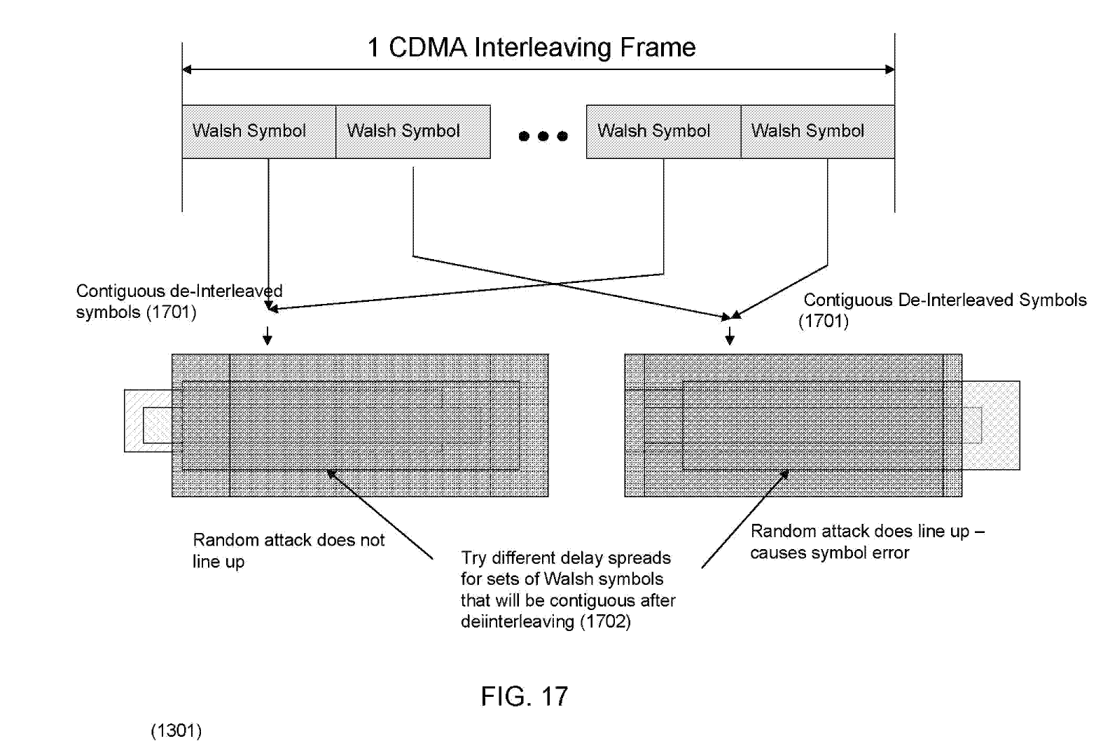

The second strategy, shown in FIG. 17, is and extension of the first but does not require precise (chip level) knowledge of the waveform timing. Instead it dithers the timing of the waveform across some broad delay spread to force a CRC error as described below.

This attack recognizes that it is not necessary to attack the entire waveform but instead attack enough symbols in the right places to force a CRC error in the receiver. In principal it is only necessary to attack a particular symbol set whose members are related by the interleaving process (1701). However, because the timing of the waveform is not known precisely, there is little chance of success in picking a random delay for the symbol set that will line up with the delay as seen at the wireless receiver. Instead the filtering system attacks multiple symbol sets but randomly dithers their delay across some nominal delay spread (e.g., 0 to 5 uS) (1702) with the expectation of lining up on the actual delay and corrupting at least one symbol set within the frame.

CRC Attack—CDMA transmissions are collected into packets consisting of a data payload and a Cyclic Redundancy Check (CRC) (or in some contexts as a Frame Quality Indicator) appended to the packet. The CRC enables a receiver to detect whether an error occurred in the transmission of the packet. When the receiver detects a CRC error it will discard the packet. If enough packets are discarded, the link can be crippled such that it remains open but intelligible communication is minimized. Increasing the discard packet rate further will ultimately cause one side or the other to terminate the link. CRCs are constructed such that all bits whether in the payload of the packet or the CRC itself are treated equally. This means that it is only necessary to corrupt one or more bits anywhere in the packet to cause a packet error.

The filtering system causes bit errors by using the previously described waveform or attacks and limiting transmission times to a small subset of symbols. The transmission times are matched to the interleaving process employed by CDMA. It is well understood in the art that the purpose of interleaving is to combat the “bursty” noise that is most common source of interference in wireless transmissions. The interleaving process acts to spread out contiguous errors caused by bursty noise in the post deinterleaved symbol sequences following reception and thereby operates to improve the performance of the convolutional decoding processes (e.g., Viterbi or Turbo decoding algorithms) that follow. It is also well understood in the art that these algorithms have a fundamental weakness in that if by chance the errors that occur during transmission are such that they end up being contiguous in the post deinterleaved symbol sequences (i.e., matched to the interleaving process), the receiver performance is likely to suffer dramatically because the convolutional decoder, which is predicated on making decisions based on sequences of symbols rather than making decisions on individual symbols, will abandon some intended sequence in favor of another sequence (i.e., ‘jump track”) and thereby create an avalanche effect causing most if not all of the bits received to be treated as corrupt.

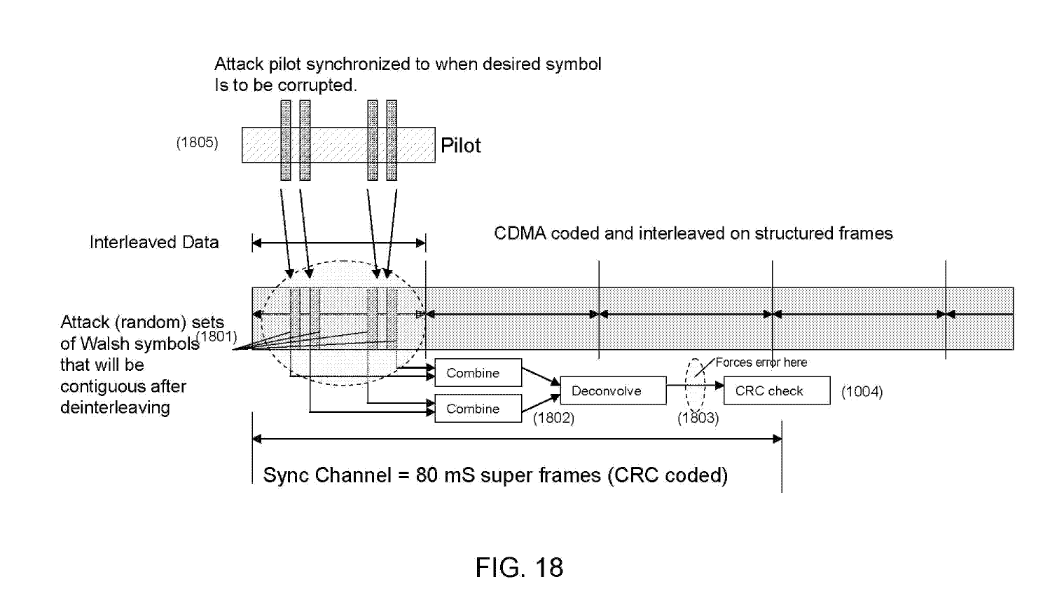

FIG. 18 illustrates the attack strategy. The filtering system surgically attacks sets of Walsh symbols (1801) that will be contiguous after the de-interleaving process using the previously described attack techniques. The convolutional decoder sees multiple contiguous errors (1802) and selects the wrong decode path causing most of the data to be decoded erroneously (1803) and thus any subsequent CRC fails (1804).

Which “sets” of bits are attacked can be chosen at random. Limiting transmission time to a very small subset (10% to 15%) of randomly chosen frames, the aims of limiting both the amount of required power and the ability to detect and/or locate the source of interference are achieved. Furthermore it is possible to attack the pilot signaling with which a code symbol is synchronized instead of the code symbol itself (1805).

Baiting and Suppression

Creating Baiting Beacons

As a first step in suppressing the relevant beacons in the operational area, receiver subsystem (502) of the filtering system will perform a scan of the environment in the operational area and analyze the relevant beacons. Receiver subsystem (601) then sets up the generation subsystem (602) so that it generates a baiting beacon at some signal level on some frequency channel with some pilot PN offset. The baiting beacon's parameters will normally be set to make it a clone of the most conspicuous existing beacon. The baiting beacon will be slightly modified so that it appears to be in a different registration area from that of the beacon the baiting beacon was cloned from. There may also be other parameter settings in the baiting beacon that maximize the conspicuousness of any wireless devices that register on the baiting beacon. The baiting beacon also has some additional feature which enables the filtering system's receiver to recognize the baiting beacon as such. Examples of such features are:
including a special code in a message which the standard requires the beacon to transmit. The special code may be either unexpected or impossible on the networks seen in the operational area; or
introducing a nonstandard or obsolete message. Because the message is nonstandard or obsolete, it is ignored by the wireless devices.

After the baiting beacon has been set up, the receiver repeats the scan. This time, it picks up the relevant beacons as well as the baiting beacon. The receiver then computes the timing differences between the baiting beacon and the relevant beacons using any available signal processing techniques for doing so—such as direct or indirect signal cross-correlation and subsequent demodulation.

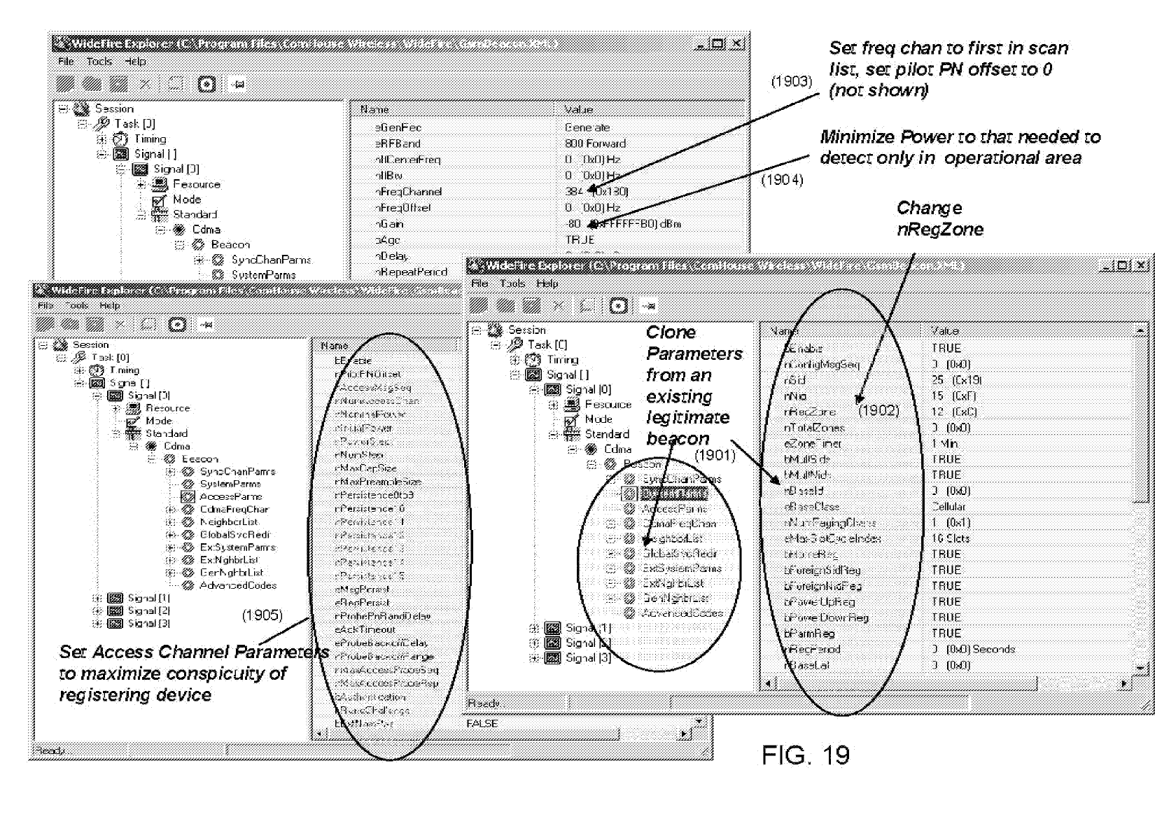

FIG. 19 shows an example of using WideFire® Dragon series test equipment to create a baiting beacon. A description of WideFire Dragon series test equipment could be found in July, 2006 at comh.com/products/products.asp. The baiting beacon is created from a clone of an existing beacon (1901) with a few modifications such changing the registration area (1902) and then set to be on a desired channel (1903) at a signal level that is set such that it can only be detected in the operational area (1904). Other parameters can be set to increase the conspicuousness of the registering wireless device. For example, the parameters that specify the duration and signal strength of an access probe from a wireless device to the beacon can be selected to maximize the duration and signal strength (1905).

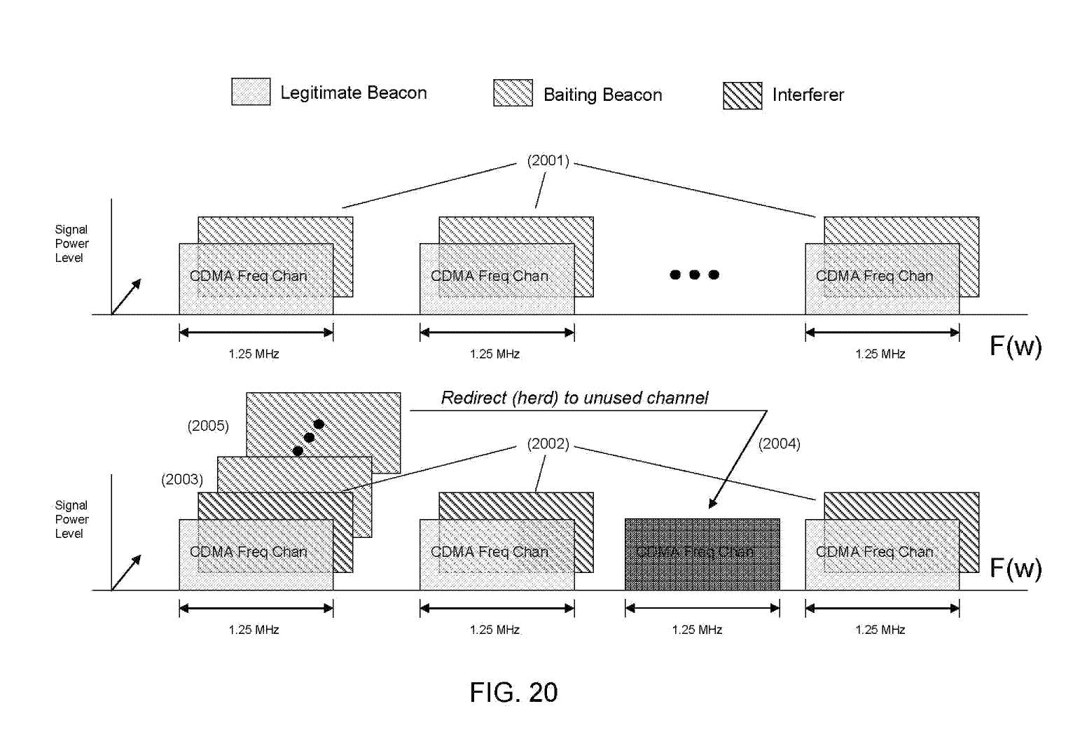

FIG. 20 shows two possibilities for the placement and nature of interfering signals and baiting beacons. As shown at (2001), the interfering signals can be produced by artificial beacons having a different pilot PN offset from the PN offset of the relevant beacons. This arrangement baits the wireless devices on all of the frequency channels used by the relevant beacons simultaneously (2001). However, this method is inferior to that proposed in the filtering system because the receiver must monitor all of the back channels associated with the beacons to detect registration attempts. Making a receiver that does this is much more complex and expensive than making a receiver that only modifies the forward channels. Instead, the filtering system uses interference signals to force all the wireless devices in the operational area to register on a single baiting beacon operating on a single frequency channel (2002).

A preferred location for a beacon in the spectrum is on the lowest unused pilot PN offset on what is the generally the first channel in the particular network that is scanned by the wireless device in the particular network. If the first channel to be scanned is occupied by an existing legitimate beacon then the baiting beacon can transmit at a level such that it acts as both an interferer with regard to the legitimate beacon and a baiting beacon (2003). Operating on the first channel to be scanned minimizes the time the wireless device requires to register with the baiting beacon, but other channels could be used as well.

In some cases the filtering system will choose to bait on an unused channel so as to eliminate any co-channel interference intrinsic to CDMA and thereby simplify the process of subsequently locating a wireless device that is operating on the unused channel by using techniques such as direction finding, angle of arrival or time difference arrival (2004). Specifically the CDMA standard provides for configuring a beacon such that a wireless device that attempts to register with a beacon in the wireless device's registration area signal is redirected to another beacon for registration. In this technique, the filtering system provides two baiting beacons—a first baiting beacon for baiting devices in the operational area and a second baiting beacon that operates in a quiescent portion of the spectrum. The first baiting beacon redirects the wireless device to the second baiting beacon. In one embodiment of the filtering system, how the baiting beacons are placed is up the user of the filtering system. If the user does not specify the placement, the filtering system provides a default placement for the baiting beacons.

It may be necessary to generate several baiting beacons simultaneously to address cases where a particular wireless device is programmed with a preset list known in the art as the preferred roaming list (PRL). Some scenarios may call for a cloned baiting beacon corresponding to each wireless service provider whose beacons are is detected in the operational area and one or more additional baiting beacons that are designed to be as general as possible to snare wireless devices that are completely foreign to the operational area. This problem is addressed by simply introducing one or more additional baiting beacons that operate on the same frequency channel but have different pilot PN offsets. This minimizes the multiple frequency channel monitoring problem by placing all the beacons on the same frequency channel (2005). Another possibility previously described is to duplex the beacon across the provider sub-bands.

Interfering signals

Any class of interference signals will work to cause a wireless device to reregister with a baiting beacon as long as the interference signals prevent the wireless device from detecting the signal of a relevant beacon. Examples of interference signals that will work are simple white noise or a modified CDMA signal that uses illegal code sequences. CDMA signals are, however, inherently resistant to jamming. Because this is so an indiscriminant jamming signal such as white noise centered upon the same frequency and having the same bandwidth as a relevant beacon that is to be suppressed must have a signal strength in the operational area that is on the order of 100 times the signal strength of the relevant beacon in the operational area. The signal strength necessary for indiscriminate jamming is a particular problem when legitimate beacons are operating at high power and in close proximity to the operational area.

The filtering system is able to generate interference signals that require no more power to suppress a relevant beacon in an operational area than the power of the relevant beacon's signal in the operational area. The filtering system achieves this by limiting the bandwidth of the interfering signals to that of the relevant beacon and attacking only critical sections of the waveform within the bandwidth (FIGS. 16 and 17). By limiting the attack to only critical sections of the waveform (FIG. 18), the filtering system minimizes the transmit on-time of the interfering signal and thus significantly reduces the average power required to suppress the relevant beacon. Matching the bandwidth and power level of the interfering signals to the bandwidth and power levels of the relevant beacons also hides the interfering signals within the waveform produced by the relevant beacons, making the interfering signals hard to detect. Where it is necessary to hide the interrogating system so that its location cannot be detected and countermeasures cannot be employed against it, the transmit on-time may be randomized.

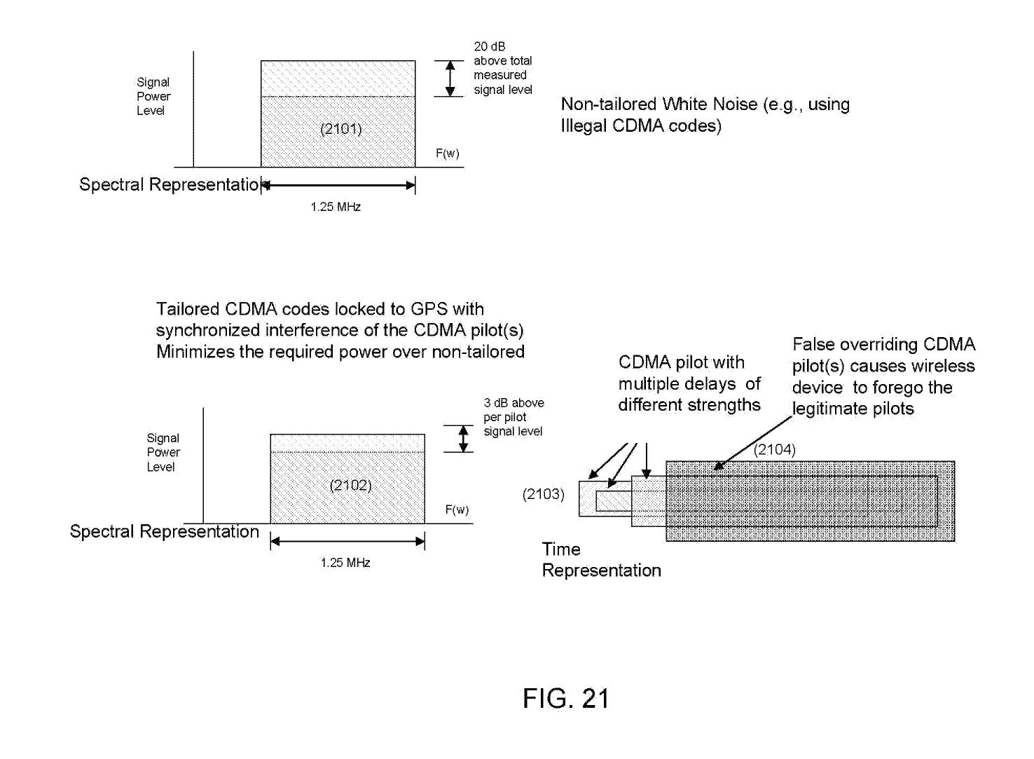

FIG. 21 shows several different examples of the types of interfering signals that may be used by the filtering system to suppress CDMA beacons. Because the filtering system is precisely synchronized to the relevant CDMA beacon it is possible to perform a direct attack on the relevant beacon's pilot signal by proffering an interfering pilot signal with false delays that are either slightly advanced or slightly retarded with respect to the relevant beacon's pilot signal but still close enough to the timing of the relevant beacon's pilot signal for the wireless device to lock onto the false pilot signal rather than onto the relevant beacon's pilot signal (2102, 2103, 2104). Because the timing from the pilot signal is used by the wireless device to interpret the remaining portions of the signal from the relevant beacon, a wireless device that is locked onto the false pilot signal cannot interpret any of the signal from the relevant beacon. The interfering pilot signal thus forces the wireless device to lose contact with its network, and that in turn forces the wireless device to reregister with the baiting beacon. This has the distinct advantage that the interfering pilots need only be slightly larger in signal strength than the legitimate pilots as received by the wireless device (2102, 2103, 2104) instead of the previously mentioned 100 fold increase in signal level required by a non synchronized white noise attack (2101).

Another possible attack, expressed is to recognize that all CDMA channels (such as the sync channel) use CRCs and are therefore susceptible to the previously described CRC attacks. Symbols in the sync code channel can be directly attacked by generating interfering symbols that are coded to that channel. Another possibility is to indirectly attack symbols using the previously described pilot signal attack. As a result of the attack on the sync code channel, the synchronization required to correctly read the symbol is disturbed and the wireless device reads the symbol incorrectly. Either form of attack causes enough post deconvolution bit errors that the CRC for the checking span to which the packet belongs to indicate that the packet is bad and thereby cause the wireless device to drop or otherwise ignore the packet and any message to which the packet belongs. Again, only a relatively small number of post-interleaved symbols on a reduced subset of frames need be attacked, and the power requirements for the filtering system are correspondingly small.

Obtaining Identification Information from the Wireless Device

In the filtering system, a receiver is paired with each baiting beacon. The receiver looks for registration bursts from wireless devices. In the CDMA standard, these registration bursts are termed access probes (303, 402). Many properties of a wireless device's access probe are controlled by parameters which the wireless device receives from the beacon it is monitoring (205, 301). Every access probe contains information that identifies the wireless device making the access probe. Proper parameter settings in the beacon can force the wireless device to provide identifying information that uniquely identifies the wireless device. Examples of information that uniquely identifies the wireless device are the device's IMSI or ESN.

Since no single access probe from a wireless device contains all of the access information which may be retrieved from an access code, the filtering system uses a two or perhaps three pass process in which the wireless device is forced to reregister itself with a number of baiting beacons, each one having parameters that require the wireless device to return a different part of the information in the access probe to that baiting beacon. More specifically, each baiting beacon broadcasts an access parameters message which indicates the identifiers for the wireless device which that baiting beacon desires to receive from the wireless device. In other embodiments, each wireless device may be expressly interrogated as it is detected by the baiting beacon to gain the identification information.

Herding Wireless Devices

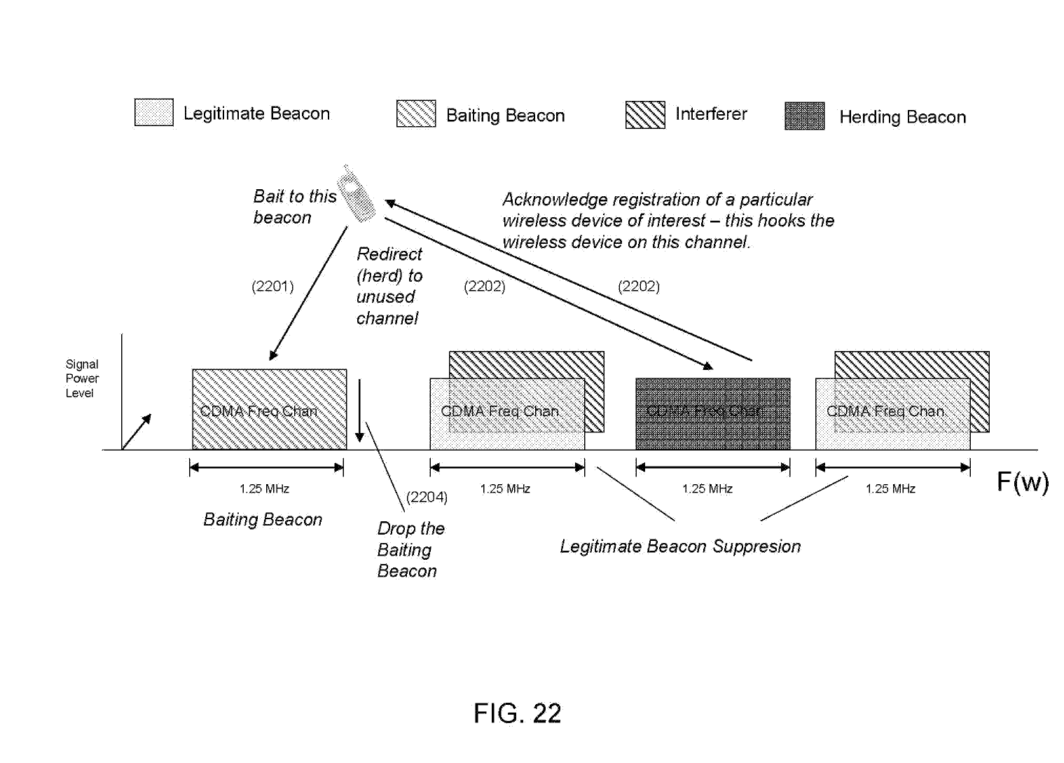

The filtering system can use messages from the baiting beacon to a wireless device to cause the wireless device to operate on an otherwise unused channel. The technique of causing the wireless device to operate on the unused channel is termed herding. Herding is shown in FIG. 22. If the herded wireless device is the only wireless device operating on the unused channel, location of the herded wireless device from the signal it broadcasts becomes dramatically easier. A CDMA wireless device can baited as described previously (2201) and then subsequently herded to attempt access on yet another baiting beacon supplied by the filtering system. This is done by having the first baiting beacon provide channel assignment parameters in either the sync message or the neighbor list messages. Once the access probe of a wireless device that is to be herded (2202) is detected in the first baiting beacon, the interrogating system responds to the access probe with a message on the forward paging channel that indicates that the wireless device is to operate on the herding channel (2203). As soon as the message has been set, the first baiting beacon lowers (2204) its power to prevent any additional wireless devices from being baited and redirected to the herding channel. At this point the wireless device is the only wireless device in the herding channel and can be interrogated at leisure by the baiting beacon on the herding channel.

The herding beacon can modify the parameters it provides to the herded wireless device so that the herded wireless device can be trapped in a continuous registration mode on the herding channel. In this mode, the wireless device will broadcast continuously without further interaction between the baiting beacon and the wireless device. Where continuous broadcasting by the wireless device is undesirable, the baiting beacon may send paging messages to the herded wireless device to elicit additional transmissions from it. The more transmissions the herded wireless device sends, the easier it is to locate it. Herding can also be used to disable the herded wireless device. To do this, the baiting beacon for the herding channel prevents the herded wireless device from either placing outgoing calls or receiving incoming calls.

The baiting beacon for the herding channel can also use a herded wireless device to measure the strengths of the pilot signals from the relevant beacons. This can be done by means of a message from the baiting beacon requesting a pilot strength measurement or by listening for an automatic pilot measurement report message which the CDMA standard requires the wireless device to send to the beacon that the wireless device is monitoring. As will be described in detail below, the pilot strength measurements can be used to locate the wireless device.

Disablement

As already mentioned, the filtering system may use data base (507) to determine whether a wireless device is to be disabled. Once it is determined that a wireless device is to be disabled, there are a number of disablement techniques available. One such technique is using maintenance features provided in the CDMA standards can be used by a baiting beacon to disable a wireless device. The CDMA standard provides that when the network detects a malfunctioning wireless device, the beacon being monitored by the wireless device may send a lock until power cycled command which locks the wireless device and thereby disables it until the wireless device is power cycled. Another such technique is to herd the wireless device onto a channel whose baiting beacon does not respond to calls from the wireless device, calls to the wireless device, or both. Another technique is to highjack the phone and feign to the network that the device is powering down using a power down order access probe with an order message indicating that the device is powering down.

CDMA Access Filtering Methods

The filtering system uses the aforementioned waveform attack techniques to provide several levels of filtering ranging from broad suppression to highly surgical targeting of individual wireless devices. The methods are described for each of the filtering modes: blanket denial-of-service, positive filtering, negative filtering, and surgical suppression. The description of each method includes separate descriptions for attacks on the forward and reverse channels, with additional description for interactive attacks such as interrogation and/or disablement.

CDMA Blanket Denial of Service

Blanket denial of service takes advantage of the fact that a CDMA wireless device can sense multiple beacons in an operational area. It is strictly left to the discretion of the CDMA wireless device as to which beacon it will choose to monitor at any given moment. It is therefore in general, difficult for the filtering system to predict what beacon a given wireless device will monitor with any certainty—particularly in geometries where a wireless device is more or less equidistant from multiple towers. Because this is so, simply attacking the strongest tower may just cause the wireless device to move to monitor the next best choice. CDMA is further complicated by the fact that it incorporates load balancing features. Several beacons operating on different frequency channels may be co-located on a single tower. The wireless device in this case, uses its electronic serial number and a mathematical randomizing algorithm to determine which frequency channel (or beacon thereon) it should work with. This makes it impossible to predict on which beacon any given wireless device will interact if the wireless device's electronic serial number (ESN) is not known in advance—and generally it is not.

As a consequence of the foregoing, effecting a blanket denial of service requires that the filtering system deal with all of the viable beacons in the operational area. As a further consequence, merely offering a stronger beacon that is a clone of a neighboring beacon in hopes of baiting all of the wireless devices to monitor the stronger beacon will not prove effective. Therefore it is understood that the techniques for denying access to a particular beacon which are described in the following may need to be performed in parallel on all viable beacons in the operational area.

CDMA Forward Link Denial of Service

Pilot Attack—This is a direct attack on the pilot signal using a matched interferer (override attack). This prevents the wireless device from detecting or otherwise synchronizing to a beacon. The filtering system using a set of pilot signals having different legitimate pilot PN offsets or operating on the same nominal pilot PN but having a delay spread different from that of the legitimate pilot. The first technique makes it possible to either divert all wireless devices to the proffered pilot signals; the second makes it possible to prevent synchronization to the legitimate pilot, which in turn makes it impossible for the wireless devices to synchronize to the sync channel. The benefit of this approach when considered against a nonspecific attack (e.g., plain white noise) is that the required power is dramatically less (perhaps as much as a factor of 1000 or 30 dB). Furthermore the filtering system randomizes the delay spread and on-time to make it difficult to detect and/or subsequently locate the source of the interference while further minimizing the required power. This type of attack uses the waveform override strategy shown in FIG. 21.

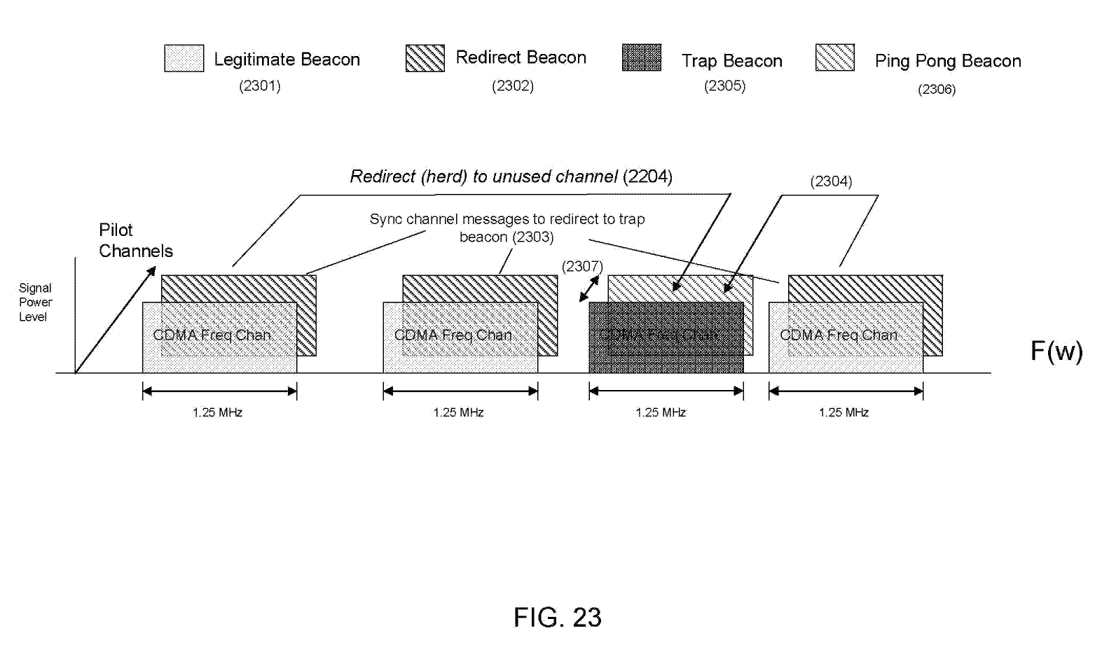

Sync Channel Attack—In this attack, the filtering system synchronizes to the beacon sync channel and then randomly targets a sufficient number of symbols to cause a CRC error in the sync channel message (CRC attack). The interfering signal is expressly modulated synchronous to the sync message such that the interfering bits are only applied during the payload part of the message. This attack is superior to the pilot channel attack with respect to the required power and covertness because the periodicity of the message is such that only a few dozen symbols per second per pilot channel need be corrupted randomly. Specifically it uses the attack methodologies shown in FIGS. 15 through 18 Beacon Override and Herding—The process is shown in FIG. 23. On any given frequency channel on which a legitimate beacon (2301) is operating, the filtering system generates a redirect beacon (2302) that is a clone of the legitimate beacon except that it has a pilot PN offset that is on the neighbor list of the legitimate beacon, at slightly higher signal level. The purpose is to bait a wireless device into monitoring this redirect beacon. The CDMA sync message contains a field that tells the wireless device the channel it should redirect to for paging messages or otherwise use for access. Usually, this field is set to be the same frequency channel that sync channel is operating on (i.e., merely redirects back to itself). However the filtering system codes this field in the sync channel message of the redirect beacon (2303) such that it redirects (2304) the phone to yet another trapping beacon that is also generated by the filtering system (2305). The trapping beacon is expressly crafted to trap the wireless device into monitoring it and/or perform an endless series of registration attempts. One particularly effective method is to neglect to transmit one of the required overhead messages on the paging channel of the trapping beacon—causing the device to wait indefinitely for the required messages before attempting registration. Other methods include but are not limited to: proffering a trapping beacon that baits the devices into registering and then consummating the registration. The trapping beacon is crafted such that it lists no neighbors, hence the wireless device will only monitor the trapping beacon after registration; or redirecting the device to yet another beacon (2306) which will in turn redirect the it back to the first, causing the device to constantly ping-pong between the two (2307).

An important benefit of this approach is that it becomes possible to achieve a significant reduction in transmitted power. More specifically, instead of simultaneously generating a redirect beacon on every frequency channel on which a legitimate beacon is known to be operating, a single redirect beacon can be rotated through each frequency channel. The redirect beacon dwells long enough so to gain the attention of the wireless devices that happen to be monitoring the channel at that time and then moves to the next frequency channel The redirect beacon power can further be tailored to match the legitimate beacon power on each frequency and thereby further reduce the average power consumption. Furthermore, the frequency channel of the trapping beacon is chosen such that it operates in either a quiescent portion of the spectrum or on a frequency channel whose beacon has the minimum received power in the operational area such that its power consumption is negligible when compared to the redirect beacon.

Another important benefit is the ability to carefully limit the operational area by controlling the power levels of both the redirect and trapping beacons. Specifically, adjusting the power of the redirect beacon will dictate the baiting radius. Similarly adjusting the power of the trapping beacon will affect the radius in which wireless devices are trapped.

Another novelty is that if the frequency channel and pilot PN offset are carefully chosen such that they are the first in the preset scan list built into the wireless device it often possible to circumvent the necessity of interfering with all of the legitimate beacons and instead introduce only a single trapping beacon and thereby further significantly reduce the required power.

CDMA Reverse Link Denial of Service

Forward channel DoS attacks are generally preferred due to the ability to limit the size of the operational area by controlling the attack signal level and thereby minimize any attendant collateral interference outside of the operational area. They are also preferred because of their insensitivity to tower sectoring (i.e., directional antennas). With the reverse channel, a wireless device may have a good view of the tower and the filtering system a poor view of the tower. When this is the case, the ability of the filtering system to affect the signal of the wireless device as seen at the tower is reduced or even eliminated. However a reverse channel attack may be the only recourse in situations where the geometry is such that operational area is significantly closer to the base station (tower) than to the interfering transmitter. When that is the case, the power required for a forward channel attack makes the attack impractical.

Blanket access denial is achieved by preventing any beacon from successfully receiving access probes from any wireless devices. The CDMA standard is predicated on a random access mechanism for gaining the initial attention of the base station. It is expected that access probes from different wireless devices will regularly collide such that both mutually interfere and prevent the base station from recognizing either. To address this, the wireless devices use the previously described pseudo-random transmit timing (FIG. 3) to effectively create a random back-off condition.

The occurrence (not to be confused with timing) of an access probe is impossible to predict (e.g., whenever a wireless device chooses to place a call). Furthermore the selection of which of perhaps several code (access) channels on which the attempt is made is also impossible to predict. Notwithstanding the impossibility of predicting the occurrence of an access probe, the legal timing boundaries for when a wireless device can choose to transmit are well defined and are synchronized expressly to the network timing provided by the beacon which the wireless device is attempting to access. However, within these timing boundaries, each access probe is delayed by a pseudo-random amount (referred to in the standard as the PN randomization delay—refer to IS-95B FIG. 6.6.3.1.1.1-1, Access Attempt (Part 2 of 2)) across some defined delay spread as chosen unilaterally by the wireless device. The purpose is to minimize access collisions, as the PN codes having different delays are uncorrelated (orthogonal) and hence the beacon can separate and therefore recover multiple simultaneous attempts—presuming that the power of one is not so large that it overwhelms the others. The purpose of power stepping an Access Probe is precisely to limit this overwhelming effect by starting at some small signal power and gradually increasing it until it can be detected by the tower. Since this randomized delay is impossible to predict, it is impossible to directly interfere with the access probe by using a delayed pilot PN as previously described for the forward channel attacks, as the delayed pilot PN will be filtered out by the base station (i.e., will not suppress the access probe) unless they are of an overwhelming power in which case all wireless devices are affected and the operation is no longer surgical.

The unpredictability of the access probe suggests that any attack must at a minimum interfere with the reverse link by generating a signal on all of the access-channel code channels at all prescribed transmission times to ensure that no access probes get through to the base station. Furthermore since the exact phase (i.e., pilot PN offset) of the code sequences used on the access channels is pseudo-random (i.e., unpredictable) across a large span of CDMA chips, it is impractical to apply the surgical techniques described for the forward link.

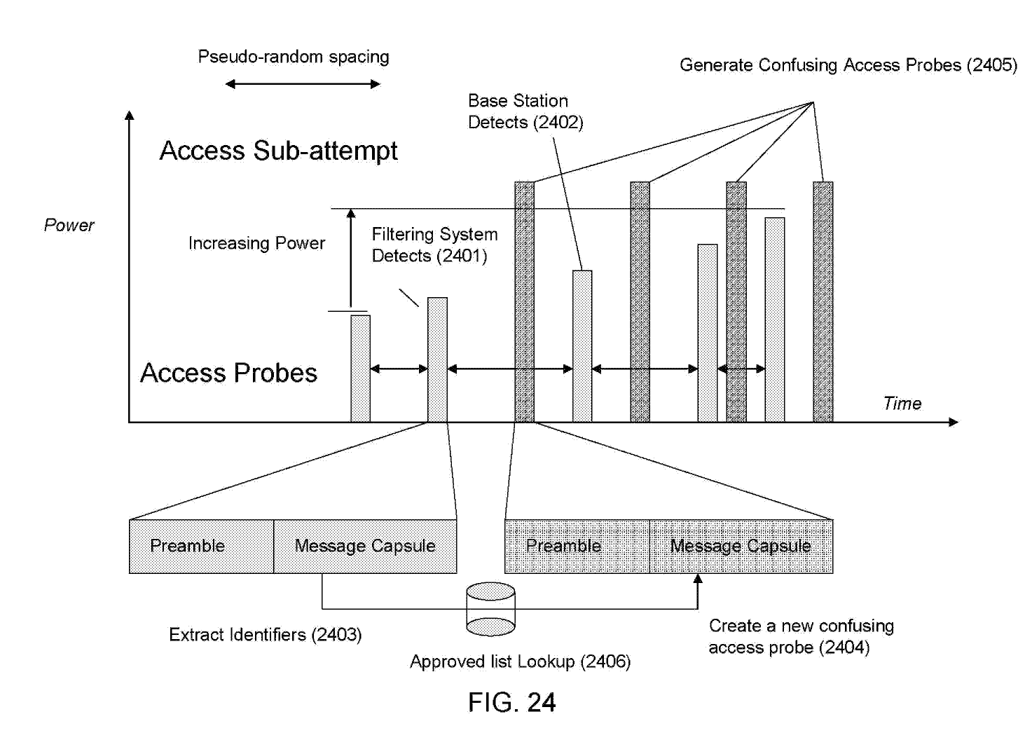

As demonstrated in FIG. 24, the filtering system addresses the foregoing limitations by exploiting the typical case where the interferer is nearer to the wireless device than the wireless device is to the beacon. As noted previously, Access Probes are structured such that the wireless device generates multiple bursts, each with increasing power until the base station responds (FIG. 14 (1406)). As such it is possible for the filtering receiver to detect the access probe (2401) before the base station (2402), extract the wireless device identifying parameters such as ESN embedded in the burst (2403), clone the identifying parameters (2405), and generate some number of additional bursts (2405) either requesting service or indicating that the wireless device is powering down and thereby confuse the base station and preventing either registration or call setup.

Examples of confusing bursts include but are not limited to:
Registration bursts (such as when it is detected that a wireless device is attempting a call setup)
Order messages—as enumerated in Table 6.7.3-1 of IS-95B such as a release order—indicating that the wireless device is powering down; base station challenge—indicating the base station should identify itself;

TAs can be seen from the foregoing, the technique of FIG. 24 does not directly interfere with the legitimate access probe. The technique also achieves significant power savings because the average duty cycle and therefore the attendant on-time of the interferer is equal to the expected birth rate of new registrations or call setups, which will be less than 10% and typically less than 1% of the time.

The technique of FIG. 24 does require that the filtering system monitor the access channels of all of the viable beacons in the operational area. This requirement may be expensive not only from the point of view of cost, but also from the point of view of the size, weight, and power requirements of the filtering systems needed to monitor the access channels. The difficulties caused by the requirement that all access channels be monitored are reduced if the use of the attack is limited to situations where the filtering system is operating in close proximity to a powerful beacon and generates interfering beacon signals (using techniques described for the forward link attack) to suppress all but the beacons on the close tower. The suppression of the other beacons of course forces all of the wireless devices to operate on the close tower.

CDMA Negative Access Filtering

This mode of operation prevents targeted wireless devices from successfully communicating with the network in any manner such as performing registration or receiving pages.

CDMA Forward Link Negative Access Filtering

The filtering system can interrogate interrogating the wireless device as described in PCT/US2006/30159 and then issuing either a specifically crafted lock order on that device or hijacking the device after interrogation and issuing a release order (of type power down order as described previously for CDMA Reverse Link Denial-of-Service) to fool the network into believing that the wireless device is no longer active. These methods are preferred if it is desirable that not even paging messages get through to the device. The lock order can be paired with an unlock order or similarly the release order can be paired with a registration to selectively enable and disable the wireless device at will.

When a beacon detects of an access probe performing either an origination (in the case of an outgoing call) or an answer to a page (in the case of an incoming call), the beacon will issue a channel assignment message via the paging channel which allocates a traffic channel to the wireless device. Consequently, an attack on, all of the paging channels on which this message could appear would achieve the desired suppression. The filtering system can perform this type of attack but it is not the preferred method due to the potential for it to interfere with any collateral wireless devices that may be attempting network access at the same time—since the timing of the channel assignment of interest is the prerogative of the network and hence impossible to predict precisely. However, the likelihood of collision is typically small and the attack requires significantly less power than a post call setup attack on the assigned traffic channel. Hence, this method is useful in cases where some risk of collateral interference is acceptable.

CDMA Reverse Link Negative Access Filtering

The reverse channel negative access filter attack is a logical extension of the blanket denial of service. The identification information embedded in the access probe is used in conjunction with data base 507 (2406) to apply the confusion attack of FIG. 24 to wireless devices as indicated by database 507.

CDMA Positive Access Filtering

The techniques described for positive access filtering are the same as those described for negative access filtering. However in this case, all wireless devices not on the positive (as opposed to those that are on the negative list) are attacked.

Positive filtering is likely to consume significantly higher power as it is presumed that unlike negative filtering where a small subset of wireless devices are denied access and thereby the on-time is relatively small, the reverse is true where the transmission is on most of the time so as to permit access to all but a few wireless devices. To mitigate this problem, the filtering system locks all wireless devices not on the positive list or performs a power down hijack of them as they attempt to gain access to the system.

Call Filtering—Allow or disallow calls to/from specific wireless devices. The filtering system detects either the origination message carried on a reverse channel access probe (in the case of an outgoing call) or on the alert with info message on the forward traffic channel after call setup. In the former case, the outgoing call is addressed by using the techniques described for negative and positive filtering. In the latter case it is necessary to camp a receiver on the forward traffic channel to detect the aforementioned messages and then apply, in the case of an incoming proscribed calling number, the techniques described for surgical traffic suppression (usually on the forward channel) described below to end the call. It is necessary to camp the receiver on the forward traffic channel because only a single message comes down from the beacon (namely the channel assignment message) before the signaling between the wireless device and the beacon moves to the traffic channel.

CDMA Surgical Traffic Suppression

The following methods are used after a wireless device has gained access to the network to either cripple communications so as to maintain the link while preventing useful communication across it or to outright sever the link while the call is in progress. The methods prevent or otherwise limit collateral interference with any other calls that may be in progress.

CDMA wireless devices necessarily co-utilize the same spectrum. The signals for the various wireless devices are kept separate by the specific modulated code sequences that the network dynamically assigns to the wireless devices when the call is established. While it is possible to end a call by attacking the either forward or reverse link with a broadband signal such as non-specific white noise, such an attack requires a power level that is perhaps 20 to 30 dB (100 to 1000 times) greater than the signal under attack as the spread spectrum techniques employed by CDMA are intrinsically resistant to this type of attack. Furthermore, such a white noise attack can be used only to attack any and all wireless devices that are currently active.

While the filtering system is capable of making a white noise attack, the attack which is preferably made by the filtering system is to generate a waveform that is expressly locked to the system timing and the wireless device of interest (i.e., is using the same codes at the same time) and thereby attack only the wireless device of interest without affecting collateral wireless devices. This method of attack further reduces the required power levels by the aforementioned factor of from 100 to 1000 times.

It is critical to the preferred attack that the timing, code sequences, and power of the generated waveform be closely controlled. For instance, if the power of the attack waveform is not commensurate with the signal under attack, it will fail to achieve suppression and conversely if it is above a certain level it begins to interfere with other wireless devices. In fact the CDMA standard expressly addresses this problem on the reverse channels (refer to FIG. 13 (1302)) by incorporating very strict power control signaling on the forward channel that commands the wireless device to constantly adjust its reverse channel power so as to create a situation where the power from all of the wireless devices as seen at the beacon's receiver is the same notwithstanding that the various wireless devices have widely different propagation losses due to factors such as the distance to the base station. To achieve the desired control of the generated wave form's power, the filtering system may use a directional antenna to focus the power of the interfering signal directly at the wireless device of interest or equivalently limit the amount of power received by collateral wireless devices that are not in the beam. The use of the directional antenna can significantly enhance the performance of the attack (commensurate with the selectivity of the antenna) by providing more grace in adjusting the transmitted power. For example it will be necessary for the user of the filtering system to estimate the propagation loss between the transmitter and the wireless device of interest so as to tailor the transmitted power to be in the proper range described above as seen at the wireless device. Incorporating the directional antenna can provide significantly more “wiggle room” for this estimate. The extra wiggle room is important, as it is often difficult in many environments to predict propagation loss.

CDMA Forward Link Surgical Traffic Suppression

The preferred attack takes place on the forward traffic channels for the reasons enumerated below:

Control of collateral interference—The power can be controlled in the forward channel case so that only devices in the operational area are affected. In the reverse case the user must estimate the power of the signal from the wireless device that is received by the beacon and set the interference accordingly without regard to other devices that are operating off of the beacon and hence it is difficult to limit collateral interference to the operational area.

Handoff—Attacking the forward channel prevents the wireless device from receiving a handoff directive as would likely to occur if the attack was on the reverse channel.

Required power—Forward channel attacks are generally more efficient (require less power) due to simple geometric arguments. The only case where this is not true is when the wireless device is operating close to a beacon. The area close to the beacon is however a small fraction of the total area over which a wireless device can operate.

It is nearly impossible to surgically override a forward channel signal such that the filtering system it can force the wireless device to receive even a specified symbol, let alone a message or other data. This is due to the fact that the interpretation of symbols on the traffic channel is based on the carrier phase of the associated pilot channel (refer to FIG. 12). Due to numerous propagation effects such as multipath or the inability to estimate the distance from the transmitter to the wireless device with sufficient precision (less than 1 foot), it is extremely difficult to estimate the carrier phase of the legitimate pilot as is it is seen at the wireless device. Therefore it is virtually impossible in CDMA for the filtering system's transmitter to force the wireless device to receive a particular symbol on the forward band (regardless of power or interference considerations). At most, the filtering system can proffer a pilot that is in phase with the overriding symbol in addition to the overriding symbol, and even in this case it is impossible to predict how the wireless device would react to this if done on a per symbol basis. Furthermore, such a procedure would certainly affect reception by collateral wireless devices that are synchronized to the legitimate pilot.

Moreover, CDMA is predicated on detecting and combining multiple paths which appear in the signal as echoes with varying delays. Therefore, in order to affect the receiver within the aforementioned power constraints it is necessary to attack some or all of those paths directly by overriding them at precisely the right time. Since these paths are derived directly from the pilot signal and since the pilot is used by all wireless devices active on that beacon, a surgical effect is not possible with any technique that affects the pilot.

It may also be possible to mount a override attack by attempting to manipulate the power control bits on the forward channel intended for the wireless device and set them such that it directs the device to power down to the point where it can no longer be heard by the base station. However for reasons described above regarding the ability of a transmitter to force the wireless device to receive a particular symbol, this attack is at best problematic. The net effect is that since it is impossible to control the state of the power control bits as seen at the wireless device, it is impossible to predict whether the device will in fact power up instead of down. This technique could thus produce the unintended consequence of increasing the power of the wireless device, possibly to the point where it begins to interfere with other devices. This method of attack might have limited utility if the transmitter is in very close proximity to the wireless device as compared to other collateral wireless devices and it therefore becomes possible to proffer the aforementioned associated pilot without creating unintended interference. However since the pilot must be on for the duration of the attack, it is unlikely that there would be any power savings over the direct attack on the traffic channel described previously.

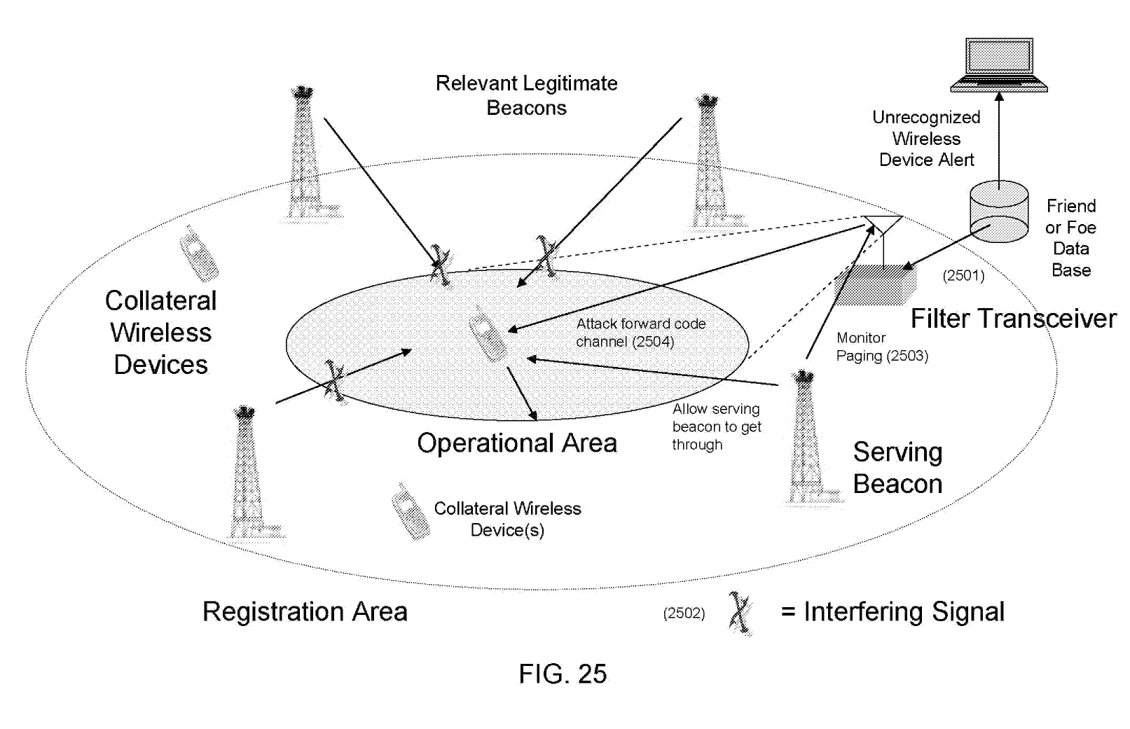

The forward channel attack operates within these constraints by generating a signal that uses the same code channel modulation as the channel of interest. FIG. 25 shows the preferred method of surgical suppression. The filtering system is provided a list of targets (2501). The filtering system then suppresses all but the serving beacon using previously described methods (2502) ensuring that the wireless device will only gain access to the network via the serving beacon. The filtering system then monitors the paging channels of the serving beacon looking for channel assignment messages (2503). The channel assignment messages identify the wireless device and the code channel to be used by the wireless device in the conversation state. The filtering system then attacks the assigned forward code channel (2504) using either the Direct Waveform or CRC attack described previously and shown in FIGS. 15 through 18.

In order to limit collateral interference, the filtering system must limit the power of the attack. The appropriate power level can be determined by estimating the distance between the filtering system and the wireless device being attacked and using well established physical relationships between signal power level and distance. While this information can be provided by the user, the filtering system can also interrogate the wireless device for measurement reports as described in Patent Application PCT/US2006/30159 so as to determine the position of the wireless device and hence estimate its distance automatically. A further enhancement is to interrogate the wireless device and estimate the distance based on the round trip delay. This can be done because the timing between the wireless device and the baiting beacon acting as a legitimate beacon is precise to within less than 1 uS (approximately 1000 feet—which is within the attack delay spread described for the Direct Waveform attack). Collateral interference is further reduced by employing a directional antenna on the filtering system's transmitter. This not only limits the space in which interference can be expected but also permits less exact distance (and hence power) estimates.

GSM, GPRS and EDGE.

In the following, GSM, GPRS and EDGE are collectively referred to as GSM and are governed by the ETSI standards body. The GSM, GPRS, and EDGE standards may be found at http://www.etsi.org. All of these standards are hereby incorporated by reference into the present patent application. GPRS and EDGE are considered to be enhanced modes of the GSM standard and hence it is only necessary to consider GSM with the understanding that wireless devices capable of these modes must necessarily operate as a superset of GSM.

GSM Signal Structuring

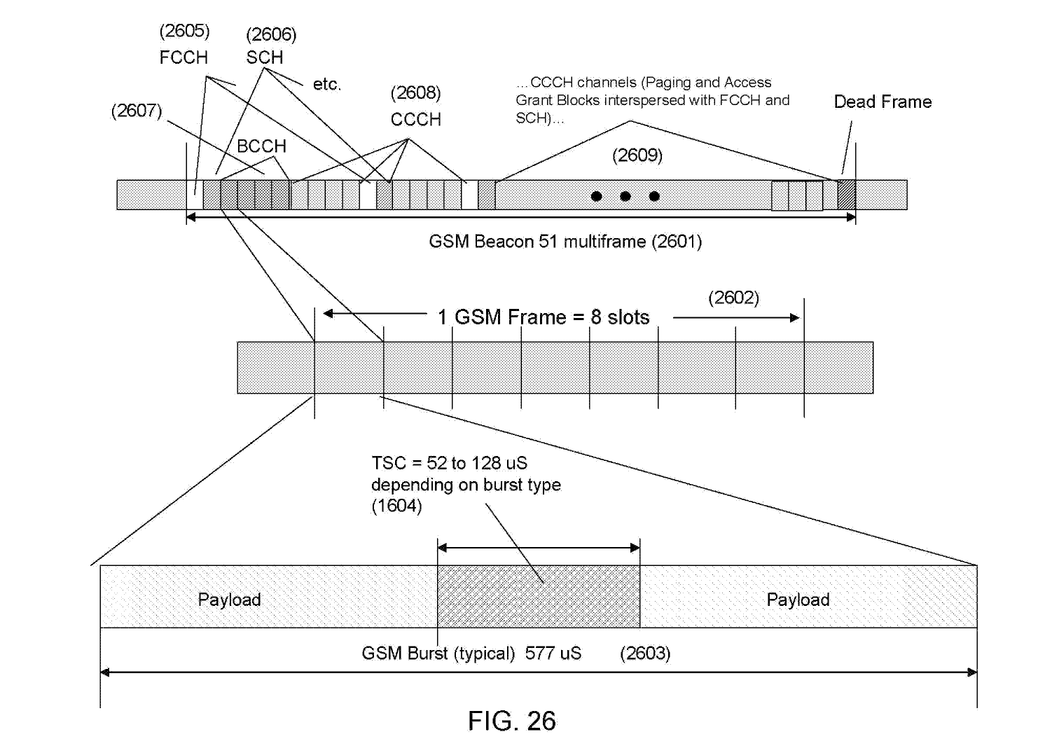

GSM signal structuring is shown in FIG. 26. When operating in non-traffic mode (e.g., beacon signals) GSM uses the 51-multiframe (2601) described in ETSI 45.002 and incorporated herein by reference. It consists of a set of 51 GSM frames each lasting 4.6 mS) (2602) and therefore each 51-multiframe repeats approximately 4 times per second. Each frame is subdivided into 8 time slots each lasting ⅛ of the frame (577 uS) (2603).

Within a slot is a “burst” consisting of a sequence of Gaussian Minimum Shift Keyed (GMSK) modulated symbols. The structure of the burst is also shown in FIG. 26. The center of the burst consists of a few dozen fixed symbols that are denoted as the training sequence (2604)—referred to in the standard as the TSC. The purpose of the TSC is to enable a receiver in the wireless device or beacon to recover the timing of an individual burst within the slot as well as to compute any necessary equalization parameters so as to improve receiver performance in the presence of multipath. The standard provides for 5 types of bursts: Normal, Frequency Correction, Sync, Access and Dummy, Each are described in ETSI 45.002 Section 5.2.

A burst from the GSM beacon occupies slot zero of every frame. The first frame is reserved for the FCCH (2605) logical channel, which is nothing more than a tone burst that is designed to be used by the wireless device to align (correct) its frequency tuning with that of the beacon. The second frame (2606) contains the SCH logical channel. It is comprised of a special sync burst that contains several fields that tentatively (but not unambiguously) identify the beacon and a timing code called the frame number that identifies the frame within the 51-multiframe in which this burst is occurring. The purpose of the sync burst (SCH channel) is that it (among other things) enables the wireless device to unambiguously identify the phase of the 51-multiframe. The next four frames carry the broadcast control channel (BCCH) (2607). The BCCH carries the system messages that identify the beacon, and its configuration and access parameters. The next four frames following the BCCH is the first common control channel (CCCH) (2608) which also has 4 frames. This is followed by another FCCH/SCH pair in the following frame and this process then repeats with 2 CCCH sets (8 frames) and a FCCH/SCH pair for the remainder of the 51-multiframe (2609). Each collection of 4 frames in either the BCCH or CCCH sets is referred to as a “block”. Therefore a beacon has 1 BCCH block and 9 CCCH blocks in a 51-multiframe. The CCCH blocks themselves are subdivided into logical paging (PCH) or access grant (AGCH) channels (blocks) depending on what is specified in the system messages broadcast on the BCCH. For example, in some configurations, all 9 CCCHs are reserved for paging and in others, some are reserved for paging and others for access grant. The purpose of a PCH is to page a wireless device and the purpose of the AGCH is to assign temporary channels. Their distinction is unimportant to the present context as access grant messages can be designated to be sent on PCHs if the beacon is so configured.

The remainder of the 51-multiframe slots will carry other types of signaling at the discretion of the beacon—these can be stand-alone dedicated control channels (SDCCHs) traffic channels (TCHs) or perhaps special GPRS signaling channels. Typically (but not necessarily) slot 1 (0 based) will carry an SDCCH. SDCCHs also use the 51-multiframe structure (which necessarily coincides with the 51-multiframe phase used in slot 0). The first 32 frames are subdivided into 8 4-frame blocks similar to that described for BCCH and CCCH channels. The remaining frames carry slow-associated-control channels (SACCHs) that are associated with each SDCCH but are not important to the present context. In this example the SDCCH running on slot 1 can support 8 subchannels. The purpose of the SDCCH subchannels is to provide a temporary dedicated channel which the wireless device and the beacon can use to interact when performing registration or call setup. SDCCH subchannels are used long enough to complete control signaling with the wireless device. When a wireless device is done using an SDCCH subchannel, the beacon recycles the subchannel into a pool for use by the next wireless device.

Each block on the BCCH, CCCH, or SDCCH channels encapsulates a single message. Each message uses a CRC and hence corrupting a message in any 1 of the 4 frames is sufficient to cause a CRC failure for that message. It is thus not necessary to attack all of the frames in a block but simply to corrupt one, which may be randomly selected.

The foregoing describes the forward channel signaling structure. The standard dictates that any forward channel has a paired reverse channel. Slot 0 of the paired reverse channel always carries the Random Access Channel (RACH). Once the wireless device has acquired timing on the forward channel it will generate an access burst on slot 0 of the paired reverse channel to gain the attention of the beacon. Similarly, there is a reverse SDCCH that is paired with the forward SDCCH, which in the context of the example above would be on slot 1 of the reverse channel. The structuring of the reverse SDCCH is slightly different from that of the associated forward SDCCH but this distinction is not important in this context. It is only necessary to note that for every forward SDCCH subchannel, there is a paired reverse SDCCH subchannel. The arrangement thus that allows the wireless device and the beacon to signal back and forth in a full duplex manner.

Wireless Device and Beacon Interaction in GSM

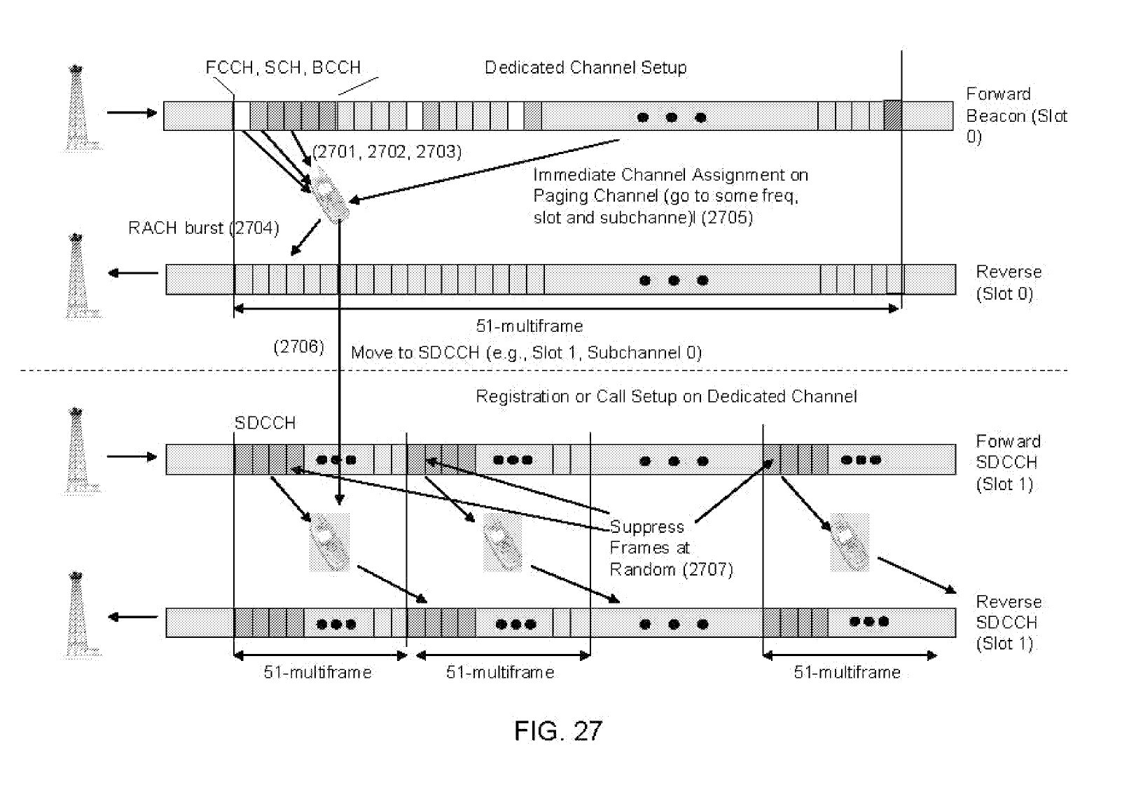

FIG. 27 summarizes the GSM signaling protocol. When a GSM wireless device powers up, it scans a prescribed set of bands looking for beacons. First the wireless device detects the FCCH bursts and corrects its frequency to match that of the beacon (2701). It then detects the sync channel burst and extracts among other things a constantly updating frame number (2702), which unambiguously enables the wireless device to determine on which frame the 51-multiframe starts. It then locates the BCCH block (2703) and begins extracting the system information messages that specifically identify the beacon, what types of wireless devices it will support, what frequency channels other neighboring beacons are operating on, and how to formulate a RACH burst for gaining the attention of the beacon.

Once a beacon is selected, the wireless device formulates a RACH burst requesting a temporary channel (2704). GSM has safeguards to thwart eavesdropping. Therefore the RACH only indicates the kind of contact the wireless device is attempting to make with the network such as attempting registration, placing an outgoing call or responding to a page from the beacon (which is typically indicative of an incoming call to the wireless device). It is important to note that there is also a field in this message indicating whether the wireless device is attempting to make an emergency call. The RACH burst also has a random field called a “random reference” which is returned by the beacon in any subsequent response to the wireless device so that the wireless device knows that the beacon is responding to its request and not that of another wireless device.

As described previously there is a potential for RACH collision between two wireless devices as neither has acquired a unique dedicated channel. In this case, the beacon will not respond to the RACH and each wireless device will back off a random amount of time and retry an RACH burst.

After sending the RACH burst, the wireless device waits for a response from the beacon by listening to the PCH or AGCH channels on the beacon (2705). If the beacon responds it will return the aforementioned random reference in an immediate channel assignment message on a PCH or AGCH. Typically the immediate channel assignment message specifies an SDCCH subchannel (more specifically a frequency channel, a time slot and an SDCCH subchannel) on which the beacon will interact with the wireless device.

The wireless device, upon receiving an immediate channel assignment response from the beacon, moves its transmitter and receiver to the specified SDCCH subchannel (2706) and the wireless device and the beacon begin communicating on this reserved channel for the duration of time it takes to consummate a transaction.

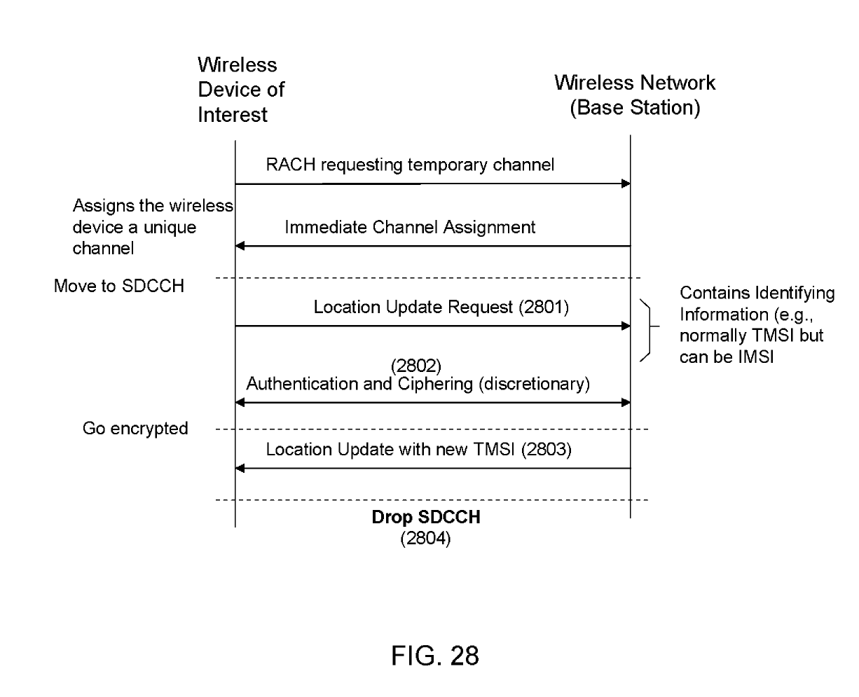

FIG. 28 shows an abbreviated example of the registration (known in the standards as a location update) signaling that tasks place after the beacon and wireless device move to the SDCCH pair. First, the wireless device will identify itself to the beacon by offering a message with its TMSI (2801). The purpose of the TMSI is to identify the wireless device without using a permanent identifier such as an IMSI that would allow an eavesdropper to identify the subscriber to whom the wireless device belongs. Now that the beacon knows the identity of the wireless device, it will optionally authenticate the device. Authentication also updates the encryption key. Once that is done, communications between the wireless device and the network are encrypted (2802). The network then issues a new TMSI to the wireless device (2803), which completes the location update. The beacon and the wireless device then end the connection (2804). At this point, the network knows the location area in which the wireless device is located and can route pages to the wireless device to alert it to incoming calls. For purposes of this discussion, it is presumed that the user has a way of identifying the wireless device by TMSI alone. The filtering system can use interrogation techniques like those shown in Patent Application PCT/US2006/30159 to obtain a wireless device's TMSI.

Once the wireless device is location updated, it will enter an idle mode and monitor the paging channels (PCHs) of the most viable beacon in the wireless device's location area. Other than timed registration dictated by the beacon parameters, the wireless device will not re-register until it roams outside of this location area.

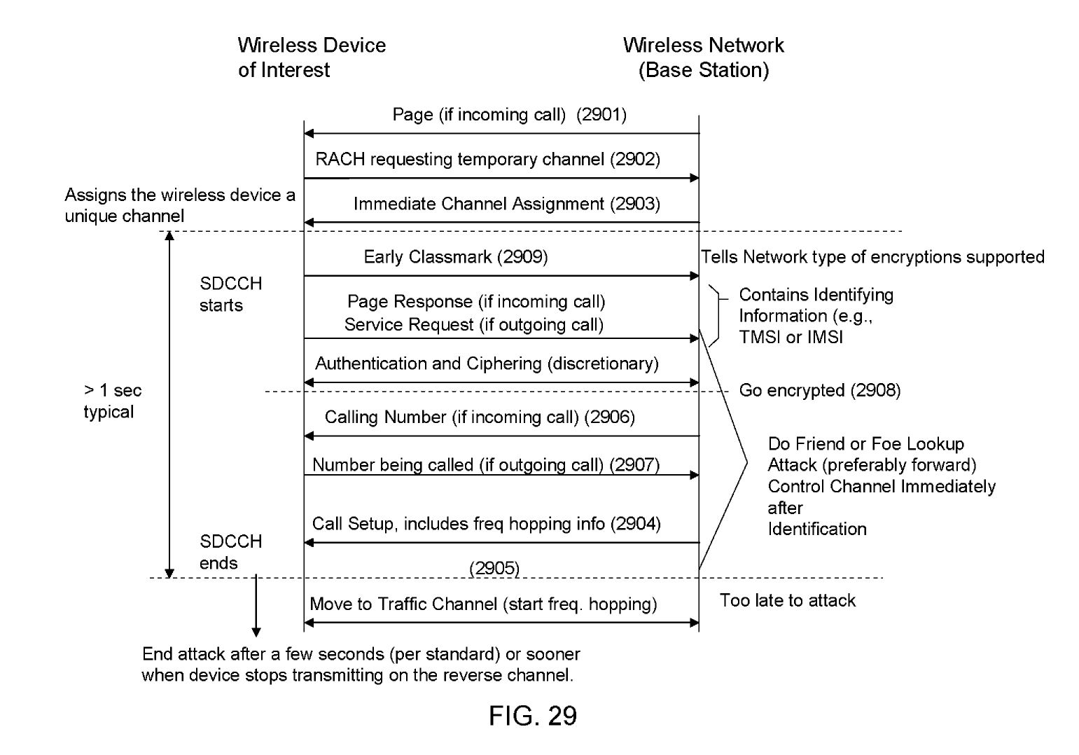

At some point, the wireless device will either place or receive a call. The processes are very similar as shown in FIG. 29. The most notable difference is that an incoming call is precipitated by a page (2901). However once a page is received or an outgoing call attempted, the signaling process is largely the same even though some of the specific messages will differ. As described for registration, the wireless device will generate a RACH (2902) and receive in response an SDCCH assignment (2903). The wireless device and the beacon will move to the SDCCH subchannel and exchange a set of messages that will perform a call setup (2904) in which the beacon assigns a traffic channel (TCH) pair (forward and reverse) to the wireless device and then both leave the SDCCH subchannel and move to the TCH pair (2905) to start the conversation (thus freeing the SDCCH for signaling with new wireless devices). In the case of an incoming call the above messaging will include the phone number of the incoming caller (2906) and in the case of an outgoing call, the messaging will indicate the phone number being called (2907).

As part of the SDCCH subchannel signaling, the wireless device and the beacon will go encrypted immediately after the wireless device identifies itself to the beacon. (2908). The fact that further communications between the wireless device and the beacon are encrypted has several consequences. First, GSM employs frequency hopping. The encrypted TCH channel assignment message includes not only a time slot number but a hopping channel list along with a hopping sequence number and a mobile allocation index offset number. Combined, this information tells the wireless device how to frequency hop in what is typically a pseudo-random fashion. In order to surgically attack a wireless device after a GSM call set up, the filtering system needs to have the encrypted hopping information. Second, in order to filter calls based on incoming and outgoing phone numbers, the filtering system needs to be able to get the phone numbers, and these are encrypted as well. Solutions to this problem include using known interrogation methods such as the “BBK” attack to discover the encryption key or to make the key unnecessary by forcing the wireless device to operate in an unencrypted mode as described herein. Other techniques are proposed herein for semi-surgically attacking a specific wireless device without the benefit of the hopping sequence; however, these techniques pose some risk of interfering with other wireless devices.

LAPDm (Link Access Protocol in the D channel, modified)—Not shown in FIGS. 28 and 29 for reasons of brevity is that the exchange of messages between the wireless device and the beacon uses the LAPDm protocol. This is a numbered supervisory protocol that determines whether a message was properly received. LAPD is specified in the following governing standards documents ITU-T Q.920 and ITU-T Q.921 incorporated herein by reference. The LAPDm protocol used in GSM is LAPD slightly modified to enhance its performance over radio links where packet dropping is a frequent occurrence. GSM uses LAPDm to ensure that the proper set of messages is has been received in the right order and more importantly, that none are missing. If a recipient is missing a message, it will not acknowledge its receipt to the sender and the sender will continue to send the message until it is acknowledged. The LAPDm inserts its own messages such a supervisory numbering that tell the receiver that for example a message is a repeat. LAPDm enables a certain degree of fluidity between either side of the link because in general not each and every message will be received (including repeats) and therefore expressly acknowledged. The filtering system exploits this feature as described under the following heading GSM Attack Methods.

GSM Attack Methods

An important distinction between GSM and CDMA is that GSM has no pilot signal that is shared by all wireless devices. Because that is so, it is possible in GSM to use an interfering signal on either the forward or reverse channel to change the values of specific symbols in a communication. One example of this in the following is the LAPDm override attack; another is the classmark attack.

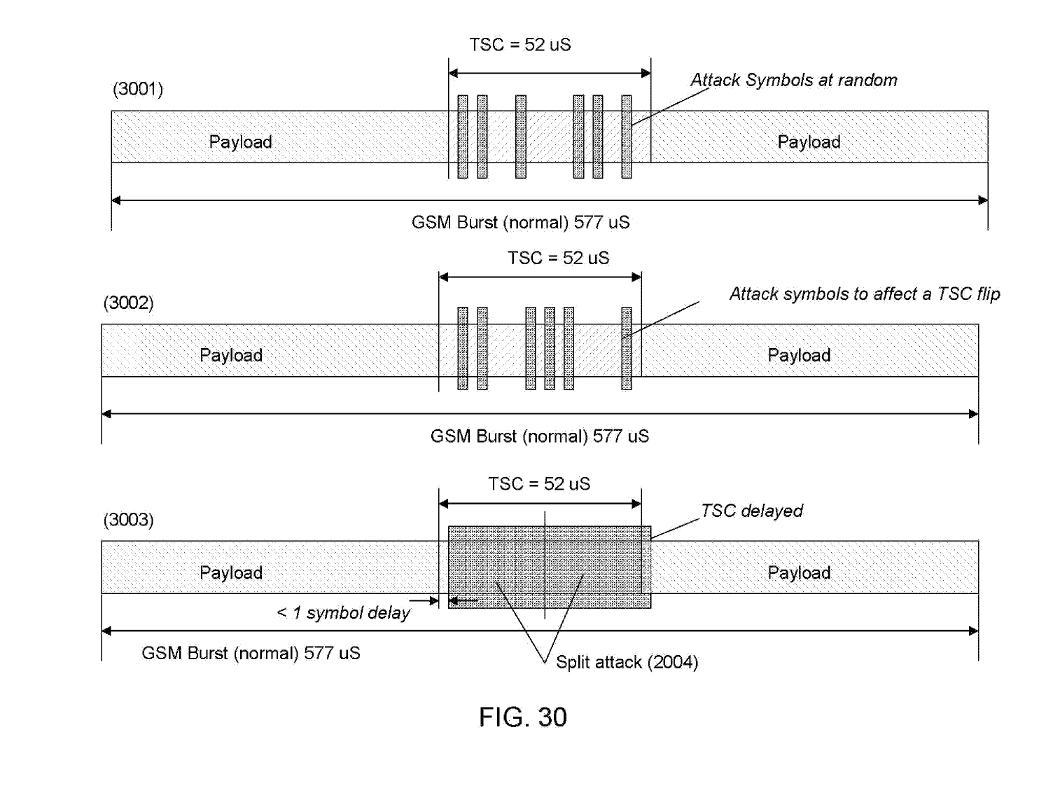

TSC Attack—The TSC is the single weakest point of the GSM waveform. If a sufficient number of symbols in the TSC are corrupted it will be difficult for the receiver to properly synchronize to and therefore recover the burst. FIG. 30 shows examples of TSC attacks. The TSC attack is limited to small sections of the waveform and therefore enjoys enormous power savings over conventional non-specific attacks.

The GSM standard provides for up to 8 different “normal” burst TSCs each of which are orthogonal to one another. Having multiple TSCs provides what is known in the art as a “color code” which prevents the beacon from synchronizing to the wrong wireless device such as might happen in a pathological propagation environment (e.g., a wireless device on a mountain top propagating far beyond its expected range) or when the network is poorly planned (e.g., two base stations in close proximity operating on the same frequency channel).

Random TSC Attack—In a general attack, the symbols should be corrupted at random (i.e., interference would randomly target only a subset of the symbols so as to minimize that ability of countermeasures to locate the source of interference) (3001).

TSC flipping—It may only be necessary to corrupt enough symbols at the proper points in the TSC to exceed the Hamming distance between one TSC and another (“flipping”) and have the receiver dismiss this corrupted TSC as one that is from an unexpected device (3002). This is the preferred method of attack, as it limits the average transmission on-time and thereby the required power.

TSC Delay Attack—Corrupting any given TSC in any given burst may prove to be insufficient when attacking a sophisticated receiver such as is might be found in a commercial beacon. A sophisticated receiver may use short termed averaging of the timing such that it may “fly-wheel” and use an estimated average timing to recover and/or equalize the burst if the TSC cannot be expressly recovered in a particular burst.

While it is hoped that flipping the TSC would cause the receiver to ignore the burst as noted above it cannot necessarily be relied upon, as the receiver may decide that it has no other choice than attempt to recover the burst as best it can in the hope that the coding redundancies spanning multiple frames will allow subsequent processing to deal with the error. One possible modification of the attack is to override the TSC with the same TSC that has been either advanced or retarded in time (3003) (typically by no more than 1 symbol) so that the receiver will completely garble the payload recovery. This approach is possible because the filtering system can synchronize so closely to the targeted waveform that the sophisticated receiver will accept the timing of the override (and if the power is properly controlled, attempt to equalize against it and thereby garble the payload) instead of ignoring it completely and perhaps using fly-wheeling instead. The attack can be economized by only offering the delayed copy for half of the TSC duration.

This permits the filtering system to attack hopping signals on two of the channels simultaneously (3204).

Other Alternatives—Other alternatives include sustaining the attack across multiple frames (i.e., exceed the short term averaging) and if necessary attack random parts of the data payload in lieu of or possibly in addition to the TSC using the CRC attack described for CDMA. While this is not the preferred method, it still significantly limits the power to a relatively small duty cycle and thereby significantly reduces the required power over a non-specific attack.

Other less desirable waveform attacks are corrupting the frequency correction bursts within the 51-multiframe so as to force the wireless device to mistune or attacking all or part of the sync channel bursts to prevent the wireless device from gaining initial network synchronization. These attacks are less desirable due to the necessity of sustaining transmission at least 4 points in the 51-multiframe. The necessity of doing so increases the average power required by the attack as well as somewhat limiting the degree to which the attack can be randomized.

Randomization and Focused Message Attacks—In GSM, information in the form of messages must necessarily transcend multiple frames. Returning to FIG. 26 showing the 51-multiframe (2601), the structure of the bursts is such that the information channels are collected into sets of 4 frames denoted as “blocks”. In order for a message to be recovered it is necessary that all frames within a block be recovered without any post-decoded error. This suggests that it is not necessary to attack all of the frames but instead only attack (using any of the above described techniques) one of the 4 in any given 51-multiframe at random. This notion is further refined by noting that on certain channels such as the broadcast control channel, a certain collection of messages that are broadcast with predictable periodicity must be received by the wireless device in order to gain access to the system. Therefore in some filtering scenarios such as blanket denial of service, the filtering system need only corrupt the TSC in a particular frame within some block carrying some critical message that may only repeat on the order of every second.

Given that the duration of a TSC is on the order of 50 uS and presuming that only half the symbols need to be corrupted to ruin the frame, the foregoing suggests that the transmitter needs to be on for as little as 25 uS every second. This reduces the required power by a factor of 40,000 when compared to a non-tailored attack where the transmitter is always on.

LAPDm Override—This attack capitalizes on the fact that supervisory frames used in the LAPDm protocol used in SDCCH must be sequentially numbered. The filtering system uses a signal override technique to generate a supervisory message at a higher signal strength having a frame number that is completely out of phase. The supervisory message can be generated on either the forward of reverse link. The receiving side of the link will respond when it receives an out of phase supervisory message by immediately dropping the call. This method is extremely economical from a power consumption perspective because it is only on for a single message. Furthermore the method forces the call to be dropped immediately instead of attacking the signaling at random and waiting for the poor quality indicators detected on either side of the link to cause the beacon or the wireless device to terminate the call. This makes the technique instantaneous and therefore maximally inconspicuous, as it minimizes exposure time.

Classmark Attack As part of the call setup process (2909) a wireless device sends an early classmark message that is necessarily in the clear. The classmark message essentially specifies the capabilities of the wireless device including the types and levels of encryption the wireless device will support. GSM provides for three modes of the encryption based on the A5 algorithm denoted as A5/0 (no encryption), A5/1 (strong encryption) and A5/2 (weak encryption).

This message is precisely timed to occur on the SDCCH immediately after the channel assignment. In this attack, the filtering system crafts an override message in its entirety but changes the encryption fields to indicate that it only supports A5/0 (no) encryption and transmits this using a higher power signal at precisely the same time as would the wireless device. The network will typically respond by providing the user with an unencrypted channel.

The classmark attack can be used prophylactically on all detected call setups in the operational area on encrypted networks. This makes it possible for the filtering system to subsequently detect the phone numbers associated with either incoming or outgoing calls and/or detect the frequency hopping sequence information so that a call can be filtered for access based on the phone number or surgically suppressed post-setup.

Wideband Attacks—The foregoing techniques describe a prophylactic approach to the problem of access filtering before a wireless device gains access to the system. However in many cases, it may not be possible to either decrypt or otherwise defeat encryption. For example, wireless devices may be actively transmitting in the operational area before the filtering system is operating or in some cases it may be the policy of the network to not support unencrypted channels. The filtering system deals with these wireless devices by forcing them into either a search or idle mode where they can subsequently be filtered for access. As described previously, the GSM standard employs a combination of encryption and frequency hopping once a call is in progress. Without knowledge of the frequency hopping list and the encryption key, it is impossible to obtain any information from the call. Further, the identifying information for the call can only be obtained at call set up time, not when the call is in progress. For these reasons, the surgically targeted waveform attack strategies described above are ineffective.

In the absence of this information, the filtering system attacks the signal in a broad fashion with the understanding that there is likely to be unavoidable collateral interference and that the goal of any method is to limit this collateral interference to the degree possible while at the same time limiting the amount of power required to mount the attack.

The most effective strategy is to apply a wideband jamming signal across the entire span of the potential frequency hopping range long enough for the network to drop the call in progress (typically several seconds). While the attack does not know the hopping sequence

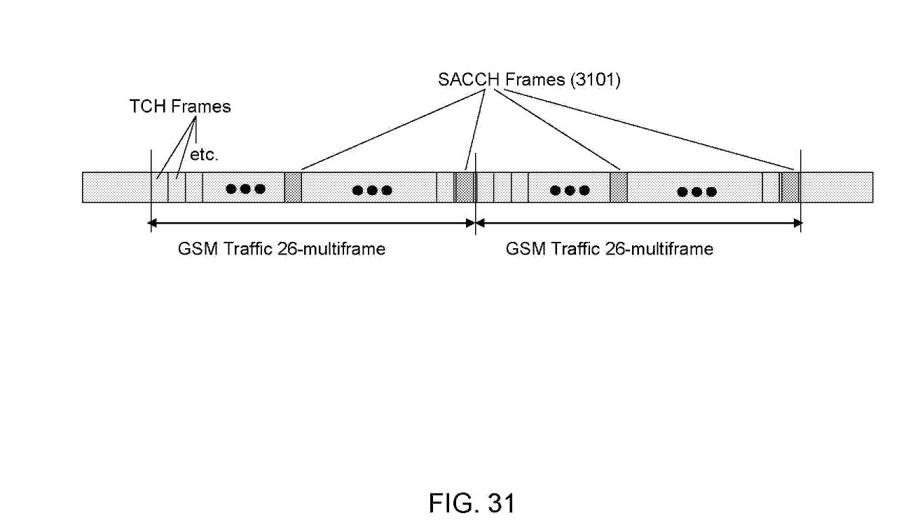

The method is best understood through a description of signaling on GSM traffic channel (TCH). The GSM traffic channel in either direction uses what is known in the standard as the 26-multiframe shown in FIG. 31. The TCH operates on the same slot of each frame (meaning that as many as 8 separate wireless devices can be operating within this framing scheme). The middle and last frame of the 26-multiframe are reserved for carrying SACCHs (3101). The information carried on the SACCH depends on the direction. On the forward link, the SACCH contains a list of neighboring beacons that the wireless device should monitor and report on for purposes of effecting smooth handovers. On the reverse link the SACCH is primarily used to report on the signal strength of the neighboring beacons listed in the SACCH on the forward link. The SACCH is also used by either side of the link to determine when a call should be dropped. If a SACCH frame is not detected within some prescribed period of time, it is presumed that the link has been lost and one side or the other will unilaterally terminate the call. The standard also provides for half rate signaling wherein the 26-multiframe is shared by two wireless devices within some slot. However this is a detail not germane to the present context.

Operating within the TCH is the fast associated control channel FACCH. The purpose of the FACCH is to exchange messages that need immediate real-time attention (e.g., perform handover or call waiting). The FACCH, in either direction works by stealing TCH frames and injecting its own messages. This known in the art as “blank-and-burst”. The messages are of sufficiently short duration that they are not noticed in the conversation by either subscriber.

The foregoing is complicated by the fact that on each frame the TCH (including SACCH and any FACCH) hops to a different frequency. The frequency hopping is predicated on a list of channels known as the Mobile Allocation (MA) and two parameters known as Mobile Allocation Index Offset (MAIO) and the Hopping Sequence Number (HSN). This information is established during the call setup. In some cases the MAIO is broadcast on one of the system messages (System Information 1) in the beacon and hence the call setup directs the wireless device to refer to this list. In other cases the MA is given directly to wireless device (i.e., obviating System Information 1). The MAIO is essentially where in this list (i.e., on which frequency channel) the hopping should start and therefore ranges from 0 to MA size −1. The HSN is a number between 0 and 63 that dictates which of 64 possible pseudo-random hopping sequences should be employed where any sequence is nominally designed such that the hopping is more or less uniformly distributed across all of the channels in the MA.

The standard is such that the maximum hopping span cannot exceed 25 MHz and is typically much smaller (e.g., 7 to 10 MHz), in part because the spectrum is often subdivided among multiple service providers. The primary purpose of frequency hopping is to combat fading, rather than to make interception of a call difficult. Therefore, a service provider will often limit the HSN and MAIO ranges to a few possibilities. This makes it possible to predict within some finite range what the hopping sequence is likely to be. This information can be discovered by using the filtering system to place several live calls to the network to discover MA and the ranges of the. HSN and MAIO for used by a given beacon. A simple method for placing the call is to hijack a existing phone and place an unencrypted call. Techniques for performing this are described in Patent Application PCT/US2006/30159. Another method is to use a legitimate SIM to place a call. In either case, this method directly addresses the problem of the MA being assigned in the call set up post encryption as the MA can be discovered via the call to the beacon.

Once the filtering system had determined the slot on which the wireless device is operating, it attacks only the TSC with one or more wideband interfering signals that are limited to the portion of the frame occupied by the TSC. The total number of interferers required to produce the interfering signals will be governed by the bandwidth of the individual interferers versus the total bandwidth of the hopping sequence. The number of interferers can be reduced to the degree that something is known about the hopping sequence—ranging from a single interferer with a 200 kHz bandwidth hopping in synchrony with wireless device to as many as are required to blanket the entire 25 MHz maximum hopping span.

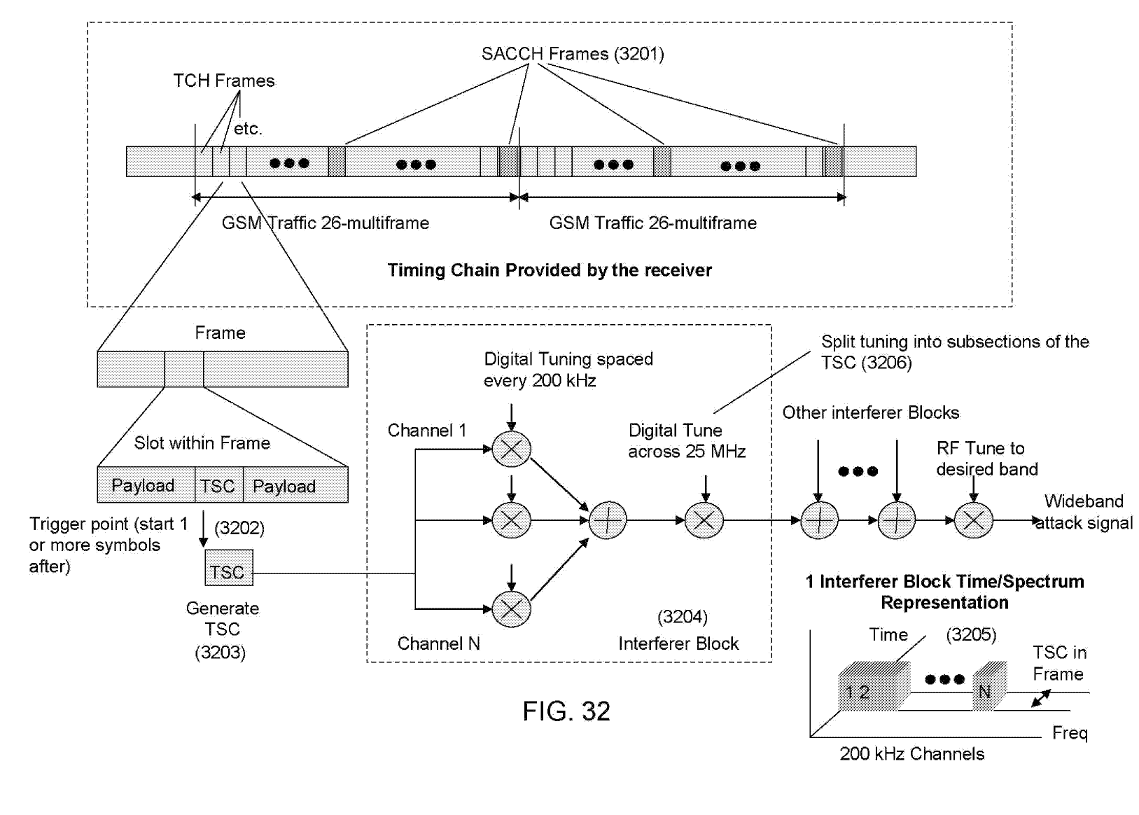

The preferred waveform of any given interferer is shown in FIG. 32. It consists of a TSC waveform that is matched to that of the target (3201). It is delayed in time relative to the target by 1 or more GMSK symbols as seen in the air (3202). This same waveform is digitally heterodyned (3203) simultaneously across N contiguous 200 kHz GSM channels where N is the maximum bandwidth of the interfering signal divided by 200 K. For example for a signal with 1.2 MHz of available bandwidth, N=6 channels. This produces the equivalent of N identical TSCs operating in N contiguous frequency channels (3204). A spectral representation is shown in (3205). This set of spectrally contiguous channels is hereafter referred to as an interferer block. An interferer block can then itself be heterodyned across the maximum 25 MHz spectrum at will, as is demonstrable in existing embodiments implemented using a device such as the ComHouse Wireless NST. The Wireless NST is capable of perhaps doubling the coverage of interference blocks by attacking the first half of a TSC on one set of hopping channels and then retuning to attack the second half of the TSC in another set of hopping channels (3206). In fact, the interference with the TSC can be subdivided in this fashion until the interference loses its effect.

The general case is where nothing is known about the signal except perhaps its time slot. In this case interferers are added until the all of the channels in the maximum range are covered. This case can be relaxed somewhat based on the nature of the attack as described further below. In the case where even the time slot is not known, it affects the power consumption, as the interferer must be on 8 times longer (i.e., on a 8 slots instead of 1). The likelihood of collateral interference increases commensurately. However, the attack will still work in this form. Not all TSCs within all frames need be attacked. The choice of attacking frames is governed by the desired result, examples of which are enumerated below:

Ending a Call (non-time-critical)—If it is desired to merely end a call and that need is not time critical, then a focused attack on SACCH frames is the preferred method, as this will require the minimum power and while be maximally inconspicuous. As described previously, either side of the link must receive viable SACCH messages in order to keep the link open. If either side goes for some defined period (possibly 10 seconds or more) without receiving a legitimate SACCH message, that side will end the call. For a number of previously cited reasons, the forward channel SACCH attack is preferred, as this will limit collateral interference to the operational area. Also as described previously the SACCH messages include at least 4 frames and therefore it is only necessary to attack one of 4 at random (i.e., one SACCH frame every 4 26-multiframes).

Ending a Call (time critical)—If ending a call is time critical, then it is necessary to attack as many frames as possible. In general all frames across the entire known hopping set should be attacked. However, voice and all other messages that may be interspersed on the FACCH use CRC coding. Therefore it is not necessary in general to attack all frames (i.e., cover the entire spectrum simultaneously) but merely enough of them to cause enough CRC failures to force either side to drop the call. In this case it may be possible to dither a smaller number of interferer blocks across the known span of the frequency hopping set. This conserves both power and resource cost.

Crippling a Call—Crippling is a logical extension of the performing a time critical call end. In this case, the frame attack rate is set so that the call remains viable but the information that it carries has become mostly unintelligible. Indeed this attack avoids the SACCH so as to give the link the appearance of viability. The likely response to a poor channel is an attempt by the network to try another channel. However, this response will not succeed because the network will only allocate another channel set and/or slot, and the filtering system simply detects the allocation and moves to cover the new slot.

Handover—The first reaction of a beacon to the poor signal quality resulting from the attack is to move the wireless device to another channel before dropping the call because of the poor signal quality. Therefore any strategy for performing suppression (surgical or otherwise) must deal with any attempt by the beacon to move the wireless device. The filtering system addresses this by ensuring that enough frames are corrupted to keep the handover messages carried in the interspersed FACCH signaling from getting through.

Suppression and Baiting

At a high level, the methods described for CDMA are applicable to the GSM. With respect to baiting, all of the relevant beacons are suppressed and a lower level baiting beacon is proffered. The technique has all of the same benefits as it has CDMA (i.e., minimization of power through surgical attack and minimization of collateral interference). The most important differences between the methods used with GSM and those used with CDMA are the parameters that must be set in the baiting beacon and the specific techniques used in beacon suppression.

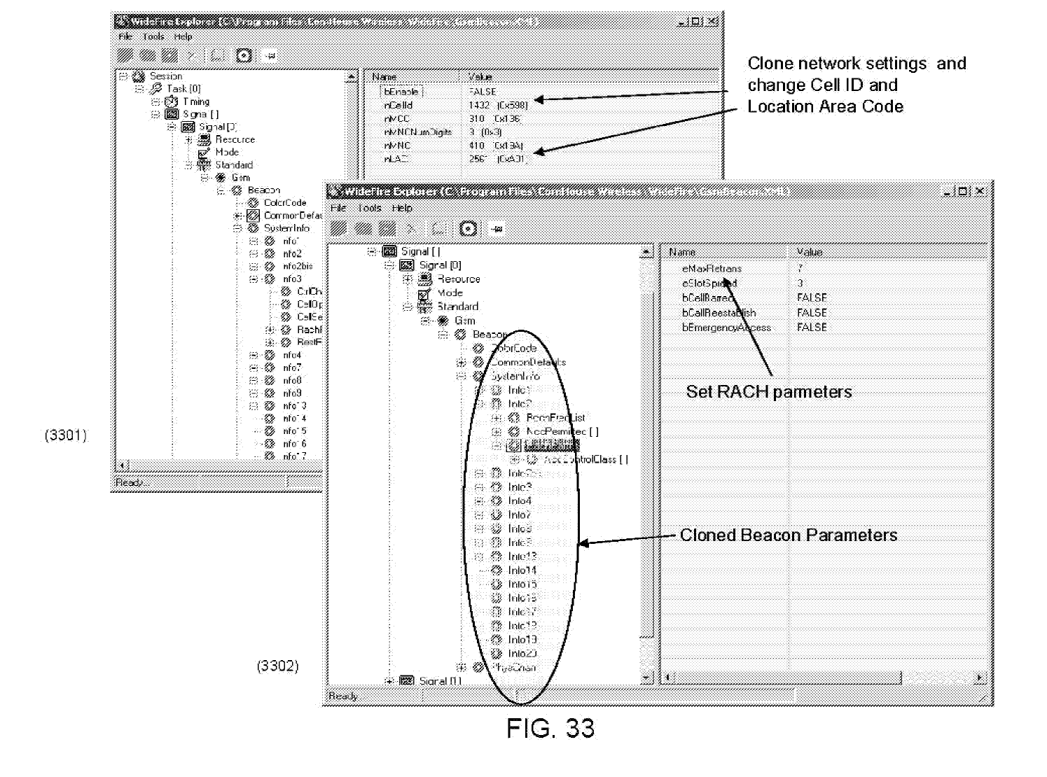

As with CDMA, the filtering system will generate baiting beacons for an operational area by automatically cloning the relevant beacons in the operational area, but will also permit the user to edit the parameters which the baiting beacons provide to the wireless devices. The user may also specify the form of the interfering signal. For example, the user may specify the number of times the interfering signal will be transmitting per frame as well as the periodicity of the transmission. An example is shown in FIG. 33 using WideFire Technology. Like the example presented in FIG. 19 for CDMA, this example shows parameter settings for a GSM baiting beacon (3301 and 3302) which maximize the conspicuousness of any subsequent registration attempt by a wireless device.

Interrogation, Herding and Location

Identifying Wireless Devices in the Operational Area

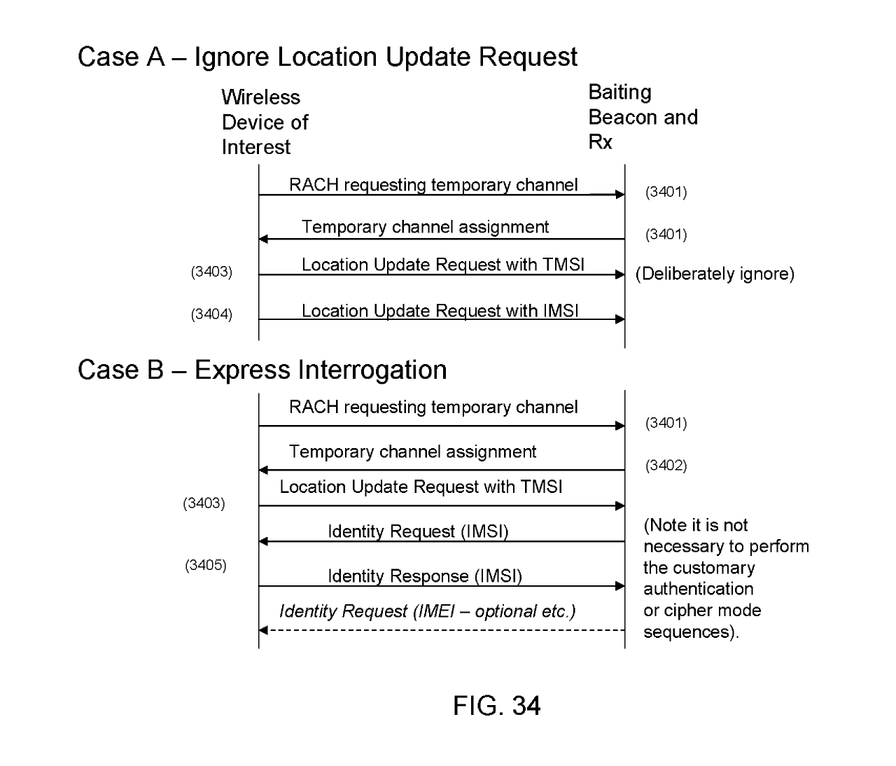

FIG. 34 shows the interrogation process for GSM wireless devices. In the filtering system, a receiver is paired with the baiting beacon. The receiver looks for channel request bursts. The GSM standard terms the request bursts random access channel bursts (RACH) (3401). The wireless device transmits the RACH burst to request a temporary dedicated control channel from the beacon. Parameters passed on the control channel will determine the subsequent interaction between the wireless device and the beacon. The form of the RACH to which a particular beacon responds is controlled by parameter settings in the beacon. The RACH further contains a transaction type field that indicates the kind of transaction which the wireless device wishes to perform with the beacon. The transaction types include location update; answer to a page; call origination; and emergency call.

In order for the filtering system to identify a wireless device in the operational area, the receiver paired with the baiting beacon must detect the RACH burst. Then the baiting beacon must respond to the RACH by assigning the wireless device a temporary dedicated control channel (3402). The wireless device will then use the control channel to provide identification information to the receiver.

If the wireless device is performing a registration, otherwise known in the standard as a location update, it will generate a RACH burst in which the transaction type field indicates that the wireless device wishes to register with the beacon. After the subsequent allocation of a temporary channel by the baiting beacon, the wireless device will then burst a location update request (3403) in which is embedded either the wireless device's TMSI or its IMSI. Nominally the wireless device will attempt a location update using its TMSI. However the standard provides for the case where the TMSI currently assigned to a wireless device is not in the system data base of the service provider with which it is attempting to gain access. In this case, the TMSI is unrecognized by the system and hence the location update is ignored. The wireless device will subsequently retry access using its IMSI (3404). In the filtering system, the baiting beacon ignores all TMSI based attempts at location update, forcing the wireless to retry using its IMSI. This in turn makes it possible to pair the device's TMSI with its IMSI. The standard also provides for expressly interrogating the wireless device using an identity request message. In the identity request message, the wireless device is queried for its IMSI, TMSI, IMEI or IMEISV (3405).

Forcing the wireless device to produce its IMSI in addition to its TMSI also makes it possible to uniquely identify the device to friend or foe data base (507). The TMSI is ephemeral and is consequently not used to identify the wireless device in data base (507).

Acquiring the MIN of the GSM Phone

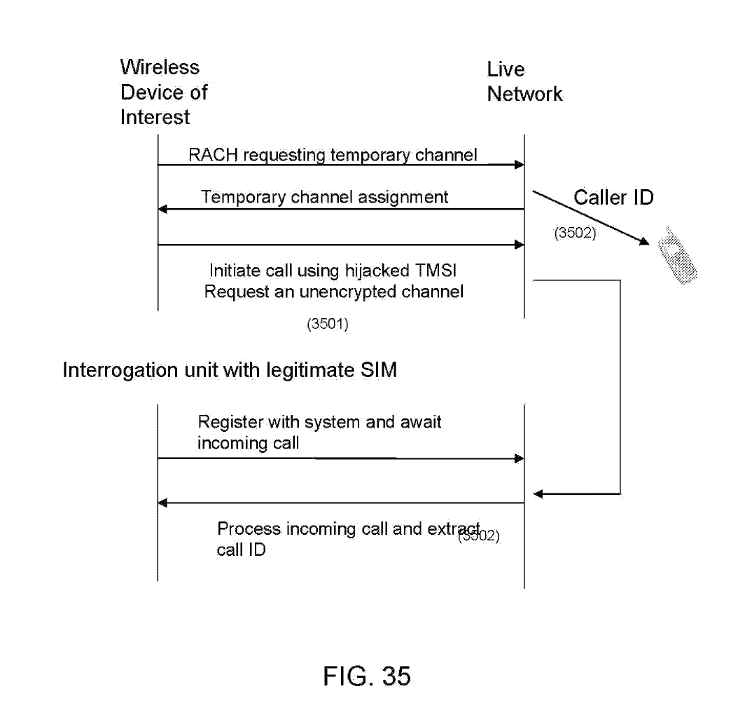

In some cases it is desirable to acquire the MIN (telephone number) of the wireless device. This information is, however, stored in the wireless network, not in the wireless device itself. A baiting beacon can retrieve the MIN for a wireless device whose TMSI or IMSI is known by “hijacking” the wireless device. This is shown in FIG. 35. The baiting beacon uses the wireless device's TMSI or IMSI to place an outgoing call to a telephone number prescribed by the filtering system (3501). When the call is placed to the telephone number, the filtering system uses the wireless network's caller ID function to determine the MIN of the wireless device (3502). The hijacking works because of two characteristics of a GSM network:
the GSM network typically only authenticates a wireless device during location update.
the GSM network permits a device in the network to request an unencrypted channel.

Thus, once the wireless device has registered with the baiting beacon, the baiting beacon can use an unencrypted channel (3501) to make the call to the telephone number belonging to the filtering system. The telephone number may be that of another phone that is available to the filtering system or the filtering system may be outfitted with a GSM subscriber identity module (SIM) that is behaving like a legitimate phone and is registered with the network to receive incoming calls. The SIM allows the filtering system to behave as a legitimate wireless device in the GSM network. As such, the filtering system can accept the call that it made for the wireless device. Having accepted the call, the filtering system can extract the caller ID information for the wireless device from the call.

Herding

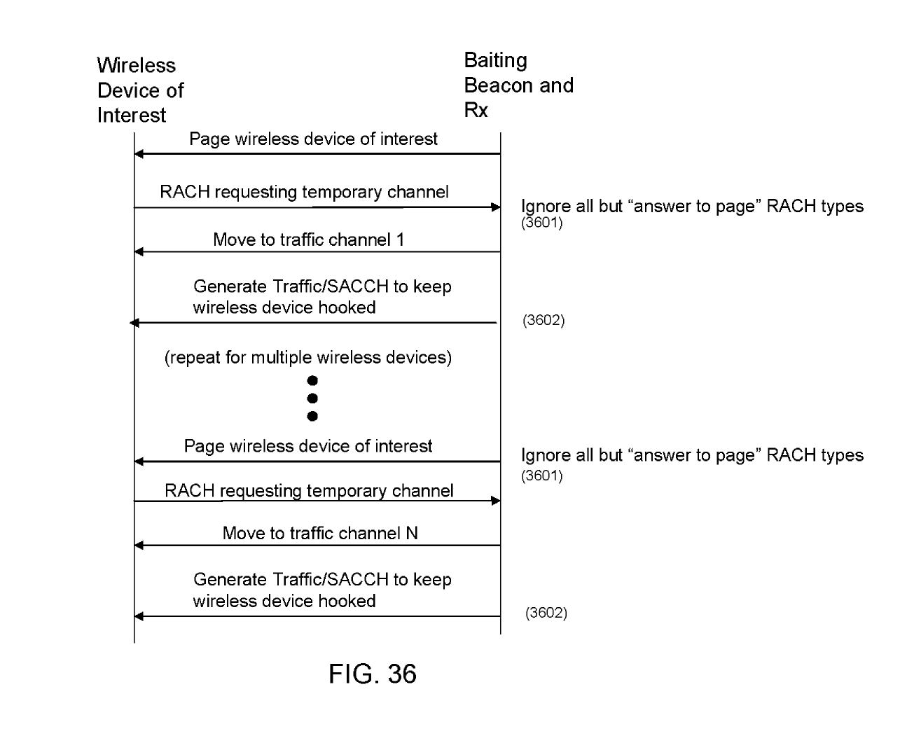

The filtering system may also herd a wireless device to an unused channel. In GSM, the use of temporary dedicated control channels makes it possible to force wireless devices to operate on any specified channel and time slot therein. FIG. 36 demonstrates the process. The baiting beacon pages the wireless device that is to be herded, using either the TMSI or IMSI. When the wireless device responds with a RACH whose transaction type indicates an answer to a page, the filtering system responds to the RACH by providing a channel assignment response that specifies the herding channel (3601). The herded wireless device will remain on the herding channel as long as it receives SACCH frames indicating that the herded wireless device is still connected to the network (3602). The filtering system can herd as many wireless devices simultaneously as it has baiting beacons and separate frequency channels. For example a filtering system with 8 baiting beacons capable of operating on 8 separate frequency channels can herd up to 63 phones simultaneously if each beacon uses all 8 slots within all 8 channels (64 less 1 to account for beacon generation).

Disablement

There are a number of methods available to disable a GSM phone. Techniques that can be derived from a direct reading of the standards include:
Hijacking a wireless device and issuing an IMSI detach that tells the network that the wireless device is powering down. This will cause the network to stop routing incoming calls to the network. The technique only suppresses incoming calls but will not prevent a wireless device from placing a call.
Issuing an authentication rejection to force the wireless device to invalidate the wireless device's SIM until the wireless device is power cycled.
Hijacking a wireless device and deliberately cloning it on the network.

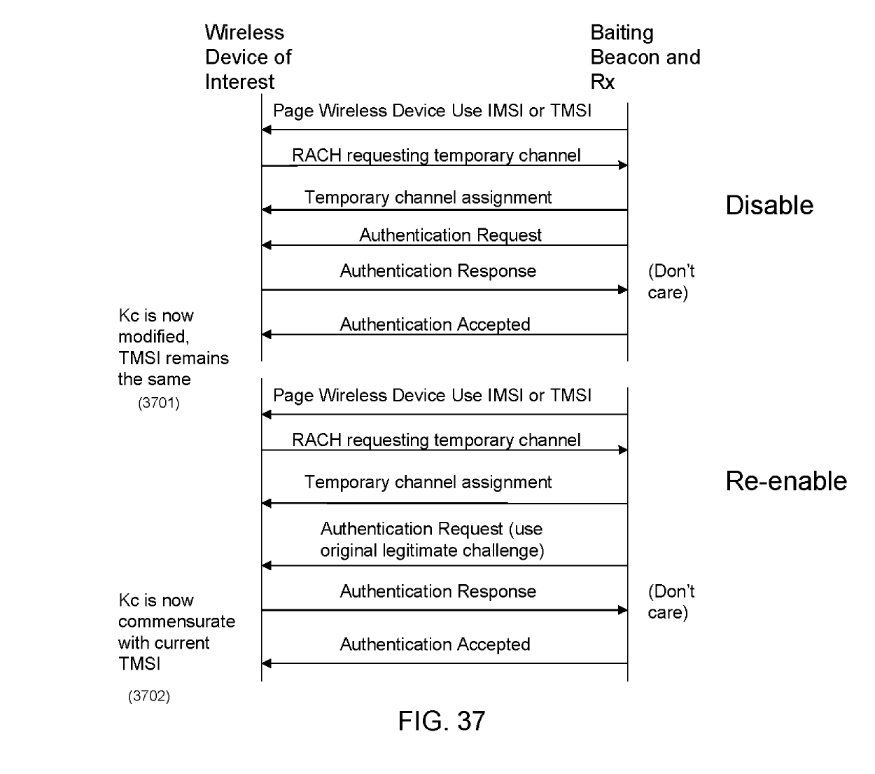

FIG. 37 demonstrates a different methodology. Generally, when a GSM beacon responds to a location update from a wireless device, it provides the wireless device with a new TMSI and a new cipher key. The baiting beacon, however, foregoes the TMSI reallocation that is normally part of the location update process. As a result, the TMSI for the wireless device and the wireless device's cipher key are now effectively out of phase (3701).

When a wireless device's cipher key is out of phase with its TMSI and the wireless device attempts to initiate a call, the network will generally not re-authenticate the wireless device. Instead, the network will presume that because the wireless device's TMSI has not changed, the wireless device is still using the cipher key that it received with the TMSI. Because the cipher key the wireless device is using does not match its TMSI, the wireless device will not be able to complete the cipher mode sequence in the call setup (FIG. 29 (2908)). The network responds to the failure to get past the cipher mode sequence by dropping the call. The same thing happens when an attempt is made to call the wireless device. The wireless device is consequently effectively cut off from the network. The wireless device will remain cut off from the network until such time as the network chooses to re-authenticate the wireless device. After re-authentication, the TMSI and the cipher key will again be in phase. The period of time during which the TMSI and the cipher key are out of phase depends on the interval between re-authentications which is specified in the network configuration. Typical intervals range from 10 minutes to an hour. If sustained denial of service is desired, the filtering system can again put the TMSI and the cipher key out of phase each time the network re-authenticates.

Another aspect of this technique is that the wireless device can be restored to the network at any time by putting the TMSI and the cipher key back in phase. This can be done by re-interrogating the wireless device with the random challenge that was used for the legitimate authentication, as this will restore the original key state and therefore put the cipher key back in phase with the currently established TMSI (3702). Another important feature of this technique is that the user does not know that the wireless device is cut off from the network.

UMTS

The UMTS standard is the next generation successor to the GSM standard. The UMTS standard has introduced safeguards that are expressly designed to thwart baiting beacons that exploit shortcomings in the earlier GSM design. Among the safeguards is that the UMTS beacon must correctly authenticate itself to the wireless device. If the beacon fails to authenticate correctly, the wireless device will mark the beacon as suspect and thereafter refrain from interacting with it. In order to distinguish between situations in which authentication fails because the beacon cannot respond, for example, because the call is dropped and situations in which the beacon does respond but does not do so correctly, the wireless device marks the beacon as suspect only if it has received a response from the beacon that is correct as to form but not as to content. The response is correct if beacon has presented fully formed valid messages having valid CRCs.

The interaction between a wireless device to which the UMTS beacon must authenticate itself and the beacon begins when the UMTS beacon receives either the TMSI or the IMSI of the wireless device. Consequently, the requirement that a UMTS beacon authenticate itself to the wireless device does not prevent discovery of both the TMSI and the IMSI of the wireless device. One way of doing this is the “ignore TMSI” method described above for GSM. Another way of doing this is to suppress all UMTS beacons using the techniques described for CDMA and then provided a GSM baiting beacon. This forces the wireless device to fall back to GSM and the “ignore TMSI” or conventional interrogation methods are again available.

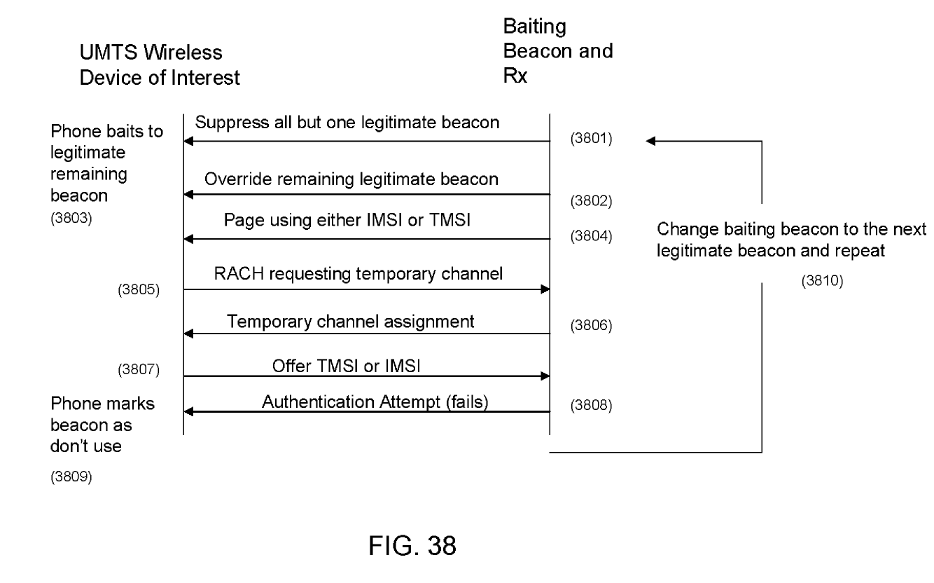

The filtering system further takes advantage of UMTS' requirement that the beacon authenticate itself to the wireless device to disable individual or entire classes of wireless devices. The method is shown in FIG. 38. The interrogator suppresses all but one of the legitimate beacons using any of the previously described techniques for CDMA (3801) and overrides the remaining beacon (3802). This ensures that the wireless device will be listening on that beacon (3803). The wireless device is then paged (3804) using either the TMSI or IMSI that was presumably derived using the interrogation methodology previously described. This is possible because paging messages in UMTS are not subject to integrity checking. The wireless device responds with a RACH for a channel and interrogator obliges (3805, 3806). The wireless device offers either its TMSI or IMSI (3807) and the baiting beacon attempts authentication in a fashion which is guaranteed to fail (3808). In response to the failure of the authentication, the wireless device marks that beacon as no longer viable (3809) and ignores the beacon from that point on. This process is repeated for all of the UMTS beacons that are detected in the operational area (3810). The wireless device is now ignoring all of the UMTS beacons in the operational area and has thereby disabled itself.

GSM Access Filtering Methodologies

The filtering system can use waveform attack techniques just described to provide levels of filtering ranging from broad suppression to highly surgical targeting of individual wireless devices. The methods are described for each of the filtering modes: blanket denial-of-service; positive/negative filtering; or surgical suppression. Within each is a separate description for attacks on the forward and then reverse channels (where applicable) with additional description for interactive attacks such as interrogation and/or disablement.

GSM Blanket Denial of Service

A GSM wireless device will sense multiple beacons in some operational area. Which beacon a GSM wireless will monitor at any given moment is left strictly to the discretion of the GSM wireless device. It is therefore in general, difficult for the filtering system to predict which beacon the wireless device will monitor with any certainty—particularly in geometries where a wireless device is more or less equidistant to multiple towers. Simply attacking the strongest beacon may thus just cause the wireless device to move to monitor the next best choice.

GSM Forward Link Denial-of-Service

Neighbor beacon—The simplest method to deny access is to clone an existing beacon that is a neighbor of the strongest beacon in the operational area but is not detectable in the operational area and then having the cloned beacon generate a signal that is stronger than the signal generated by the strongest beacon in the operational area. All wireless devices in the operational area should then begin monitoring the cloned beacon. However this is not a preferred method because of the required power consumption and because there is no guarantee that all of the wireless devices will necessarily move to monitor the cloned beacon. While this technique permits filtering of incoming calls, when a wireless device attempts to make an outgoing call and receives no response from the cloned beacon, the wireless device may attempt to use another beacon. In fact it is known that some wireless devices are designed to “black list” a beacon that does not respond for some period of time. The filtering system deals with this problem by allowing the cloned beacon to respond to the wireless device and having it pretend to set up a call. In this case the wireless device has no reason to mark the beacon as not viable. Another possibility is to periodically rotate the cloned beacon to prevent it from being black listed.

BCCH Attack—This attack randomly corrupts one of the frames within a message block belonging to any of the compulsory system messages broadcast on the broadcast control channel (BCCH)—refer to FIG. 27 (2707) using previously described TSC attacks (FIG. 30). Specifically, the GSM standard requires that System Information messages type 2, 3 and 4 be present in all beacons (ETSI 44.018). Failure to detect any of these messages will preclude the use of the beacon for access by the wireless device. However, in cases where the wireless device has already registered with the system and is in idle mode, the wireless device will be insensitive to this type of attack. Therefore the filtering system refines this attack by preceding it with a blinding signal lasting several seconds that will force the wireless device to lose synchronization. The filtering system will then resume the surgical BCCH attack with the effect that all wireless devices in the operational area will not be able to resynchronize to the legitimate beacon(s). The filtering system must provide the blinding simultaneously for every beacon that is detectable in the operational area to completely cut off the wireless device. Blinding one beacon will simply cause the wireless device to move to monitoring another beacon from which it will be able to receive incoming pages.

Paging/Access Grant Channels Attack—This method randomly corrupts one of the frames within the message block of all the paging and access channels operating within the 51 multi-frame (FIG. 27 (2707)) using previously described TSC attacks (FIG. 30). This prevents the wireless device from receiving either immediate channel assignments or pages from the network. This method is inferior to the BCCH attack from an average power consumption perspective, as the transmit duty cycle is significantly increased (by a factor of 9) but the method can be used in cases where the BCCH attack is not viable. In general, all beacons in the operational area must be attacked simultaneously for the reasons cited in the BCCH attack. However this attack is useful in cases where there is a single dominant beacon, as the wireless devices will necessarily stay camped on this beacon even though the paging messages from the beacon are being attacked. This is because the remainder of the beacon remains unmolested by the attack and the wireless device therefore has no reason to consider alternative beacons.

SDCCH Attack—This attack is directed to any SDCCH channel when the channel is allocated for access. However this technique has a relatively high power consumption, first because the interfering transmitter will constantly be active on any reasonably loaded system and second because the receiver associated with the interfering transmitter must constantly monitor the reverse channels looking for access attempts. This technique may, however, be viable on beacons that have a relative low density of wireless devices. In the attack, one of four frames in each block of the SDCCH subchannel (FIG. 27 (2707)) on which the wireless device is active is suppressed using previously described TSC attacks (FIG. 30)

Herding—The wireless devices can be herded to a false beacon and thereby in effect disabled using the interrogation techniques described previously. However this is not the preferred method from a power consumption perspective, due to the requirements of generating multiple interferers while sustaining a baiting beacon.

Post Call Set Up Attack—GSM poses a special problem when wireless devices may already be actively operating using frequency hopping in the operational area. This is a particularly acute problem in situations where the operational area is mobile and consequently passes by wireless devices that are active. To address this problem, the filtering system refines the wideband attack described previously under Ending a Call (time critical) by marrying it to receivers that scan the reverse hopping channels specified in either the Cell or Mobile allocation lists extracted from either the System Info messages or those that have been obtained using the previously described techniques for calling the tower and retrieving the list.

GSM Reverse Link Denial-of-Service

Forward channel attacks are generally preferred because the operational area and any attendant collateral interference may be limited. Furthermore reverse channel attacks have a significant disadvantage with respect to power consumption as the attack work on wireless devices that are far closer to the tower than the interfering transmitter. Because this is so, the interfering transmitter must always transmit using the worst case power levels. The high power levels of course make the transmitters highly conspicuous and also result in extensive collateral interference.

Reverse channel attacks may, however, be the only recourse in situations where the geometry is such that wireless device(s) of interest is(are) significantly closer to the base station than to the interfering transmitter. This is, however, likely to be the case for only a very small fraction of the wireless devices of interest.

The preferred method is to use the SDCCH attack as described for the forward channels but instead operating on the reverse link. A random access channel (RACH) attack may also be used to prevent any devices in the operational area from gaining the attention of the beacon and being allocated an SDCCH channel in the first place. However, since the RACH is a wholly random event it is necessary to generate a sustained interfering signal. That in turn precludes using any of the power saving techniques described herein. Furthermore if a wireless device cannot get a response from a particular beacon it is likely that it will search for other beacons that are more responsive. To prevent this from happening, the reverse RACH channels associated with all of the beacons that are detectable in the operational area must be suppressed.

GSM Positive and Negative Access Filtering

The GSM standard has a key vulnerability that can be exploited to both positively and negatively filter access by particular wireless devices. Embedded in any request for service with be the wireless device identifying information (nominally TMSI but often IMSI). It is also important to note that the request for service can never be encrypted because the identifying information upon which encryption is based has not yet been made known to the beacon (i.e., the network). Therefore it is a simple matter for the filtering system's receiver to detect the identifying information embedded in the service request and to determine from the friend-foe database whether the associated wireless device should be allowed access. Methods for discovering the TMSI and IMSI of a wireless device have been described previously under interrogation techniques.

If a device is to be negatively filtered, the filtering system attacks the dedicated control channel (SDCCH) assigned to the wireless device, using the previously described TSC attacks, subsequent to detection of the identifying information and hence prevents the control signaling from consummating either an incoming or outgoing call. Similarly if a device is to be positively filtered, wireless devices not on the approved list are attacked as just described. Since a unique control channel is allocated to a single wireless device (FIG. 27) the effect of surgical access on a subscriber or even a wireless device basis is thereby achieved.

Related to the attack are the issues of how quick the response time must be and how long it must be sustained. In the former case the minimum worst case response time will be on the order of less than a second. That is because at most 4 messages per second can be passed between the beacon and the wireless device and 4 messages is the minimum number required to effect a call setup (presuming that the system forgoes the customary authentication and ciphering exchanges) (FIG. 29). Several seconds is expected to be more typical and therefore this would normally give ample time for a data base lookup. However if faster response times are called for, the filtration system can create a precompiled hash detection list from the data base entries and the receiver can use the hash list for fast detection. As pointed out below, the response time is critical in ensuring that the forward channel is attacked before it can direct a change to encrypted mode.

The filtering system sustains the attack long enough to ensure that one or the other side of the link gives up. The wireless device or beacon may make repeated attempts to gain access or respond, so the attack must be sustained longer than the minimum timeout of either side of the link as established by the standard (ETSI 44.006). Conversely the attack cannot be sustained longer than channel reuse period. If it is, the channel under attack may be reallocated by the beacon to yet another wireless device and continued interference with the channel would result in collateral interference The filtering system uses the minimum timeout periods to determine the duration of the attack. This is supported by the fact that there are at least 4 and typically 8 control channels in the control channel pool and these are typically, if not necessarily, allocated in sequence. Therefore the attack must end before the beacon loops around and attempts to reuse the control channel. The filtering system can thus use the beacon/system configurations to determine the duration of the attack. However, there are several refinements that lessen the duration of the attack and thereby decrease both power consumption and conspicuousness. The first refinement takes advantage of the fast response time described above and overrides the beacon signal with a higher powered signal that transmits the channel release message directing the wireless device to release the channel.

The above described methods can also be refined by making use of the LAPDm protocol employed on the SDCCH signaling. Here the network can be forced to drop the call by replying using a supervisory frame on the reverse channel with frame numbering that is out of phase. This will force the network to drop the control link via a channel release (in essence hijacking the network to act on behalf of the filtering system). This is a particularly effective technique when the geometry is such that the filtering system is located closer to the beacon than is the wireless device.

The filtering system also surgically filters emergency calls by detecting the emergency settings in the initial RACH channel request and allowing the associated control signaling to proceed regardless of the wireless device. Specifically, the filtering system recovers the random reference information in all RACH channel request and matches it to the subsequent the immediate channel assignment that echoes the random reference and thereafter refrains from interfering with the associated SDCCH signaling that follows.

Overall power consumption can be decreased because beacon timing used in the GSM system is highly stable. Therefore it is not necessary in many cases to leave the receiver on constantly. Instead in cases where the receiver does not need to actively intercept signaling it makes use of a timing receiver (e.g., GPS) having significantly lower power consumption to flywheel the timing so that filtering system need only be resynchronized to a beacon infrequently (e.g., perhaps every hour or possibly even once a day).

Call Filtering—GSM encrypts the sensitive information in a call, including the identification of incoming or outgoing calls. The following discussion presumes that the encryption key is available or encryption can be defeated as described previously and therefore contemplates detecting the post-encrypted information that identifies either the incoming or outgoing phone number (e.g., included in the setup or other messages) and ending the control signaling (e.g., attack the SDCCH) before the traffic channel assignment can be completed—refer to “Call Setup” in FIG. 29. Selection of whether the attack is on the forward or reverse link is expected to be a function of the positions of the wireless device and the transmitter relative to each other and the beacon the wireless device is monitoring.

Since the post encrypted information also contains the frequency hopping sequence information, the filtering system attacks the traffic channel as described below under the heading of Surgical Traffic Suppression, post call setup

GSM Surgical Traffic Suppression

Surgical Traffic Suppression—Surgical traffic suppression cripples communications between the wireless device and the beacon or severs the link between the wireless device and the beacon after the wireless device has already gained access to the network. The filtering system does this by using a signal generator that is precisely timed to the network and possibly supplemented by directional antennas to surgically either hamper communication using the TSC attack methodologies previously described and thereby prolong it or to outright sever communications after either a prescribed amount of time or upon an event determined by the operator.

Specifically it presumes that the filtering system has access to the encryption key or the key can otherwise be derived as for example described in Patent Application PCT/US2006/30159 or defeated as described herein. In this case it is simply a matter of hopping synchronously to the wireless device under consideration and performing the aforementioned GSM surgical waveform attacks. More specifically it requires one interferer block with a total number of channels (N) therein equal to 1 as shown in FIG. 32 (3206).

In cases where the knowledge of the frequency hopping set is incomplete the generalized techniques expressed in FIG. 32 are applied to simultaneously limit power consumption and collateral interference by applying interferer blocks to fit the estimated bandwidth of the signal.

Whether a link is crippled or severed is controlled by the frame rate corruption. A modest frame rate corruption (e.g., 10%) would be sufficient to the keep the link open but still render the communication link virtually unintelligible. The preferred method of corruption is to employ the previously described TSC attacks. However, the CRC attack may be used to attack the data in the burst payload instead of the TSC. In this fashion it gives the appearance that link is open, as evidenced by the good TSC quality, even though the payload data bits have been corrupted. This forces forcing the receiver to discard enough vocoded voice packets to render the link unintelligible. The attack employs direct interference (random data bits using GMSK modulation) on non-TSC bits. A further refinement is to attack non-protected bits used in the voice encoding process. This is made possible by the fact that these bits are placed at regular locations in the transmitted data. Therefore attacking non-protected bits further fosters the illusion that the link is viable while still corrupting intelligibility.

### CONCLUSION

The foregoing Detailed Description has set forth to those skilled in the relevant technologies how to make and use the filtering system disclosed herein and has further disclosed the best mode presently known to the inventor of making and using the filtering system The Detailed Description has described the filtering system in general terms and has also set forth how the inventions are implemented in wireless systems that operate according to the CDMA, GSM, and UMTS standards. It will be immediately apparent to those skilled in the relevant technologies that the principles embodied in the construction and use of the filtering system can be employed to make interference signals and baiting beacons in any present or future digital wireless communication system.

The interference signals can be used to suppress the beacons in an operational area or to interfere with communications between a beacon and a wireless device on either the forward or reverse channels. The interference may include inducing errors in individual symbols of a communication or even changing the values of individual symbols. The baiting beacons can be used to obtain identification information from wireless devices, to disable wireless devices, to perform operations in the wireless communication system for the wireless devices, to locate wireless devices, and to herd wireless devices to specified channels in any present or future digital wireless communication system.

The filtering system itself may be implemented using any hardware or software technology which is able to generate interference signals which obey the timing constraints required for the techniques and have the power required to override a beacon or a portion of a communication between a beacon and a wireless device.

Since the techniques disclosed herein may be employed in any present or future wireless communication system and may be implemented using many hardware and software technologies, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. A method of suppressing a given beacon so that a wireless device cannot interact with the given beacon, the given beacon and the wireless device obeying a wireless communication standard and
the method comprising the steps of:
determining a characteristic of the signal produced by the given beacon, the characteristic being required by the standard for interaction between the wireless device and the given beacon; and
generating an interference signal that is specifically adapted to the characteristic and that interferes with the characteristic at the wireless device such that the wireless device cannot interact with the given beacon.

2. The method set forth in claim 1 wherein:
in the step of generating the interference signal, the interference signal is limited to the channel upon which the given beacon is operating.

3. The method set forth in claim 2 wherein:
the interference signal is a noise signal that is limited to the channel and is stronger at the wireless device than the signal in the channel.

4. The method set forth in claim 1 wherein:
in the step of generating the interference signal, the interference signal's power is determined by the power of the given beacon at the wireless device.

5. The method set forth in claim 1 wherein:
the interference signal defines an operational area surrounding the wireless device wherein the interference signal interferes with the characteristic such that the wireless device cannot interact with the given beacon.

6. The method set forth in claim 1 wherein:
the characteristic is a part of the signal that contains information which the wireless device requires to interact with the given beacon; and
in the step of generating the interference signal, the interference signal is generated such that the interference signal interferes with the part of the signal from the given beacon and thereby prevents the wireless device from interacting with the given beacon.

7. The method set forth in claim 6 wherein:
the given beacon generates the part of the signal at discrete times; and
in the step of generating the interference signal, the interference signal is generated at times that are determined by the times at which the part of the signal is generated by the given beacon.

8. The method set forth in claim 6 wherein:
the part of the signal is a pilot signal which the wireless device uses to synchronize itself with the given beacon; and
the interference signal interferes with the pilot signal such that the wireless device cannot use the pilot signal to synchronize itself with the given beacon.

9. The method set forth in claim 8 wherein:
the given beacon generates the information in the pilot signal which the wireless device uses to synchronize itself with the given beacon at first discrete times; and
in the step of generating the interference signal, the interference signal is generated at second discrete times such that the wireless device synchronizes itself with the interference signal instead of the pilot signal.

10. The method set forth in claim 8 wherein:
the signal produced by the given beacon includes symbols representing data carried by the signal and a quality indicator for the data;
the wireless device discards the data as indicated by the quality indicator;
the wireless device synchronizes itself with the pilot signal to read the symbols; and
in the step of generating the interference signal, the interference signal is generated at discrete times such that the wireless device erroneously reads certain of the symbols with the result that the quality indicator indicates that the data should be discarded.

11. The method set forth in claim 6 wherein:
the signal produced by the given beacon includes symbols representing data carried by the signal and a quality indicator for the data;
the wireless device discards the data as indicated by the quality indicator; and
in the step of generating the interference signal, the interference signal is generated at times such that certain of the symbols are corrupted with the result that the quality indicator indicates that the data should be discarded.

12. The method set forth in claim 6 wherein:
the characteristic is a signaling channel that carries signaling information; and
the interference signal disrupts the signaling information.

13. The method set forth in claim 1 further comprising the step of:
providing a baiting beacon with which the wireless device may interact instead of the given beacon.

14. The method set forth in claim 13 wherein the method further includes the step of:
detecting timing differences between the baiting beacon and the given beacon; and
in the step of generating the interference signal, the timing differences are used in generating the interference signal.

15. The method set forth in claim 13 wherein:
the interference signal defines an operational area surrounding the wireless device wherein the interference signal interferes with the characteristic such that the wireless device cannot interact with the given beacon;
the power of the baiting beacon is such that the wireless device will not interact with the baiting beacon outside the operational area.

16. The method set forth in claim 14 wherein:
the standard requires that a beacon authenticate itself to the wireless device and that a wireless device not interact with a beacon that does not authenticate itself; and
the baiting beacon does not authenticate itself to the wireless device, whereby the wireless device is disabled in the operational area.

17. The method set forth in claim 13 wherein:
the baiting beacon is different from the given beacon at least in that the baiting beacon specifies a different registration area from that specified by the given beacon;
the only beacon with which the wireless device can interact in the operational area is the baiting beacon, whereby the wireless device is forced to reregister with the baiting beacon.

18. The method set forth in claim 17 wherein:
the baiting beacon is further different from the given beacon in that the baiting beacon provides the wireless device with parameters which maximize the conspicuousness of the wireless device in the operational area.

19. The method set forth in claim 18 wherein:
the baiting beacon is otherwise a clone of the given beacon.

20. The method set forth in claim 13 wherein:
the baiting beacon operates on a channel which is different from the channel on which the given beacon operates.

21. The method set forth in claim 1 wherein:
there is a plurality of the given beacons;
in the step of generating the interference signal, an interference signal is generated for each of the given beacons, the interference signals defining an operational area surrounding the wireless device in which the wireless device cannot interact with any of the given beacons.

22. The method set forth in claim 21 further comprising the step of:
providing a baiting beacon in the operational area with which the wireless device may interact instead of the given beacon.

23. The method set forth in claim 22 wherein:
in the step of providing the baiting beacon, the power of the baiting beacon is such that the wireless device will not interact with the baiting beacon outside the operational area.

24. The method set forth in claim 22 wherein:
in the step of providing the baiting beacon, a baiting beacon is provided for each of the given beacons.

25. The method set forth in claim 24 wherein:
in the step of providing the baiting beacon, a baiting beacon that is provided for a given beacon differs from the given beacon in that the baiting beacon specifies a different registration area from that specified by the given beacon.

26. The method set forth in claim 25 wherein:
the baiting beacon that is provided for a given beacon further differs from the given beacon in that the baiting beacon provides the wireless device with parameters which maximize the conspicuousness of the wireless device in the operational area.

27. The method set forth in claim 26 wherein:
the baiting beacon is otherwise a clone of the given beacon.

28. The method set forth in claim 25 wherein:
a baiting beacon operates on a channel which is different from any of the channels on which the given beacons operate.

29. The method set forth in claim 13 further comprising the step of:
causing the baiting beacon to interact with the wireless device when the wireless device reregisters with the baiting beacon.

30. The method set forth in claim 29 wherein:
the baiting beacon interacts with the wireless device such that the baiting beacon obtains information from the wireless device, the wireless device responding during the interaction as specified in the standard.

31. The method set forth in claim 30 wherein:
the information is identification information for the wireless device.

32. The method set forth in claim 30 wherein.
the identification information includes temporary identification information that is temporarily assigned to the wireless device and permanent identification information that is permanently assigned to the wireless device; and in the step of causing the baiting beacon to interact,
the baiting beacon fails to respond when the wireless device provides the temporary identification information, the failure to respond causing the wireless device to respond by providing the permanent identification information.

33. The method set forth in claim 30 further comprising the steps of:
using the identification information to query a data base; and
performing a further interaction between the baiting beacon and the wireless device based on the query result.

34. The method set forth in claim 33 wherein:
in the step of performing the further interaction, the further interaction is disabling the wireless device.

35. The method set forth in claim 29 wherein:
the baiting beacon interacts with the wireless device such that the baiting beacon disables the wireless device.

36. The method set forth in claim 35 wherein:
the baiting beacon disables the wireless device by using a disablement command specified in the wireless communication standard.

37. The method set forth in claim 35 wherein the baiting beacon disables the wireless device by performing the further step of:
herding the wireless device to a channel wherein the only beacon the wireless device can interact with is a baiting beacon that neither provides incoming calls to the wireless device nor responds to outgoing calls from the wireless device.

38. The method set forth in claim 35 wherein:
the wireless device has a cipher key and identification information that is in phase with the cipher key and
the baiting beacon disables the wireless device by performing the step of:
changing either the identification information or the cipher key in the wireless device so that the identification information is out of phase with the wireless device's cipher key.

39. The method set forth in claim 38 wherein the baiting beacon disables the wireless device by performing the step of:
using the challenge which the baiting beacon employs in authenticating the wireless device to change the wireless device's cipher key.

40. The method set forth in claim 35 wherein
the baiting beacon disables the wireless device by performing the step of:
changing the identification information in the wireless device.

41. The method set forth in claim 38 wherein
the baiting bacon reenables the wireless device by performing the step of:
restoring the change so that the identification information is again in phase with the cipher key.

42. The method set forth in claim 35 wherein
the wireless communication standard specifies that a wireless device will not interact with a beacon unless the beacon has authenticated itself to the wireless device;
the wireless device is able to interact with one or more given beacons; and
the baiting beacon disables the wireless device by performing the further steps for each of the given beacons of:
overriding the given beacon; and
thereupon failing to authenticate itself to the wireless device, whereby the wireless device no longer interacts with any of the given beacons.

43. The method set forth in claim 13 wherein:
the baiting beacon interacts with the wireless device by performing a network operation in place of the wireless device.

44. The method set forth in claim 43 wherein:
the network has caller identifier functionality;
the network operation is making a call from the wireless device to a destination; and
the network uses the caller identifier functionality to supply the telephone number of the wireless device to the destination.

45. The method set forth in claim 29 further comprising the step of:
providing a further baiting beacon on a different channel; and
the baiting beacon interacts with the wireless device such that the wireless device switches to the further baiting beacon's channel.

46. The method set forth in claim 45 wherein:
the wireless device is the only wireless device operating on the further baiting beacon's channel, whereby the wireless device is more easily located.

47. Apparatus for suppressing a given beacon so that a wireless device cannot interact with the given beacon, the given beacon and the wireless device obeying a wireless communication standard and
the apparatus comprising:
an analyzer that determines a characteristic of the signal produced by the given beacon that is required by the standard for interaction between the wireless device and the given beacon; and
a signal generator that generates a signal that is specifically adapted to the characteristic and that interferes with the characteristic at the wireless device such that the wireless device cannot interact with the given beacon.

48. A method employed in a baiting beacon of performing a given interaction with a wireless device that is monitoring the baiting beacon,
the method comprising the steps of:
during authentication of the wireless device to the baiting beacon, refusing to respond to temporary identification information that temporarily identifies the wireless device, thereby causing the wireless device to provide permanent identification information that permanently identifies the wireless device to the baiting beacon;
querying a database associated with the baiting beacon with the provided permanent identification information; and
performing the given interaction with the wireless device only if the result of the query indicates that given interaction may be performed.

49. The method set forth in claim 48 wherein:
the given interaction disables the wireless device.

50. A method employed in a baiting beacon being monitored by a wireless device of locating the wireless device
the method comprising the steps of:
requesting a report from the wireless device of the signal strength of signals from a plurality of beacons at known locations in the wireless device;
for each beacon of the plurality, using the beacon's signal strength at the wireless device to determine the distance of the wireless device from the beacon; and
using the determined distances to determine the location of the wireless device.

51. The method set forth in claim 50 further comprising the step of:
obtaining sector orientation and aperture information for each beacon of the plurality, the sector orientation and aperture information being employed in the step of using the beacon's signal strength to refine the determination of the distance of the wireless device from the beacon.

52. A method of employing a baiting beacon to obtain the telephone number of a wireless device which is monitoring the baiting beacon, the wireless device interacting with a network which has caller identification capability and
the method comprising the steps of:
using the baiting beacon to obtain identification information for the wireless device from the wireless device:
using the identification information in the baiting beacon to set up a call to a destination device that has access to the network's caller identification capability; and
obtaining the telephone number of the wireless device from the destination device.

53. A method of employing a GSM baiting beacon to interact with a UMTS wireless device comprising the steps of:
establishing a relationship between the power of the GSNI baiting beacon and the power perceived by the UMTS wireless device of any UMTS beacons such that the UMTS wireless device falls back to GSM and attempts to register with the GSM baiting beacon; and
in the GSM beacon, responding to the registration attempt by interacting with the UMTS wireless device.

54. The method set forth in claim 53 wherein:
the step of establishing the relationship includes the step of interfering with the UMTS beacons, whereby the UMTS wireless device perceives the GSM baiting beacon as being more powerful than any of the UMTS beacons.

55. A method of employing a baiting beacon to obtain permanent identification information for a wireless device that is monitoring the baiting beacon,
the method comprising the steps of:
requesting identification information from the wireless device; and
when the wireless device returns temporary information, failing to respond further, the wireless device responding to the failure of the baiting beacon to respond further by returning permanent identification information.

56. A method of employing a baiting beacon to disable a wireless device that is monitoring the baiting beacon, the wireless communication standard under which the wireless device operates specifying that that a wireless device will not interact with a beacon unless the beacon has authenticated itself to the wireless device, the wireless device being potentially able to interact with one or more given beacons other than the baiting beacon, and
the method comprising the steps performed by the baiting beacon for each of the given beacons of:
overriding the given beacon; and
thereupon failing to authenticate itself to the wireless device, whereby the wireless device no longer interacts with any of the given beacons.

57. A method of moving a given wireless device that is monitoring a given beacon to a different channel,
the method comprising the steps of:
using a first baiting beacon to override the given beacon such that the given wireless device monitors the first baiting beacon instead of the given beacon in an operational area that surrounds the given wireless device;
establishing a second baiting beacon on the different channel, the second baiting beacon acting in the operational area to override any beacons operating on the different channel; and
using the first baiting beacon to command the wireless device to operate on the different channel.

58. A method of disabling a wireless device comprising the steps of:
determining an area that potentially contains the wireless device; and
irradiating the area with sufficient energy to trip the wireless device's protection circuitry.

59. A method of employing a baiting beacon to disable a wireless device of a type wherein identification information and a cipher key must be in phase in order for the wireless device to initeract with the wireless network,
the method comprising the steps of:
enticing the wireless device to register with the baiting beacon; and
employing the baiting beacon to change either the identification information or the cipher key in the wireless device so that the identification information is out of phase with the wireless device's cipher key.

60. The method of employing a baiting beacon set forth in claim 59 further comprising the step of:
employing the baiting beacon to reenable the wireless device by restoring the change so that the identification information is again in phase with the cipher key.
